(19) United States
(12) Patent Application Publication
(10) Pub. No.: US 2012/0282000 A1
(43) Pub. Date: Nov. 8, 2012

(54) TONER FOR ELECTROPHOTOGRAPHY, DEVELOPER, AND IMAGE FORMING APPARATUS

(76) Inventors: Shinya Nakayama, Shizuoka (JP); Atsushi Yamamoto, Shizuoka (JP); Masahide Yamada, Shizuoka (JP); Hideyuki Santo, Shizuoka (JP); Daiki Yamashita, Kanagawa (JP); Suzuka Amemori, Shizuoka (JP)

(21) Appl. No.: 13/458,512

(22) Filed: Apr. 27, 2012

(30) Foreign Application Priority Data
May 2, 2011 (JP) 2011-103175
Sep. 20, 2011 (JP) 2011-204269

(51) Int. Cl. G03G 9/16; G03G 9/087; G03G 15/22

(52) U.S. Cl. 399/130; 430/109.1; 430/109.5; 430/109.4; 430/108.7

(57) ABSTRACT

To provide a toner for electrophotography, which contains a binder resin, a colorant, and an organic-modified layered inorganic mineral, wherein the binder resin contains a crystalline resin in an amount of 50% by mass or greater, and wherein the organic-modified layered inorganic mineral is an organic-modified layered inorganic mineral in which at least part of ions present between layers of a layered inorganic mineral are modified with organic ions.

### BACKGROUND OF THE INVENTION

1. Field of the Invention

The present invention relates to a toner for electrophotography, a developer, and an image forming apparatus.

2. Description of the Related Art

Conventionally, in an electrophotographic image forming apparatus or the like, an electrically or magnetically formed latent image is visualized with a toner for electrophotography (may be merely referred to as a “toner” hereinafter). For example, in electrophotography, a latent electrostatic image (latent image) is formed on a photoconductor, followed by developing the latent image with the toner, to form a toner image. The toner image is typically transferred onto a transfer material such as paper, followed by fixing onto the transfer material. In the fixing image for fixing the toner image on the transfer paper, a thermal fixing system, such as a heating roller fixing system or heating belt fixing system, has been generally widely used because of its excellent energy efficiency.

Recently, there are increasing demands from the market for image forming apparatuses of high speed and energy saving, and therefore a toner having excellent low temperature fixing ability and capable of providing high quality images is desired. To achieve the low temperature fixing ability of the toner, the softening point of the binder resin contained in the toner needs to be low, but use of the binder resin having a low softening point tends to occur deposition of part of a toner image onto a surface of a fixing member during fixing, which will then be transferred to photocopy paper, which is so-called offset (also referred to as hot offset hereinafter). In addition to this, the heat resistant storage stability of the toner reduces, and therefore toner particles are fused to each other particularly in high temperature environments, which is so called blocking. Other than the above, use of the binder resin having a low softening point causes problems that the toner is fused to an inner area of a developing unit, or to a carrier, and the toner tends to cause filming on a surface of a photoconductor.

As for the technique for solving the aforementioned problems, it has been known that a crystalline resin is used as a binder resin of the toner. Specifically, the crystalline resin is capable of decreasing the softening point of the toner to around the melting point thereof by sharply softening at the melting point of the resin, while maintaining the heat resistant storage stability at the temperature equal to or lower than the melting point. Accordingly, use of the crystalline resin in the toner realizes both the low temperature fixing ability and heat resistant storage stability of the toner.

As for the toner using the crystalline resin, for example, there is disclosed a toner in which a crystalline resin obtained by elongating crystalline polyester with diisocyanate is used as a binder resin (see Japanese Patent Publication Application (JP-B) Nos. 04-024702, and 04-024703). In the case of these proposed toners, the low temperature fixing ability of the toner is excellent, but the hot offset resistance of the toner is insufficient, and therefore these toners do not meet the quality required by the market of recent years.

There is disclosed a toner using a crystalline resin which has a crosslink structure due to an unsaturated bond containing sulfonic acid groups (see Japanese Patent (JP-B) No. 3910338). This toner improves its hot offset resistance compared to that achieved by the conventional technique. Moreover, there is disclosed a technique related resin particles having excellent low temperature fixing ability and heat resistant storage stability, in which a ratio of a softening point to a peak temperature of heat of melting, and viscoelastic properties are specified (see Japanese Patent Application Laid-Open (JP-A) No. 2010-077419).

In the case of the aforementioned toners each of which uses the crystalline resin as a main component of the binder resin, however, the toner has excellent shock resistance owing to the characteristics of the crystalline resin, but has insufficient indentation hardness, such as Vickers hardness. Therefore, there are problems that due to the stress caused by stirring in a developing unit, depositions of the toner to the carrier or inner side of the developing unit and filming onto a photoconductor tend to occur, and deterioration in charging ability and flowability of the toner tends to occur due to embedded external additives in the toner particles. Moreover, as the toner melted on the fixing medium during the thermal fixing requires a time to be recrystallized, the hardness of the material constituting the surface of the image does not quickly recover. Therefore, there are problems that changes in glossiness due to marks formed by a roller or damage tends to caused on a surface of the image by a discharging roller or the like in a discharging operation after the fixing. Further, the hardness of the surface of the image is insufficient even after the hardness is recovered by recrystallization of the toner, and therefore there is a problem that the resulting image has low resistance to scratches or abrasion.

Meanwhile, there is disclosed a technique for improving stress resistance of the toner by specifying Durometer hardness of the crystalline resin, and adding inorganic particles to the toner (see JP-B No. 3360527).

In accordance with the technique, however, the roller mark damages in images just after fixing cannot be improved, and the hardness of the image after recrystallization of the toner is also insufficient. Moreover, the low temperature fixing ability of the toner is adversely affected by the inorganic particles, and there is a problem that the advantage of use of the crystalline resin in fixing cannot be maximized.

Meanwhile, there are disclosed various techniques for using a combination of a crystalline resin and a non-crystalline resin, not using the crystalline resin as a main component of a binder resin (see JP-B Nos. 3949526 and 4513627). In the case of these toners, however, the disadvantage of the crystalline resin regarding the hardness can be compensated with the non-crystalline resin, but the effect of the crystalline resin for contributing to low temperature fixing ability cannot be maximally exhibited.

### SUMMARY OF THE INVENTION

The present invention aims to solve the aforementioned various problems in the art, and to achieve the following object. An object of the present invention is to provide a toner for electrophotography, which is a toner using a crystalline resin in an amount of 50% by mass or greater of the binder resin, substantially as a main component of the binder resin, which can solve the particular problems for the toner using the crystalline resin, such as insufficient stress resistance, occurrences of image damage by transportation at the time of recrystallization of the toner just after thermal fixing, and insufficient hardness of output images, without adversely affecting low temperature fixing ability, and which can achieve both low temperature fixing ability and heat resistant storage stability at a highly desirable level.

As a result of the diligent studies conducted by the present inventors to achieve the aforementioned object, the present inventors have obtained the insights that by adding an organic-modified layered inorganic mineral, in which part of ions present between layers of a layered inorganic mineral are modified with organic ions, to a toner using a crystalline resin, occurrences of image damage by transportation at the time of recrystallization of the toner just after thermal fixing, and insufficient hardness of output images can be solved, which cannot be achieved by the conventional toners, as well as providing the stress resistance that is the same level as those of the conventional toners, which leads to the present invention.

This invention is based on the aforementioned finding by the present inventors, and the means for solving the aforementioned problems are as follows:

A toner for electrophotography, which contains:

a binder resin;

a colorant; and

an organic-modified layered inorganic mineral,

wherein the binder resin contains a crystalline resin in an amount of 50% by mass or greater, and

wherein the organic-modified layered inorganic mineral is an organic-modified layered inorganic mineral in which at least part of ions present between layers of a layered inorganic mineral are modified with organic ions.

The layered inorganic mineral moreover exhibits the maximum effect by located adjacent to a surface of a toner particle, but in the present invention, it has been found that the organic-modified layered inorganic mineral are in the stable state of assembly within the toner particle and are uniformly aligned adjacent to the surface of the toner particle without any space therebetween. Accordingly, the structural viscosity of the binder resin present adjacent to the surface of the toner particle is effectively increased, so that the binder resin sufficiently protects the resulting image even though the image is such an image having low hardness of the resin just after fixing. In addition, the organic-modified layered inorganic mineral can efficiently exhibit its effect with a small amount thereof, and therefore it is considered that it hardly affect the fixing ability of the toner.

The present invention can solve the various problems in the art, achieve the aforementioned object, and provide a toner for electrophotography, which is a toner using a crystalline resin in an amount of 50% by mass or greater of the binder resin, substantially as a main component of the binder resin, which can solve the particular problems for the toner using the crystalline resin, such as insufficient stress resistance, occurrences of image damage by transportation at the time of recrystallization of the toner just after thermal fixing, and insufficient hardness of output images, without adversely affecting low temperature fixing ability, and which can achieve both low temperature fixing ability and heat resistant storage stability at a highly desirable level.

### BRIEF DESCRIPTION OF THE DRAWINGS

FIG. 1 is a schematic diagram illustrating one example of a two-component developing unit mounted in the image forming apparatus of the present invention.

FIG. 2 is a schematic diagram illustrating one example of the process cartridge of the present invention.

FIG. 3 is a schematic diagram illustrating one example of the image forming apparatus of the present invention employing a tandem developing system.

FIG. 4 is an enlarged view of each image forming unit illustrated in FIG. 3.

FIG. 5A is a schematic diagram illustrating the state of one example of the toner of the present invention observed under TEM, and FIG. 5B is a picture showing the enlarged view of “b” in FIG. 5A.

### DETAILED DESCRIPTION OF THE INVENTION

### (Toner for Electrophotography)

The toner for electrophotography (may be also referred merely as “toner” hereinafter) of the present invention contains at least a binder resin, a colorant, and an organic-modified layered inorganic mineral, and may further contain other components, if necessary.

In the toner of the present invention, the binder resin contains a crystalline resin in an amount of 50% by mass or greater. Moreover, the organic-modified layered inorganic mineral is an organic-modified layered inorganic mineral in which at least part of ions present between layers of layered inorganic mineral have been modified with organic ions.

### <Binder Resin>

The binder resin is appropriately selected depending on the intended purpose without any limitation, provided that the binder resin contains a crystalline resin in an amount of 50% by mass or greater, specifically, a main component of the binder resin is substantially the crystalline resin. For example, the binder resin may further contain a non-crystalline resin.

An amount of the crystalline resin in the binder resin is appropriately selected depending on the intended purpose without any limitation, provided that it is 50% by mass or greater. The amount of the crystalline resin is preferably 65% by mass or greater, more preferably 80% by mass or greater, and even more preferably 95% by mass or greater for attaining the maximum effect of the crystalline resin in both of low fixing ability and heat resistant storage stability. When the amount thereof is less than 50% by mass, the thermal sharpness of the binder resin in the viscoelastic properties of the toner cannot be exhibited, which makes it difficult to attain both low fixing ability and heat resistance storage stability of the resulting toner.

In the present specification, as for the term “crystalline,” a resin having a ratio (softening point/maximum peak temperature of heat of melting) of 0.80 to 1.55 is defined as a “crystalline resin,” where the ratio is a ratio of a softening point of the resin as measured by a elevated flow tester to a maximum peak temperature of heat of melting the resin as measured by a differential scanning calorimeter (DSC). The “crystalline resin” has properties that it is sharply softened by heat.

Moreover, “crystalline” in a sense used for the “crystalline resin” in the present invention cannot be satisfied unless it is a resin containing a crystalline unit, which is a site having a crystal structure, in an amount of 50% by mass or more. In other words, an amount of the crystalline unit being 50% by mass or more relative to the binder resin means that an amount of the crystalline resin being 50% by mass or more relative to the binder resin.

Moreover, as for “non-crystalline,” a resin having a ratio (softening point/maximum peak temperature of heat of melting) of greater than 1.55 is defined as “non-crystalline resin.” The “non-crystalline resin” has properties that it is gradually softened by heat.

Note that, the presence of the crystalline resin in the toner can be confirmed by appropriately employing the aforementioned method on the resin extracted from the toner.

The softening points of the binder resin and toner can be measured by means of an elevated flow tester (e.g., CFT-500D, manufactured by Shimadzu Corporation). As a sample, 1 g of the binder resin or toner is used. The sample is heated at the heating rate of 6° C./min., and at the same time, load of 1.96 Mpa is applied by a plunger to extrude the sample from a nozzle having a diameter of 1 mm and length of 1 mm, during which an amount of the plunger of the flow tester pushed down relative to the temperature is plotted. The temperature at which half of the sample is flown out is determined as a softening point of the sample.

The maximum peak temperatures of heat of melting the binder resin and toner can be measured by a differential scanning calorimeter (DSC) (e.g., TA-60WS and DSC-60 of Shimadzu Corporation). A sample provided for a measurement of the maximum peak temperature of heat of melting is subjected to a pretreatment. Specifically, the sample is melted at 130° C., followed by cooled from 130° C. to 70° C. at the rate of 1.0° C./min. Next, the sample was cooled from 70° C. to 10° C. at the rate of 0.5° C./min. Then, the sample is heated at the heating rate of 20° C./min. to measure the endothermic and exothermic changes by DSC, to thereby plot “absorption or evolution heat capacity” verses “temperature” in a graph. In the graph, the endothermic peak temperature appeared in the temperature range from 20° C. to 100° C. is determined as an endothermic peak temperature, Ta*. In the case where there are a few endothermic peaks within the aforementioned temperature range, the temperature of the peak at which the absorption heat capacity is the largest is determined as Ta*. Thereafter, the sample is stored for 6 hours at the temperature that is (Ta*−10)° C., followed by storing for 6 hours at the temperature that is (Ta*−15)° C. Next, the sample is cooled to 0° C. at the cooling rate of 10° C./min., and then heated at the heating rate of 20° C./min. to measure the endothermic and exothermic changes by means of DSC, creating a graph in the same manner as the above. In the graph, the temperature corresponding to the maximum peak of the absorption or evolution heat capacity is determined as the maximum peak temperature of heat of melting.

A method for determining the amount of the crystalline unit relative to the binder resin is appropriately selected from conventional methods known in the art, without any limitation. Examples of the method thereof include: a method containing determining a resin structure by GC-MS, or thermal decomposition GC-MS, measuring the amount from the integral value of the spectrum derived from the crystalline unit, and calculating; and a method containing measuring a spectrum derived from the crystalline unit by ¹H-NMR, and calculating from the integral value of the obtained spectrum.

### <<Crystalline Resin>>

The crystalline resin is appropriately selected depending on the intended purpose without any limitation, and examples thereof include a polyester resin, a polyurethane resin, a polyurea resin, a polyamide resin, a polyether resin, a vinyl resin, and a modified crystalline resin. These may be used alone, or in combination. Among them, the polyester resin, polyurethane resin, polyurea resin, polyamide resin, and polyether resin are preferable, the resin having at least either of a urethane backbone or a urea backbone is preferable, and a composite resin containing a linear-chain polyester resin, and a linear-chain polyester resin is more preferable.

As for the resin containing at least either of the urethane backbone or the urea backbone, for example, the aforementioned polyurethane resin, the aforementioned polyurea resin, a urethane-modified polyester resin, and a urea-modified polyester resin are preferably included.

The urethane-modified polyester resin is a resin obtained through a reaction between a polyester resin having a terminal isocyanate group, and polyol. The urea-modified polyester resin is a resin obtained through a reaction between a polyester resin having a terminal isocyanate group, and amines.

The maximum peak temperature of heat of melting the crystalline resin is preferably 45° C. to 70° C., more preferably 53° C. to 65° C., and even more preferably 58° C. to 62° C. for attaining both low temperature fixing ability and heat resistant storage stability of the resulting toner. When the maximum peak temperature thereof is lower than 45° C., the resulting toner has desirable low temperature fixing ability, but insufficient heat resistant storage stability. When the maximum peak temperature thereof is higher than 70° C., the toner has conversely desirable heat resistant storage stability, but insufficient low temperature fixing ability.

The crystalline resin has a ratio (softening point/maximum peak temperature of heat of melting) of 0.80 to L55, preferably 0.85 to 1.25, more preferably 0.90 to 1.20, and even more preferably 0.90 to 1.19, where the ratio is a ratio of a softening point of the crystalline resin to a maximum peak temperature of heat of melting the crystalline resin. The smaller value of the ratio is preferable as the smaller the value is more sharply the resin is softened, which can realize to achieve both low temperature fixing ability and heat resistant storage stability of the resulting toner.

Regarding the viscoelastic properties of the crystalline resin, storage elastic modulus G′ of the crystalline resin at the temperature that is the maximum peak temperature of heat of melting+20° C. is preferably 5.0×10⁶ Pa·s or lower, more preferably 1.0×10¹ Pa·s to 5.0×10⁵ Pa·s, and even more preferably 1.0×10¹ Pa·s to 1.0×10¹ Pa·s. Moreover, loss elastic modulus G″ of the crystalline resin at the temperature that is the maximum peak temperature of heat of melting+20° C. is preferably 5.0×10⁶ Pa·s or lower, more preferably 1.0×10¹ Pa·s to 5.0×10⁵ Pa·s, and even more preferably 1.0×10¹ Pa·s to 1.0×10⁴ Pa·s. In view of the viscoelastic properties of the toner of the present invention, the values of G′ and G″ at the temperature the maximum peak temperature of heat of melting+20° C. falling into the range of 1.0×10³ Pa·s to 5.0×10⁶ Pa·s is preferable for giving the fixing strength and hot offset resistance to the resulting toner. Considering that the values of G′ and G″ increase as the colorant or layered inorganic mineral is dispersed in the binder resin, the viscoelastic properties of the crystalline resin are preferably within the aforementioned range.

The aforementioned viscoelastic properties of the crystalline resin can be achieved by adjusting a mixing ratio between a crystalline monomer and non-crystalline monomer constituting the binder resin, or the molecular weight of the binder resin. For example, the value of G′ (Ta+20) degreases as a proportion of the crystalline monomer increases in the monomers constituting the binder resin.

Dynamic viscoelastic values (storage elastic modulus G′, loss elastic modulus G″) of the resin and toner can be measured by means of a dynamic viscoelastometer (e.g., ARES of TA Instruments Japan Inc.). The measurement is carried out with a frequency of 1 Hz. A sample is formed into a pellet having a diameter of 8 mm, and a thickness of 1 mm to 2 mm, and the pellet sample is fixed to a parallel plate having a diameter of 8 mm, followed by stabilizing at 40° C. Then, the sample is heated to 200° C. at the heating rate of 2.0° C./min. with frequency of 1 Hz (6.28 rad/s), and strain of 0.1% (in a strain control mode) to thereby measure dynamic viscoelastic values of the sample.

The weight average molecular weight Mw of the crystalline resin is preferably 2,000 to 100,000, more preferably 5,000 to 60,000, and even more preferably 8,000 to 30,000 in view of fixing ability of the resulting toner. When the weight average molecular weight thereof is smaller than 2,000, the resulting toner is likely to exhibit insufficient hot offset resistance. When the weight average molecular weight thereof is larger than 100,000, low temperature fixing ability of the resulting toner tends to be degraded.

In the embodiment of the present invention, the weight average molecular weight (Mw) of the binder resin can be measured by means of a gel permeation chromatography (GPC) measuring device (e.g., GPC-8220GPC of Tosoh Corporation). As for a column used for the measurement, TSKgel Super HZM-H, 15 cm, three connected columns (of Tosoh Corporation) are used. The resin to be measured is formed into a 0.15% by mass solution using tetrahydrofuran (THF) (containing a stabilizer, manufactured by Wako Chemical Industries, Ltd.), and the resulting solution is subjected to filtration using a filter having a pore size of 0.2 from which the filtrate is provided as a sample. The THF sample solution is injected in an amount of 100 μL into the measuring device, and the measurement is carried out at a flow rate of 0.35 mL/min. in the environment having the temperature of 40° C. For the measurement of the molecular weight distribution of the sample, a molecular weight distribution of the sample is calculated from the relationship between the logarithmic value of the calibration curve prepared from a several monodispersible polystyrene standard samples and the number of counts. As the standard polystyrene samples for preparing the calibration curve, Showdex STANDARD Std. Nos. S-7300, S-210, S-390, S-875, S-1980, S-10.9, S-629, S-3.0, and S-0.580 of SHOWA DENKO K.K., and toluene are used. As the detector, a refractive index (RI) detector is used.

### <<<Polyester Resin>>>

As for the polyester resin, for example, a polycondensate polyester resin synthesized from polyol and polycarboxylic acid, a lactone ring-opening polymerization product, and polyhydroxycarboxylic acid are included. Among them, the polycondensate polyester resin synthesized from polyol and polycarboxylic acid is preferable in view of exhibition of crystallinity.

### —Polyol—

The polyol includes, for example, diol, trihydric to octahydric or higher polyol.

The diol is appropriately selected depending on the intended purpose without any limitation, and examples thereof include: aliphatic diol such as linear-chain aliphatic diol, branched-chain aliphatic diol; C4-C36 alkylene ether glycol; C4-C36 alicyclic diol; alkylene oxide (abbreviated as “AO” hereinafter) of the above-listed alicyclic diol; AO adducts of bisphenols; polylactonediol; polybutadienediol; and diol having a functional group, such as diol having a carboxyl group, diol having a sulfonic acid group or sulfamine group, salts thereof, and diols having other functional groups. Among them, C2-C36 aliphatic diol is preferable, and the linear-chain aliphatic diol is more preferable. These may be used alone, or in combination.

An amount of the linear-chain aliphatic diol is preferably 80 mol % or greater, more preferably 90 mol % or greater relative to the total amount of the diols. Use of the linear-chain aliphatic diol in an amount of 80 mol % or greater is preferable as the crystallinity of the resin is enhanced, both low temperature fixing ability and heat resistant storage stability are desirably provided to the resulting resin, and the hardness of the resin tends to be increased.

The linear-chain aliphatic diol is appropriately selected depending on the intended purpose without any limitation, and examples thereof include ethylene glycol, 1,3-propanediol, 1,4-butanediol, 1,5-pentanediol, 1,6-hexanediol, 1,7-heptanediol, 1,8-octanediol, 1,9-nanonediol, 1,10-decanediol, 1,11-undecanediol, 1,12-dodecanediol, 1,13-tridecanediol, 1,14-tetradecanediol, 1,18-octadecanediol, and 1,20-eicosanediol. Among them, ethylene glycol, 1,3-propanediol, 1,4-butanediol, 1,6-hexanediol, 1,9-nanonediol, and 1,10-decanediol are preferable, because they are readily available.

The C2-C36 branched-chain aliphatic diol is appropriately selected depending on the intended purpose without any limitation, and examples thereof include 1,2-propylene glycol, butanediol, hexanediol, octanediol, decanediol, dodecanediol, tetradecanediol, neopentyl glycol, and 2,2-diethyl-1,3-propanediol.

The C4-C36 alkylene ether glycol is appropriately selected depending on the intended purpose without any limitation, and examples thereof include diethylene glycol, triethylene glycol, dipropylene glycol, polyethylene glycol, polypropylene glycol, and polytetramethylene ether glycol.

The C4-C36 diol is appropriately selected depending on the intended purpose without any limitation, and examples thereof include 1,4-cyclohexanedimethanol, and hydrogenated bisphenol A.

The alkylene oxide (abbreviated as “AO” hereinafter) of the above-listed alicyclic diol is appropriately selected depending on the intended purpose without any limitation, and examples thereof include adducts (number of moles added: 1 to 30) of ethylene oxide (may be abbreviated as “EO” hereinafter), propylene oxide (may be abbreviated as “PO” hereinafter), butylene oxide (may be abbreviated as “BO”).

The bisphenols are appropriately selected depending on the intended purpose without any limitation, and examples thereof include AO (e.g., EO, PO, and BO) adducts (number of moles added: 2 to 30) of bisphenol A, bisphenol F, and bisphenol S.

The polylactone diol is appropriately selected depending on the intended purpose without any limitation, and examples thereof include poly(ε-caprolactone)diol.

The diol having a carboxyl group is appropriately selected depending on the intended purpose without any limitation, and examples thereof include: C6-C24 dialkylol alkanoic acid such as 2,2-dimethylol propionic acid (DMPA), 2,2-dimethylol butanoic acid, 2,2-dimethylol heptanoic acid, and 2,2-dimethylol octanoic acid.

The diol having a sulfonic acid group or sulfaminic acid group is appropriately selected depending on the intended purpose without any limitation, and examples thereof include: N,N-bis(2-hydroxyalkyl)sulfamic acid (where the alkyl group is C1-C6 group) and AO adducts thereof (where AO is EO or PO, and the number of moles of AO added is 1 to 6), such as N,N-bis(2-hydroxyethyl)sulfamic acid, and N,N-bis(2-hydroxyethyl)sulfamic acid PO (2 mol) adduct; and bis(2-hydroxyethyl)phosphate.

The neutralized salt group contained in the diol having a neutralized salt group is appropriately selected depending on the intended purpose without any limitation, and examples thereof include C3-C30 tertiary amine (e.g., triethyl amine), and alkali metal (e.g., sodium salt).

Among them, the C2-C12 alkylene glycol, diol having a carboxyl group, AO adduct of bisphenols, and any combination thereof are preferable.

Moreover, the trihydric to octahydric or higher polyol, which is optionally used, is appropriately selected depending on the intended purpose without any limitation, and examples thereof include: C3-C36 trihydric to octahydric or higher polyhydric aliphatic alcohol such as alkane polyol, and its intramolecular or intermolecular dehydrate (e.g., glycerin, trimethylol ethane, trimethylol propane, pentaerythritol, sorbitol, sorbitan, and polyglycerin), saccharide and derivatives thereof (e.g., sucrose, and methylglucoside); AO adduct (number of moles added: 2 to 30) of trisphenols (e.g., trisphenol PA); AO adduct (number of moles added: 2 to 30) of a novolak resin (e.g., phenol novolak, and cresol novolak); and acryl polyol such as a copolymer of hydroxyethyl(meth)acrylate and other vinyl-based monomer. Among them, the trihydric to octahydric or higher aliphatic polyhydric alcohol, and AO adduct of the novolak resin are preferable, and he AO adduct of the novolak resin is more preferable.

### —Polycarboxylic Acid—

As for the polycarboxylic acid, for example, dicarboxylic acid, and trivalent to hexavalent, or higher polycarboxylic acid are included.

The dicarboxylic acid is appropriately selected depending on the intended purpose without any limitation, and examples thereof include: aliphatic dicarboxylic acid such as a linear-chain aliphatic dicarboxylic acid, and branched-chain dicarboxylic acid; and aromatic dicarboxylic acid. Among them, the linear-chain aliphatic dicarboxylic acid is preferable.

The aliphatic dicarboxylic acid is appropriately selected depending on the intended purpose without any limitation, and examples thereof preferably include: C4-C36 alkane dicarboxylic acid such as succinic acid, adipic acid, sebacic acid, azelaic acid, dodecane dicarboxylic acid, octadecane dicarboxylic acid, and decyl succinic acid; C4-C36 alkene dicarboxylic acid such as alkenyl succinic acid (e.g., dodecenyl succinic acid, pentadecenyl succinic acid, octadecenyl succinic acid), maleic acid, fumaric acid, citraconic acid; and C6-C40 alicyclic dicarboxylic acid such as dimer acid (e.g., dimeric lenoleic acid).

The aromatic dicarboxylic acid is appropriately selected depending on the intended purpose without any limitation, and examples thereof preferably include C8-C36 aromatic dicarboxylic acid such as phthalic acid, isophthalic acid, terephthalic acid, t-butyl isophthalic acid, 2,6-naphthalene dicarboxylic acid, and 4,4′-biphenyl dicarboxylic acid.

Examples of the optionally used trivalent to hexavalent or higher polycarboxylic acid include C9-C20 aromatic polycarboxylic acid such as trimellitic acid, and pyromellitic acid.

Note that, as the dicarboxylic acid or trivalent to hexavalent or higher polycarboxylic acid, acid anhydrides or C1-C4 lower alkyl ester (e.g., methyl ester, ethyl ester, and isopropyl ester) of the above-listed acids may be used.

Among the above-listed dicarboxylic acids, a use of the aliphatic dicarboxylic acid (preferably, adipic acid, sebacic acid, dodecane dicarboxylic acid, terephthalic acid, isophthalic acid, etc.) alone is particularly preferable, but a copolymer of the aliphatic dicarboxylic acid and the aromatic dicarboxylic acid (preferably, terephthalic acid, isophthalic acid, or t-butyl isophthalic acid; or lower alkyl ester of these aromatic dicarboxylic acids) is also preferably used. In this case, the amount of the aromatic dicarboxylic acid in a copolymer is preferably 20 mol % or smaller.

### —Lactone Ring-Opening Polymerization Product—

The lactone ring-opening polymerization product is appropriately selected depending on the intended purpose without any limitation, and examples thereof include a lactone ring-opening polymerization product obtained by subjecting lactones (e.g., C3-C12 monolactone (having one ester group in a ring), such as β-propiolactone, γ-butyrolactone, δ-valerolactone, and ε-caprolactone) to ring-opening polymerization using a catalyst (e.g., metal oxide, and an organic metal compound); and a lactone ring-opening polymerization product containing a terminal hydroxy group obtained by subjecting C3-C12 monolactones to ring-opening polymerization using glycol (e.g., ethylene glycol, and diethylene glycol) as an initiator.

The C3-C12 monolactone is appropriately selected depending on the intended purpose without any limitation, but it is preferably ε-caprolactone in view of crystallinity.

The lactone ring-opening polymerization product may be selected from commercial products, and examples of the commercial products include highly crystalline polycaprolactone such as H1P, H4, H5, and H7 of PLACCEL series manufactured by Daicel Corporation.

### —Polyhydroxycarboxylic Acid—

The preparation method of the polyhydroxycarboxylic acid is appropriately selected depending on the intended purpose without any limitation, and examples thereof include a method in which hydroxycarboxylic acid such as glycolic acid, and lactic acid (e.g., L-lactic acid, D-lactic acid, and racemic lactic acid) is directly subjected to a dehydration-condensation reaction; and a method in which C4-C12 cyclic ester (the number of ester groups in the ring is 2 to 3), which is an equivalent to a dehydration-condensation product between 2 or 3 molecules of hydroxycarboxylic acid, such as glycolide or lactide (e.g., L-lactide acid, D-lactide, and racemic lactic acid) is subjected to a ring-opening polymerization using a catalyst such as metal oxide and an organic metal compound. The method using ring-opening polymerization is preferable because of easiness in adjusting a molecular weight of the resultant.

Among the cyclic esters listed above, L-lactide and D-lactide are preferable in view of crystallinity. Moreover, terminals of the polyhydroxycarboxylic acid may be modified to have a hydroxyl group or carboxyl group.

### <<<Polyurethane Resin>>>

As for the polyurethane resin, a polyurethane resin synthesized from polyol (e.g., diol, trihydric to octahydric or higher polyol) and polyisocyanate (e.g., diisocyanate, and trivalent or higher polyisocyanate) is included. Among them, the polyurethane resin synthesized from the diol and the diisocyanate is preferable.

As for the diol and trihydric to octahydric or higher polyol, those mentioned as the diol and trihydric to octahydric or higher polyol listed in the description of the polyester resin can be used.

### —Polyisocyanate—

As for the polyisocyanate, for example, diisocyanate, and trivalent or higher polyisocyanate are included.

The diisocyanate is appropriately selected depending on the intended purpose without any limitation, and examples thereof include aromatic diisocyanates, aliphatic diisocyanates, alicyclic diisocyanates, and aromatic aliphatic diisocyanates. Among them, preferable examples include the C6-C20 aromatic diisocyanate (the number of the carbon atoms excludes other than those contained in NCO groups, which is the same as follows), the C2-C18 aliphatic diisocyanate, C4-C15 alicyclic diisocyanate, C8-C15 aromatic aliphatic diisocyanate, and modified products (e.g., modified products containing a urethane group, carboxylmide group, allophanate group, urea group, biuret group, uretdione group, uretimine group, isocyanurate group, or oxazolidone group) of the preceding diisocyanates, and a mixture of two or more of the preceding diisocyanates. Optionally, trivalent or higher isocyanate may be used in combination.

The aromatic diisocyanates are appropriately selected depending on the intended purpose without any limitation, and examples thereof include 1,3- and/or 1,4-phenylene diisocyanate, 2,4- and/or 2,6-tolylenediisocyanate (TDI), crude TDI, 2,4′- and/or 4,4′-diphenyl methane diisocyanate (MDI), crude MDI (e.g., a phosgenite product of crude diaminophenyl methane (which is a condensate between formaldehyde and aromatic amine (aniline) or a mixture thereof, or condensate of a mixture of diaminodiphenyl methane and a small amount (e.g., 5% by mass to 20% by mass) of trivalent or higher polyamine) and polyallylpolyisocyanate (PAPI)), 1,5-naphthalene diisocyanate, 4,4′,4″-triphenylmethane triisocyanate, and m- and p-isocyanatophenylsulfonyl isocyanate.

The aliphatic diisocyanates are appropriately selected depending on the intended purpose without any limitation, and examples thereof include ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethylcaproate, bis(2-isocyanatoethyl)fumarate, bis(2-isocyanatoethyl)carbonate, and 2-isocyanatoethyl-2,6-diisocyanatohexanoate.

The alicyclic diisocyanates are appropriately selected depending on the intended purpose without any limitation, and examples thereof include isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, and 2,5- and 2,6-norbornanediisocyanate.

The aromatic aliphatic diisocyanate is appropriately selected depending on the intended purpose without any limitation, and examples thereof include m- and p-xylene diisocyanate (XDI), and α,α,α′,α′-tetramethylxylene diisocyanate (TMXDI).

Moreover, the modified product of the diisocyanate is appropriately selected depending on the intended purpose without any limitation, and examples thereof include modified products containing a urethane group, carboxylmide group, allophanate group, urea group, biuret group, uretdione group, uretimine group, isocyanurate group, or oxazolidone group. Specific examples thereof include: modified products of diisocyanate such as modified MDI (e.g., urethane-modified MDI, carbodiimide-modified MDI, and trihydrocarbylphosphate-modified MDI), and urethane-modified TDI (e.g., isocyanate-containing prepolymer); and a mixture of two or more of these modified products of diisocyanate (e.g., a combination of modified MDI and urethane-modified TDI).

Among these diisocyanates, C6-C15 aromatic diisocyanate (where the number of carbon atoms excludes those contained in NCO groups, which will be the same as follows), C4-C12 aliphatic diisocyanate, and C4-C15 alicyclic diisocyanate are preferable, and TDI, MDI, HDI, hydrogenated MDI, and IPDI are particularly preferable.

### <<<Polyurea Resin>>>

As for the polyurea resin, a polyurea resin synthesized from polyamine (e.g., diamine, and trivalent or higher polyamine) and polyisocyanate (e.g., diisocyanate, and trivalent or higher polyisocyanate) is included. Among them, the polyurea resin synthesized from the diamine and the diisocyanate is preferable.

As for the diisocyanate and trivalent or higher polyisocyanate, those listed as the diisocyanate and trivalent or higher polyisocyanate in the description of the polyurethane resin can be used.

### —Polyamine—

As for the polyamine, for example, diamine, and trivalent or higher polyamine are included.

The diamine is appropriately selected depending on the intended purpose without any limitation, and examples thereof include aliphatic diamines, and aromatic diamines. Among them, C2-C18 aliphatic diamines, and C6-C20 aromatic diamines are preferable. With this, the trivalent or higher amines may be used in combination, if necessary.

The C2-C18 aliphatic diamines are appropriately selected depending on the intended purpose without any limitation, and examples thereof include: C2-C6 alkylene diamine, such as ethylene diamine, propylene diamine, trimethylene diamine, tetramethylene diamine, and hexamethylene diamine; C4-C18 alkylene diamine, such as diethylene triamine, iminobispropyl amine, bis(hexamethylene)triamine, triethylene tetramine, tetraethylene pentamine, and pentaethylene hexamine; C1-C4 alkyl or C2-C4 hydroxyalkyl substitution products of the alkylene diamine or polyalkylene diamine, such as dialkylaminopropylamine, trimethylhexamethylene diamine, aminoethylethanolamine, 2,5-dimethyl-2,5-hexamethylene diamine, and methyl isobispropyl amine; C4-C15 alicyclic diamine, such as 1,3-diaminocyclohexane, isophorone diamine, menthane diamine, and 4,4′-methylene dichlorohexane diamine (hydrogenated methylene dianiline); C4-C15 heterocyclic diamine, such as piperazine, N-aminoethyl piperazine, 1,4-diaminoethyl piperazine, 1,4-bis(2-amino-2-methylpropyl)piperazine, 3,9-bis(3-aminopropyl)-2,4,8,10-tetraoxapiro[5,5]undecane; and C8-C15 aromatic ring-containing aliphatic amines such as xylylene diamine, and tetrachloro-p-xylylene diamine.

The C6-C20 aromatic diamines are appropriately selected depending on the intended purpose without any limitation, and examples thereof include: unsubstituted aromatic diamine such as 1,2-, 1,3- and 1,4-phenylenediamine, 2,4′- and 4,4′-diphenyl methanediamine, crude diphenyl methanediamine (e.g., polyphenyl polymethylene polyamine), diaminodiphenyl sulfone, benzidine, thiodianiline, bis(3,4-diaminophenyl)sulfone, 2,6-diaminopyridine, m-aminobenzylamine, triphenylmethane-4,4′,4″-triamine, and naphthylene diamine; aromatic diamine containing a C1-C4 nuclear substituted alkyl group such as 2,4- and 2,6-tolylenediamine, crude tolylenediamine, diethyltolylenediamine, 4,4′-diamino-3,3′-dimethyldiphenyl methane, 4,4′-bis(o-toluidine), dianisidine, diaminoditolylsulfone, 1,3-dimethyl-2,4-diaminobenzene, 1,3-dimethyl-2,6-diaminobenzene, 1,4-diisopropyl-2,5-diaminobenzene, 2,4-diaminomesitylene, 1-methyl-3,5-diethyl-2,4-diaminobenzene, 2,3-dimethyl-1,4-diaminonaphthalene, 2,6-dimethyl-1,5-diaminonaphthalene, 3,3′,5,5′-tetramethylbenzidine, 3,3′,5,5′-tetramethyl-4,4′-diaminodiphenyl methane, 3,5-diethyl-3′-methyl-2′,4-diaminodiphenyl methane, 3,3′-diethyl-2,2′-diaminodiphenyl methane, 4,4′-diamino-3,3′-dimethyldiphenyl methane, 3,3′,5,5′-tetraethyl-4,4′-diaminobenzophenone, 3,3′,5,5′-tetraethyl-4,4′-diaminodiphenyl ether, and 3,3′,5,5′-tetraisopropyl-4,4′-diaminodiphenylsulfone; mixtures of isomers of the unsubstituted aromatic diamine and/or aromatic diamine containing a C1-C4 nuclear substituted alkyl group at various mixing ratios; methylenebis-o-chloroaniline, 4-chloro-o-phenylenediamine, 2-chloro-1,4-phenylenediamine, 3-amino-4-chloroaniline, 4-bromo-1,3-phenylenediamine, 2,5-dichloro-1,4-phenylenediamine, 5-nitro-1,3-phenylenediamine, and 3-dimethoxy-4-aminoaniline; aromatic diamine containing a nuclear substituted electron-withdrawing group (e.g., halogen such as Cl, Br, I, and F; an alkoxy group such as a methoxy group and ethoxy group; and a nitro group), such as 4,4′-diamino-3,3′-dimethyl-5,5′-dibromo-diphenyl methane, 3,3′-dichlorobenzidine, 3,3′-dimethoxybenzidine, bis(4-amino-3-chlorophenyl)oxide, bis(4-amino-2-chlorophenyl)propane, bis(4-amino-2-chlorophenyl)sulfone, bis(4-amino-3-methoxyphenyl)decane, bis(4-aminophenyl)sulfide, bis(4-aminophenyl)telluride, bis(4-aminophenyl)selenide, bis(4-amino-3-methoxyphenyl)disulfide, 4,4′-methylene bis(2-iodoaniline), 4,4′-methylenebis(2-bromoaniline), 4,4′-methylenebis(2-fluoroaniline), and 4-aminophenyl-2-chloroaniline; and aromatic diamine containing a secondary amino group (e.g., part of or entire primary amino groups of the unsubstituted aromatic diamine, aromatic diamine containing a C1-C4 nuclear substituted alkyl group, mixture of isomers thereof at various mixing ratios, and aromatic diamine containing a nuclear substituted electron-withdrawing group are substituted with secondary amino group using lower alkyl groups such as a methyl group, and ethyl group), such as 4,4′-di(methylamino)diphenyl methane, and 1-methyl-2-methylamino-4-aminobenzene.

As for the diamine, other than those listed above, polyamide polyamine such as low molecular polyamide polyamine obtained by condensation of dicarboxylic acid (e.g., dimer acid) and excess (2 moles or more per mole of acid) of the polyamine (e.g., the alkylene diamine, and the poly alkylene polyamine); and polyether polyamine such as hydride of cyanoethylated product of polyetherpolyol (e.g., polyalkylene glycol) are included.

### <<<Polyamide Resin>>>

As for the polyamide resin, a polyamide resin synthesized from polyamine (e.g., diamine, and trivalent or higher polyamine), and polycarboxylic acid (e.g., dicarboxylic acid, and trivalent to hexavalent or higher polycarboxylic acid) is included. Among them, the polyamide resin synthesized from diamine and dicarboxylic acid is preferable.

As for the diamine and trivalent or higher polyamine, those listed as the diamine and trivalent or higher polyamine in the description of the polyurea resin can be used.

As for the dicarboxylic acid and trivalent to hexavalent or higher polycarboxylic acid, those listed as the dicarboxylic acid and trivalent to hexavalent or higher polycarboxylic acid in the description of the polyester resin can be used.

### <<<Polyether Resin>>>

The polyether resin is appropriately selected depending on the intended purpose without any limitation, and examples thereof include crystalline polyoxyalkylene polyol.

The preparation method of the crystalline polyoxyalkylene polyol is appropriately selected from the conventional methods known in the art depending on the intended purpose without any limitation, and examples thereof include: a method in which chiral AO is subjected to ring-opening polymerization using a catalyst that is commonly used for a polymerization of AO (e.g., a method described in Journal of the American Chemical Society, 1956, Vol. 78, No. 18, pp. 4787-4792); and a method in which inexpensive racemic AO is subjected to ring-opening polymerization using a catalyst that is a complex having a three-dimensionally bulky unique chemical structure.

As for the method using the unique complex, a method using a compound in which a lanthanoide complex and organic aluminum are in contact as a catalyst (e.g., a method described in JP-A No. 11-12353), and a method in which bimetal-proxoalkoxide and a hydroxyl compound are reacted in advance (e.g., a method described in JP-A No. 2001-521957) have been known.

As for the method for obtaining crystalline polyoxyalkylene polyol having extremely high isotacticity, a method using a salen complex (e.g., the method described in Journal of the American Chemical Society, 2005, Vol. 127, No. 33, pp. 11566-11567) has been known. For example, by using glycol or water as an initiator in the course of a ring-opening polymerization of chiral AO, polyoxyalkylene glycol containing a terminal hydroxyl group, and having isotacticity of 50% or higher is yielded. The polyoxyalkylene glycol having isotacticity of 50% or higher may be the one whose terminal group may be modified to have a carboxyl group. Note that, the isotacticity of 50% or higher generally results in crystallinity. As for the glycol, the aforementioned diol is included. As for the carboxylic acid used for the carboxy-modificartion, the aforementioned dicarboxylic acid is included.

As for AO used for the production of the crystalline polyoxyalkylene polyol, C3-C9 AO is included. Examples thereof include PO, 1-chlorooxetane, 2-chlorooxetane, 1,2-dichlorooxetane, epichlorohydrin, epibromohydrin, 1,2-BO, methyl glycidyl ether, 1,2-pentyleneoxide, 2,3-pentyleneoxide, 3-methyl-1,2-butyleneoxide, cyclohexene oxide, 1,2-hexyleneoxide, 3-methyl-1,2-pentyleneoxide, 2,3-hexyleneoxide, 4-methyl-2,3-pentyleneoxide, allylglycidyl ether, 1,2-heptyleneoxide, styrene oxide, and phenylglycidyl ether. Among these AOs, PO, 1,2-BO, styrene oxide, and cyclohexene oxide are preferable, PO, 1,2-BO, and cyclohexene oxide are more preferable. These AOs may be used alone or in combination.

The isotacticity of the crystalline polyoxyalkylene polyol is preferably 70% or higher, more preferably 80% or higher, even more preferably 90% or higher, and particularly preferably 95% or higher, in view of high sharp melt properties and blocking resistance of the resulting crystalline polyether resin.

The isotacticity can be calculated by the method described in Macromolecules, Vol. 35, No. 6, pp. 2389-2392 (2002), and can be obtained in the following manner.

About 30 mg of a measuring sample is weight and taken into a sample tube for ¹³C-NMR having a diameter of 5 mm, and about 0.5 mL of a deuteration solvent is added thereto to dissolve the sample therein, to thereby prepare a sample for analysis. The deuteration solvent for use is not particularly limited, and appropriately selected from solvents capable of dissolving the sample. Examples of such deuteration solvent include deuterated chloroform, deuterated toluene, deuterated dimethylsulfoxide, and deuterated dimethyl formamide. Three signals of ¹³C-NMR derived from a methine group are respectively appeared around the syndiotactic value (S) of 75.1 ppm, heterotactic value (H) of 75.3 ppm, and isotactic value (I) of 75.5 ppm.

The isotacticity is calculated by the following equation 1:

Isotacticity (%)=[I/(I+S+H)]×100 Equation 1

In the equation 1, I is an integral value of the isotactic signal, S is an integral value of the syndiotactic signal, and H is an integral value of the heterotactic signal.

### <<<Vinyl Resin>>>

The vinyl resin is appropriately selected depending on the intended purpose without any limitation, provided that it has crystallinity, but it is preferably one containing, in its constitutional unit, a crystalline vinyl monomer and optionally a non-crystalline vinyl monomer.

The crystalline vinyl monomer is appropriately selected depending on the intended purpose without any limitation, and examples thereof preferably include a linear-chain alkyl(meth)acrylate having C12-C50 alkyl group (C12-C50 linear-chain alkyl group is a crystalline group), such as lauryl(meth)acrylate, tetradecyl(meth)acrylate, stearyl(meth)acrylate, eicosyl(meth)acrylate, and behenyl(meth)acrylate.

The non-crystalline vinyl monomer is appropriately selected depending on the intended purpose without any limitation, but it is preferably a vinyl monomer having a molecular weight of 1,000 or smaller. Examples thereof include styrenes, (meth)acryl monomer, a carboxyl group-containing vinyl monomer, other vinyl ester monomers, and aliphatic hydrocarbon vinyl monomer. These may be used alone, or in combination.

The styrenes are appropriately selected depending on the intended purpose without any limitation, and examples thereof include styrene, and alkyl styrene having a C1-C3 alkyl group.

The (meth)acryl monomer is appropriately selected depending on the intended purpose without any limitation, and examples thereof include: (meth)acrylate where the alkyl group has 1 to 11 carbon atoms and branched alkyl(meth)acrylate where the alkyl group has 12 to 18 carbon atoms, such as methyl(meth)acrylate, ethyl(meth)acrylate, butyl(meth)acrylate, and 2-ethylhexyl(meth)acrylate; hydroxylalkyl(meth)acrylate where the alkyl group has 1 to 11 carbon atoms, such as hydroxylethyl(meth)acrylate; and alkylamino group-containing (meth)acrylate where the alkyl group contains 1 to 11 carbon atoms, such as dimethylaminoethyl(meth)acrylate, and diethylaminoethyl(meth)acrylate.

The carboxyl group-containing vinyl monomer is appropriately selected depending on the intended purpose without any limitation, and examples thereof include: C3-C15 monocarboxylic acid such as (meth)acrylic acid, crotonic acid, and cinnamic acid; C4-C15 dicarboxylic acid such as maleic acid (anhydride), fumaric acid, itaconic acid, and citraconic acid; dicarboxylic acid monoester, such as monoalkyl (C1-C18) ester of dicarboxylic acid (e.g., maleic acid monoalkyl ester, fumaric acid monoalkyl ester, itaconic acid monoalkyl ester, and citraconic acid monoalkyl ester).

The aforementioned other vinyl ester monomers are appropriately selected depending on the intended purpose without any limitation, and examples thereof include: C4-C15 aliphatic vinyl ester such as vinyl acetate, vinyl propionate, and isopropenyl acetate; C8-C50 unsaturated carboxylic acid polyhydric (dihydric to trihydric or higher) alcohol ester such as ethylene glycol di(meth)acrylate, propylene glycol di(meth)acrylate, neopentyl glycol di(meth)acrylate, trimethylolpropane tri(meth)acrylate, 1,6-hexanediol diacrylate, and polyethylene glycol di(meth)acrylate; and C9-C15 aromatic vinyl ester such as methyl-4-vinylbenzoate.

The aliphatic hydrocarbon vinyl monomer is appropriately selected depending on the intended purpose without any limitation, and examples thereof include: C2-C10 olefin such as ethylene, propylene, butene, and octene; and C4-C10 diene such as butadiene, isoprene, and 1,6-hexadiene.

### <<<Modified Crystalline Resin (Binder Resin Precursor)>>>

The modified crystalline resin is appropriately selected depending on the intended purpose without any limitation, provided that it is a crystalline resin having a functional group reactive with an active hydrogen group. Examples of the modified crystalline resin include a crystalline polyester resin, crystalline polyurethane resin, crystalline polyurea resin, crystalline polyamide resin, crystalline polyether resin, and crystalline vinyl resin, all of which contain a functional group reactive with an active hydrogen group. The modified crystalline resin is reacted with a compound having an active hydrogen group (e.g., a resin containing an active hydrogen group, and a crosslinking or elongation agent containing an active hydrogen) during the production of a toner, so that the molecular weight of the resulting resin is increased to form a binder resin. Accordingly, the modified crystalline resin can be used as a binder resin precursor in the production of the toner.

Note that, the binder resin precursor denotes a compound capable of undergoing an elongation reaction or crosslink reaction, including the aforementioned monomers, oligomers, and modified resins or oligomers having a functional group reactive with an active hydrogen group for constituting the binder resin. The binder resin precursor may be a crystalline resin or a non-crystalline resin, provided that it satisfies these conditions. Among them, the binder resin precursor is preferably the modified crystalline resin containing an isocyanate group at least at a terminal thereof, and it is preferred that the binder resin precursor undergo an elongation and/or crosslink reaction with an active hydrogen group during granulating toner particles by dispersing and/or emulsifying in an aqueous medium, to thereby form a binder resin.

As for the binder resin formed from the binder resin precursor in the aforementioned manner, a crystalline resin obtained by an elongation reaction and/or crosslink reaction of the modified resin containing a functional group reactive with an active hydrogen group and the compound containing an active hydrogen group is preferable. Among them, a urethane-modified polyester resin obtained by an elongation and/or crosslink reaction of the polyester resin containing a terminal isocyanate group and the polyol; and a urea-modified polyester resin obtained by an elongation reaction and/or crosslink reaction of the polyester resin containing a terminal isocyanate group and the amines are preferable.

The functional group reactive with an active hydrogen group is appropriately selected depending on the intended purpose without any limitation, and examples thereof include functional groups such as an isocyanate group, an epoxy group, a carboxylic group, and an acid chloride group. Among them, the isocyanate group is preferable in view of the reactivity and stability.

The compound containing an active hydrogen group is appropriately selected depending on the intended purpose without any limitation, provided that it contains an active hydrogen group. In the case where the functional group reactive with an active hydrogen group is an isocyanate group, for example, the compound containing an active hydrogen group includes compounds containing a hydroxyl group (e.g., alcoholic hydroxyl group and phenolic hydroxyl group), an amino group, a carboxyl group, and a mercapto group as the active hydrogen group. Among them, the compound containing an amino group (e.g., amines) is particularly preferable in view of the reaction speed.

The amines are appropriately selected depending on the intended purpose without any limitation, and examples thereof include phenylene diamine, diethyl toluene diamine, 4,4′ diaminodiphenylmethane, 4,4′-diamino-3,3′dimethyldicyclohexylmethane, diamine cyclohexane, isophorone diamine, ethylene diamine, tetramethylene diamine, hexamethylene diamine, diethylene triamine, triethylene tetramine, ethanol amine, hydroxyethyl aniline, aminoethylmercaptan, aminopropylmercaptan, amino propionic acid, and amino caproic acid. Moreover, a ketimine compound and oxazoline compound where amino groups of the preceding amines are blocked with ketones (e.g., acetone, methyl methyl ketone, and methyl isobutyl ketone) are also included as the examples of the amines.

The crystalline resin may be a block copolymer resin having a crystalline segment and a non-crystalline segment, and the crystalline resin can be used as the crystalline segment. A resin used for forming the non-crystalline segment is appropriately selected depending on the intended purpose without any limitation, and examples thereof include a polyester resin, a polyurethane resin, a polyurea resin, a polyamide resin, a polyether resin, a vinyl resin (e.g., polystyrene, and styreneacryl-based polymer), and an epoxy resin.

Since the crystalline segment is preferably at least one selected from the group consisting of a polyester resin, a polyurethane resin, a polyurea resin, a polyamide resin, and a polyether resin, in view of compatibility, the resin used for forming the non-crystalline segment is also preferably selected from a polyester resin, a polyurethane resin, a polyurea resin, a polyamide resin, a polyether resin, and a composite resin thereof, more preferably a polyurethane resin, or a polyester resin. The formulation of the non-crystalline segment can be any combinations of materials which is appropriately selected depending on the intended purpose without any limitation, provided that it is a non-crystalline resin. Examples of a monomer for use include the aforementioned polyol, the aforementioned polycarboxylic acid, the aforementioned polyisocyanate, the aforementioned polyamine, and the aforementioned AO.

The crystalline resin preferably contains a first crystalline resin, and a second crystalline resin that has the larger weight average molecular weight than that of the first crystalline resin. Use of the first crystalline resin and the second crystalline resin in combination can provide the resulting toner with low temperature fixing ability owing to the first crystalline resin, and hot offset resistance owing to the second crystalline resin. In this manner, two different properties are functionally separated, so that a toner capable of performing fixing in the wider temperature range can be provided.

The second crystalline resin is preferably a resin obtained by an elongation reaction and/or crosslink reaction of a modified crystalline resin containing a terminal isocyanate group, because the crystalline resin of the higher molecular weight can be added into the binder resin.

Further, the second crystalline resin is preferably a resin obtained by an elongation reaction and/or crosslink reaction of a modified crystalline resin containing a terminal isocyanate group, that is the first crystalline resin at terminal of which an isocyanate group has been introduced, because the resulting second crystalline resin can be uniformly and finely dispersed in the binder resin, which contributes to provide a toner having much excellent low temperature fixing ability and hot offset resistance.

The weight average molecular weight of the first crystalline resin is appropriately selected depending on the intended purpose without any limitation, but it is preferably 2,000 to 100,000, more preferably 5,000 to 60,000, and even more preferably 8,000 to 30,000, in view of fixing ability of the resulting toner. When the weight average molecular weight thereof is smaller than 2,000, the resulting toner may have insufficient hot offset resistance. When the weight average molecular weight thereof is greater than 100,000, the resulting toner may have insufficient low temperature fixing ability.

The weight average molecular weight of the second crystalline resin is appropriately selected depending on the intended purpose without any limitation, provided that it is larger than that of the first crystalline resin. The weight average molecular weight of the second crystalline resin is preferably 10,000 to 2,000,000, more preferably 30,000 to 1,000,000, and even more preferably 50,000 to 500,000, in view of hot offset resistance of the resulting toner. When the weight average molecular weight thereof is smaller than 10,000, the resulting toner may have insufficient hot offset resistance. When the weight average molecular weight thereof is greater than 2,000,000, the resulting toner may have insufficient low temperature fixing ability.

### <<Non-Crystalline Resin>>

The non-crystalline resin is appropriately selected from conventional resins known in the art depending on the intended purpose without any limitation, provided that it is non-crystalline. Examples thereof include: homopolymer of styrene or substitution thereof (e.g., polystyrene, poly-p-styrene, and polyvinyl toluene), styrene copolymer (e.g., styrene-p-chlorostyrene copolymer, styrene-propylene copolymer, styrene-vinyltoluene copolymer, styrene-methyl acrylate copolymer, styrene-ethyl acrylate copolymer, styrene-methacrylic acid copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer); other resins (e.g., a polymethyl methacrylate resin, a polybutyl methacrylate resin, a polyvinyl chloride resin, a polyvinyl acetate resin, a polyethylene resin, a polypropylene resin, a polyester resin, an epoxy resin, an epoxy polyol resin, a polyurethane resin, a polyamide resin, a polyvinyl butyral resin, a polyacrylic acid resin, a rosin resin, a modified rosin resin, a terpene resin, an aliphatic or alicyclic hydrocarbon resin, an aromatic petroleum resin); and modified products of the preceding resins to contain a functional group reactive an active hydrogen group. These may be used alone, or in combination.

### <Organic-Modified Layered Inorganic Mineral>

The organic-modified layered inorganic mineral is an organic-modified layered inorganic mineral in which at least part of ions present between layers of a layered inorganic mineral are modified with organic ions. The layered inorganic mineral is a layered inorganic mineral formed with layers having the average thickness of several nanometers laminated. The term “modified” means introducing organic ions to ions present between layers of the layered inorganic mineral, specifically, it means substituting at least part of ions present between layers of the layered inorganic mineral with organic ions, or further introducing organic ions between layers of the layered inorganic mineral, or both. In the broad sense, the “modified” means intercalation.

Since the toner of the present invention, which contains the binder resin containing the crystalline resin in an amount of 50% by mass or greater, contains the organic-modified layered inorganic mineral in which at least part of ions present between layers of the layered inorganic mineral are modified with organic ions, the stress resistance is provided to the resulting toner to the same level as the conventional toner, as well as preventing occurrences of image damages during transportation due to recrystallization just after thermal fixing, and formations of output images with insufficient hardness.

The layered inorganic mineral moreover exhibits the maximum effect by located adjacent to a surface of a toner particle, but in the present invention, it has been found that the organic-modified layered inorganic mineral are uniformly aligned adjacent to the surface of the toner particle without any space therebetween. Because of this aligning structure, the structural viscosity of the binder resin present adjacent to the surface of the toner particle is effectively increased, so that the binder resin sufficiently protect the resulting image even though the image is such an image having low hardness of the resin just after fixing. In addition, the organic-modified layered inorganic mineral can efficiently exhibit its effect with a small amount thereof, and therefore it is considered that it hardly affect the fixing ability of the toner.

The presence and state of the organic-modified layered inorganic mineral in the toner can be confirmed by cutting a sample, which has been prepared by embedding toner particles in an epoxy resin or the like, by a micro microtome or ultramicrotome, and observing the cross-sections of the toner particles in the cut surface of the sample under a scanning electron microscope (SEM) or the like. In the case of the observation by SEM, it is preferred that the sample be confirmed in a reflection electron image, as the presence of the organic-modified layered inorganic mineral can be observed with a strong contrast. Alternatively, a sample prepared by embedding toner particles in an epoxy resin or the like is cut with ion beams by means of FIB-STEM (HD-2000, Hitachi, Ltd.), and the cross-sections of the toner particles in the cut surface of the sample may be observed. In this case, visual observation is preferable rather than observing a reflection electron image because of easiness. Alternatively, an ultra-thin sample prepared by cutting by means of a micro microtome or ultramicrotome may be confirmed by observing under a transmission electron microscope (TEM). In this case, the ultra-thin sample may be dyed by a dye such as ruthenium tetraoxide or osmium tetraoxide so that the organic-modified layered inorganic mineral can be easily visually observed. FIGS. 5A and 5B depict diagrams illustrating the result of the observation of one example of the toner of present invention (including the region where the organic-modified layered inorganic mineral is included) by means of TEM (field emission electron microscope, JEM-2100F, manufactured by JEOL Ltd.). In FIG. 5A, the organic-modified layered inorganic mineral b is present in the area that is in the depth of 0 nm to 300 nm from the outer surface of the toner (particle) a.

Moreover, the expression “adjacent to the surface(s) of the toner particle(s)” used in the present specification is defined as the region(s) of the toner particle(s) that is in depth of 0 nm to 300 nm from the outer surface(s) of the toner particle(s) in the observation image of cross-section(s) of toner particle(s) obtained by cut a sample in which toner particles are embedded in an epoxy resin or the like by means of a micro microtome, ultramicrotome, or FIB-STEM, where the cross-section of the toner particle is a cut surface of the toner particle containing a center of the toner particle.

The layered inorganic mineral is appropriately selected depending on the intended purpose without any limitation, and examples thereof include a smectite clay mineral (e.g., montmorillonite, saponite, and hectorite), kaolin clay mineral (e.g., kaolinite), bentonite, attapulgite, magadiite, and kenemite. These may be used alone, or in combination.

The organic-modified layered inorganic mineral is appropriately selected depending on the intended purpose without any limitation, and examples thereof include an organic-modified layered inorganic mineral in which at least part of ions (organic cation or organic anion) present between layers of the layered inorganic mineral are modified with organic ions (organic cation or organic anion). Among them, the organic-modified layered inorganic mineral in which at least part of ions present between layers of a smectite clay mineral having a smectite basic crystal structure are modified with organic cations is preferable because it can be stably dispersed in the area adjacent to surfaces of toner particles. The organic modified layered inorganic mineral in which at least part of ions present between layered of montmorillonite are modified with organic cations, and the organic modified layered inorganic mineral in which at least part of ions present between layers of bentonite are modified with organic cations are particularly preferable.

Examples of the organic-modified layered inorganic mineral further include the layered inorganic compound in which metal anions are introduced by substituting part of bivalent metals of the layered inorganic mineral with trivalent metals, and at least part of the metal anions are further substituted with organic anions.

The modification of part of the ions present between layers of the layered inorganic mineral with organic ions in the organic-modified layered inorganic mineral can be confirmed by has chromatography mass spectroscopy (GCMS). For example, it preferably include a method in which the binder resin in the toner, which is a sample, is dissolved in a solvent to prepare a solution, the resulting solution is subjected to filtration to obtain solids, and the obtained solids are thermally decomposed by means of a thermal decomposition device, to thereby determine the organic material by GCMS. Specifically, there is a method in which as the thermal decomposition device, Py-2020D (manufactured by Frontier Laboratories Ltd.) is used to perform thermal decomposition at 550° C., followed by performing the determination by means of a GCMS device, QP5000 (manufactured by Shimadzu Corporation).

As for the organic-modified layered inorganic mineral, commercial products may be used. Examples of the commercial products thereof include: octanium-18 bentonite, such as BENTONE 3, BENTONE 38, BENTONE 38V (all manufactured by Elements Specialties); TIXOGEL VP (manufactured by ROCKWOOD ADDITIVES LTD.), CLAYTONE 34, CLAYTONE 40, and CLAYTONE XL (all manufactured by Southern Clay Products Inc.); stearalkonium bentonite such as BENTONE 27 (manufactured by Elements Specialties), TIXOGEL LG (manufactured by ROCKWOOD ADDITIVES LTD.), and CLAYTONE AF (manufactured by Southern Clay Products Inc.); octanium-18/benzalkonium bentonite, such as CLAYTONE HT, CLAYTONE PS, and CLAYTONE APA (all manufactured by Southern Clay Products Inc.); organic modified montmorillonite, such as CLAYTONE HY (manufactured by Southern Clay Products Inc.); and organic modified smectite, such as LUCENTITE SPN (manufactured by Kobo Products, Inc.). Among them, CLAYTONE AF, and CLAYTONE APA are particularly preferable.

The organic-modified layered inorganic mineral is particularly preferably the one in which DHT-4A (manufactured by Kyowa Chemical Industry Co., Ltd.) is modified with a compound containing the organic ion represented by R₁(OR₂)nOSO₃M (where R₁ is a C13 alkyl group, R₂ is a C2-C6 alkylene group, n is an integer of 2 to 10, and M is a monovalent metal element). Examples of the compound containing the organic ion represented by R₁(OR₂)nOSO₃M include HITENOL 330T (manufactured by Dai-ichi Kogyo Seiyaku Co., Ltd.).

The organic-modified layered inorganic mineral may be mixed with a resin to form a master batch that is a composite thereof with the resin, and may be used as the master batch. The resin is appropriately selected from those known in the art depending on the intended purpose without any limitation.

An amount of the organic-modified layered inorganic mineral in the toner is preferably 0.1% by mass to 3.0% by mass, more preferably 0.5% by mass to 2.0% by mass, and even more preferably 1.0% by mass to 1.5% by mass. When the amount thereof is less than 0.1% by mass, the effect of the layered inorganic mineral may not be effectively exhibited. When the amount thereof is greater than 3.0% by mass, low temperature fixing ability may be inhibited.

The organic ion modification agent, which contains organic ions and is a compound capable of modifying at least part of the ions present between layers of the layered inorganic mineral with organic ions, is appropriately selected depending on the intended purpose without any limitation. Examples thereof include: a quaternary alkyl ammonium salt; a phosphonium salt; an imidazolium salt; sulfate having a backbone of C1-C44 branched, non-branched, or cyclic alkyl, C1-C22 branched, non-branched, or cyclic alkenyl, C8-C32 branched, non-branched, or cyclic alkoxy, or C2-C22 branched, non-branched, or cyclic hydroxyalkyl ethyleneoxide, or propylene oxide; a sulfonic acid salt having the aforementioned backbone; a carboxylic acid salt having the aforementioned backbone; and a phosphoric acid salt having the aforementioned backbone. Among them, a quaternary alkyl ammonium salt, and a carboxylic acid salt having an ethylene oxide backbone are preferable, and the quaternary alkyl ammonium salt is particularly preferable. These may be used alone, or in combination.

Examples of the quaternary alkyl ammonium include trimethylstearyl ammonium, dimethylstearylbenzyl ammonium, dimethyloctadecyl ammonium, and oleylbis(2-hydroxyethyl)methyl ammonium.

A modification amount with the organic ions is appropriately selected depending on the intended purpose without any limitation, but it is preferably 5% by mass to 60% by mass, more preferably 25% by mass to 45% by mass, relative to the layered inorganic mineral. When the modification amount is within the aforementioned preferable range, the organic-modified layered inorganic mineral tends to be easily and uniformly aligned adjacent to a surface of a toner particle. When the modification amount thereof is within the aforementioned more preferable range, the uniform alignment thereof becomes more significant.

### <Colorant>

The colorant is appropriately selected from conventional dyes and pigments known in the art depending on the intended purpose without any limitation, and examples thereof include: carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone. These may be used alone, or in combination.

A color of the colorant is appropriately selected depending on the intended purpose without any limitation, and examples thereof include a colorant for black, and color colorants for magenta, cyan, and yellow. These may be used alone, or in combination.

Examples of the colorant for black include: carbon black (C.I. Pigment Black 7) such as furnace black, lamp black, acetylene black, and channel black; metals such as copper, iron (C.I. Pigment Black 11), and titanium oxide; and organic pigments such as aniline black (C.I. Pigment Black 1).

Examples of the colorant for magenta include: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 163, 177, 179, 202, 206, 207, 209, 211; C.I. Pigment Violet 19; and C.I. Vat Red 1, 2, 10, 13, 15, 23, 29, 35.

Examples of the colorant for cyan include: C.I. Pigment Blue 2, 3, 15, 15:1, 15:2, 15:3, 15:4, 15:6, 16, 17, 60; C.I. Vat Blue 6; C.I. Acid Blue 45, a copper phthalocyanine pigment, a copper phthalocyanine pigment in which 1 to 5 methyl phthalimide groups have been introduced to the phthalocyanine backbone, Green 7, and Green 36.

Examples of the colorant for yellow include: C.I. Pigment Yellow 0-16, 1, 2, 3, 4, 5, 6, 7, 10, 11, 12, 13, 14, 15, 16, 17, 23, 55, 65, 73, 74, 83, 97, 110, 151, 154, 180; C.I. Vat Yellow 1, 3, 20; and C.I. Pigment Orange 36.

An amount of the colorant in the toner is appropriately selected depending on the intended purpose without any limitation, but it is preferably 1% by mass to 15% by mass, more preferably 3% by mass to 10% by mass. When the amount thereof is smaller than 1% by mass, the tinting strength reduces. When the amount thereof is greater than 15% by mass, a dispersion failure of the pigment particles occurs in the toner, which may cause reduction in tinting strength and electric characteristics of the toner.

The colorant may form a composite with a resin for master batch, and may be used as a master batch. The resin for master batch is appropriately selected from those known in the art depending on the intended purpose without any limitation, and examples thereof include polymer of styrene or substitution thereof, styrene copolymer, a polymethyl methacrylate resin, a polybutyl methacrylate resin, a polyvinyl chloride resin, a polyvinyl acetate resin, a polyethylene resin, a polypropylene resin, a polyester resin, an epoxy resin, an epoxypolyol resin, a polyurethane resin, a polyamide resin, a polyvinyl butyral, a polyacrylic acid resin, rosin, modified rosin, a terpene resin, an aliphatic hydrocarbon resin, an alicyclic hydrocarbon resin, an aromatic petroleum resin, chlorinated paraffin, and paraffin wax. These may be used alone, or in combination.

Examples of the polymer of styrene or substitution thereof include a polyester resin, a polystyrene resin, a poly-p-chlorostyrene resin, and polyvinyl toluene resin. Examples of the styrene copolymer include styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl-α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer.

As for the resin for the master batch, the binder resin of the present invention, such as the aforementioned crystalline resin, can be used without any problem.

The master batch can be prepared by mixing and kneading the colorant with the resin for the master batch. In the mixing and kneading, an organic solvent may be used for improving the interactions between the colorant and the resin. Moreover, the master batch can be prepared by a flashing method in which an aqueous paste containing a colorant is mixed and kneaded with a resin and an organic solvent, and then the colorant is transferred to the resin to remove the water and the organic solvent. This method is preferably used because a wet cake of the colorant is used as it is, and it is not necessary to dry the wet cake of the colorant to prepare a colorant. In the mixing and kneading of the colorant and the resin, a high-shearing disperser (e.g., a three-roll mill) is preferably used.

### <Other Components>

The toner of the present invention may contain other components than the binder resin, colorant, and organic-modified layered inorganic mineral, if necessary, provided that the obtainable effect of the invention is not impaired. Examples of the aforementioned components include a releasing agent, a charge controlling agent, an external additive, a flow improving agent, a cleaning improving agent, and a magnetic material.

### <<Releasing Agent>>

The releasing agent is appropriately selected from those known in the art without any limitation, and examples thereof include wax, such as carbonyl group-containing wax, polyolefin wax, and a long chain hydrocarbon. These may be used alone, or in combination. Among them, the carbonyl group-containing wax is preferable.

Examples of the carbonyl group-containing wax include polyalkanoic acid ester, polyalkanol ester, polyalkanoic acid amide, polyalkyl amide, and dialkyl ketone.

Examples of the polyalkanoic acid ester include carnauba wax, montan wax, trimethylolpropane tribehenate, pentaerythritol tetrabehenate, pentaerythritol diacetate dibehenate, glycerin tribehenate, and 1,18-octadecanediol distearate. Examples of the polyalkanol ester include tristearyl trimellitate, and distearyl maleate. Examples of the polyalkanoic acid amide include dibehenyl amide. Examples of the polyalkyl amide include trimellitic acid tristearyl amide. Examples of the dialkyl ketone include distearyl ketone. Among the carbonyl group-containing wax mentioned above, polyalkanoic acid ester is particularly preferable.

Examples of the polyolefin wax include polyethylene wax, and polypropylene wax.

Examples of the long chain hydrocarbon include paraffin wax, and Sasol wax.

The melting point of the releasing agent is appropriately selected depending on the intended purpose without any limitation, but it is preferably 40° C. to 160° C., more preferably 50° C. to 120° C., and even more preferably 60° C. to 90° C. When the melting point thereof is lower than 40° C., use of such releasing agent may adversely affect the heat resistant storage stability of the resulting toner. When the melting point thereof is higher than 160° C., the resulting toner is likely to cause cold offset during the fixing at low temperature.

The melting point of the releasing agent can be measured, for example, by means of a differential scanning calorimeter (DSC210, Seiko Instruments Inc.) in the following manner. A sample of the releasing agent is heated to 200° C., cooled from 200° C. to 0° C. at the cooling rate of 10° C./min., followed by heating at the heating rate of 10° C./min. The maximum peak temperature of heat of melting as obtained is determined as a melting point of the releasing agent.

A melt viscosity of the releasing agent, which is measured at the temperature higher than the melting point of the releasing agent by 20° C., is preferably 5 cps to 1,000 cps, more preferably 10 cps to 100 cps. When the melt viscosity thereof is lower than 5 cps, the releasing ability of the toner may be degraded. When the melt viscosity thereof is higher than 1,000 cps, the effect of improving hot offset resistance and low temperature fixing ability may not be attained.

An amount of the releasing agent in the toner is appropriately selected depending on the intended purpose without any limitation, but it is preferably 0% by mass to 40% by mass, more preferably 3% by mass to 30% by mass. When the amount of the releasing agent is greater than 40% by mass, the flowability of the toner particles may be degraded.

### <<Charge Controlling Agent>>

The charge controlling agent is appropriately selected from those known in the art without any limitation, but it is preferably a no-color or white material as use of a colored material as the charge controlling agent may change a color tone of the toner. Examples of such charge controlling agent include a triphenyl methane dye, a molybdic acid chelate compound, Rhodamine dye, alkoxy amine, a quaternary ammonium salt (including a fluorine-modified quaternary ammonium salt), alkylamide, phosphor and a compound including phosphor, tungsten and a compound including tungsten, a fluorine-containing activator, a metal salt of salicylic acid, and a metal salt of salicylic acid derivative. These may be used alone, or in combination.

The charge controlling agent may be selected from commercial products thereof, and examples of the commercial products include: BONTRON P-51 (quaternary ammonium salt), E-82 (oxynaphthoic acid-based metal complex), E-84 (salicylic acid-based metal complex) and E-89 (phenol condensate), all manufactured by ORIENT CHEMICAL INDUSTRIES CO., LTD; TP-302 and TP-415 (quaternary ammonium salt molybdenum complexes) both manufactured by Hodogaya Chemical Co., Ltd.; COPY CHARGE PSY VP 2038 (quaternary ammonium salt), COPY BLUE PR (triphenylmethane derivative), COPY CHARGE NEG VP2036 and COPY CHARGE NX VP434 (quaternary ammonium salts), all manufactured by Hoechst AG; LRA-901 and LR-147 (boron complexes), both manufactured by Japan Carlit Co., Ltd.; quinacridone; azo pigments; and polymeric compounds having, as a functional group, a sulfonic acid group, carboxyl group, quaternary ammonium salt, etc.

The charge controlling agent may be dissolved and dispersed after being melted and kneaded together with the master batch, or added together with other components of the toner directly to an organic solvent when dissolution and/or dispersion is performed. Alternatively, the charge controlling agents may be fixed on surfaces of toner particles after the production of the toner particles.

An amount of the charge controlling agent in the toner cannot be determined unconditionally, as it varies depending on the binder resin for use, the presence of the additive, the dispersion method, etc. For example, an amount of the charge controlling agent is preferably 0.1 parts by mass to 10 parts by mass, more preferably 0.2 parts by mass to 5 parts by mass, relative to 100 parts by mass of the binder resin. When the amount thereof is smaller than 0.1 parts by mass, the charge controlling ability cannot be attained. When the amount thereof is greater than 10 parts by mass the electrostatic propensity of the resulting toner is excessively large, which reduces the effect of charge controlling agent. As a result, the electrostatic suction force toward the developing roller may increase, which may cause poor flowing ability of the developer, and low image density.

### <<External Additive>>

The external additive is appropriately selected from those known in the art depending on the intended purpose without any restriction, and examples thereof include silica particles, hydrophobic silica particles, a fatty acid metal salt (e.g., zinc stearate, and aluminum stearate), metal oxide (e.g., titanium oxide, alumina, tin oxide, and antimony oxide), hydrophobic metal oxide particles, and fluoropolymer. Among them, hydrophobic silica particles, hydrophobic titanium oxide particles, and hydrophobic alumina particles are preferable.

Examples of the silica particles include: HDK H 2000, HDK H 2000/4, HDK H 2050EP, HVK21, and HDK H1303 (all manufactured by Hoechst AG); and R972, R974, RX200, RY200, R202, R805, and R812 (all manufactured by Nippon Aerosil Co., Ltd.). Examples of the titanium oxide particles include: P-25 (manufactured by Nippon Aerosil Co., Ltd.); STT-30, and STT-65C-S (both manufactured by Titan Kogyo, Ltd.); TAF-140 (manufactured by Fuji Titanium Industry Co., Ltd.); and MT-150W, MT-500B, MT-600B, and MT-150A (all manufactured by TAYCA CORPORATION). Examples of the hydrophobic titanium oxide particles include: T-805 (manufactured by Nippon Aerosil Co., Ltd.); STT-30A, and STT-65S-S (both manufactured by Titan Kogyo, Ltd.); TAF-500T, and TAF-1500T (both manufactured by Fuji Titanium Industry Co., Ltd.); MT-100S, and MT-100T (both manufactured by TAYCA CORPORATION); and IT-S (manufactured by ISHIHARA SANGYO KAISHA, LTD.).

In order to attain hydrophobic silica particles, hydrophobic titanium oxide particles, and hydrophobic alumina particles, hydrophilic particles (e.g., silica particles, titanium oxide particles, and alumina particles) are treated with a silane coupling agent such as methyltrimethoxy silane, methyltriethoxy silane, and octyltrimethoxy silane.

As for the external additive, silicone-oil-treated inorganic particles, which have been treated with silicone oil, optionally with an application of heat, can be suitably used.

As for the silicone oil, for example, dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxyl-modified silicone oil, mercapto-modified silicone oil, acryl or methacryl-modified silicone oil, and α-methylstyrene-modified silicone oil can be used.

Examples of the inorganic particles include silica, alumina, titanium oxide, barium titanate, magnesium titanate, calcium titanate, strontium titanate, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride. Among them, silica, and titanium dioxide are particularly preferable.

An amount of the external additive for use is preferably 0.1% by mass to 5% by mass, more preferably 0.3% by mass to 3% by mass, relative to the toner.

The number average particle diameter of primary particles of the inorganic particles is preferably 100 nm or smaller, more preferably 3 nm to 70 nm. When the number average particle diameter thereof is smaller than 3 nm, the inorganic particles are embedded into the toner particles, and therefore the inorganic particles do not effectively function. When the number average particle diameter is greater than 100 nm, the inorganic particles may unevenly damage a surface of a latent electrostatic image bearing member, and hence not preferable.

As the external additive, the inorganic particles, hydrophobic inorganic particles and the like may be used in combination. The number average particle diameter of primary particles of hydrophobic particles is preferably 1 nm to 100 nm. Of these, it is preferred that the external additive contain two types of inorganic particles having the number average particle diameter of 5 nm to 70 nm. Further, it is preferred that the external additive contain two types of inorganic particles having the number average particle of hydrophobic-treated primary particles thereof being 20 nm or smaller, and one type of inorganic particles having the number average particle thereof of 30 nm or greater. Moreover, the external additive preferably has BET specific surface area of 20 m²/g to 500 m²/g.

Examples of the surface treating agent for the external additive containing the oxide particles include: a silane-coupling agent (e.g., dialkyl dihalogenated silane, trialkyl halogenated silane, alkyl trihalogenated silane, and hexaalkyl disilazane), a sililation agent, a silane-coupling agent containing a fluoroalkyl group, an organic titanate-based coupling agent, an aluminum-based coupling agent, silicone oil, and silicone varnish.

As the external additive, resin particles can also be added. Examples of the resin particles include; polystyrene obtained by a soap-free emulsification polymerization, suspension polymerization, or dispersion polymerization; copolymer of methacrylic ester or acrylic ester; polymer particles obtained by polymerization condensation, such as silicone, benzoguanamine, and nylon; and polymer particles formed of a thermoset resin. Use of these resin particles in combination can reinforce the charging ability of the toner, reduces reverse charges of the toner, reducing background deposition. An amount of the resin particles for use is preferably 0.01% by mass to 5% by mass, more preferably 0.1% by mass to 2% by mass, relative to the toner.

### <<Flow Improving Agent>>

The flow improving agent is an agent capable of performing surface treatment of the toner to increase hydrophobicity, and preventing degradations of flow properties and charging properties of the toner even in a high humidity environment. Examples of the flow improving agent include a silane-coupling agent, a sililation agent, a silane-coupling agent containing a fluoroalkyl group, an organic titanate-based coupling agent, an aluminum-based coupling agent, silicone oil, and modified silicone oil.

### <<Cleaning Improving Agent>>

The cleaning improving agent is added to the toner for the purpose of removing the developer remained on a latent electrostatic image bearing member or intermediate transfer member after transferring. Examples of the cleaning improving agent include: fatty acid metal salt such as zinc stearate, calcium stearate, and stearic acid; and polymer particles produced by soap-free emulsification polymerization, such as polymethyl methacrylate particles, and polystyrene particles. The polymer particles are preferably those having a relatively narrow particle size distribution, and the polymer particles having the weight average particle diameter of 0.01 μm to 1 μm are preferably used.

### <<Magnetic Material>>

The magnetic material is appropriately selected from those known in the art depending on the intended purpose without any limitation, and examples thereof include iron powder, magnetite, and ferrite. Among them, a white magnetic material is preferable in view of color tone.

### [Properties of Toner]

In order to achieve both low temperature fixing ability and heat resistant storage stability of highly desirable level, and to achieve excellent hot offset resistance of the toner of the present invention, the toner satisfies: 45≦Ta≦70, and 0.8≦Tb/Ta≦1.55, where Ta (° C.) is the maximum peak temperature of heat of melting the toner measured by a differential scanning calorimeter, and Tb (° C.) is a softening point of the toner measured by an elevated flow tester. In addition, the toner preferably satisfies: 1.0×10³≦G′(Ta+20)≦5.0×10⁶, and 1.0×10³≦G″(Ta+20)≦5.0×10⁶, where G′(Ta+20) (Pa·s) is the storage elastic modulus of the toner at the temperature of (Ta+20)° C., and G″(Ta+20) (Pa·s) is the loss elastic modulus of the toner at the temperature of (Ta+20)° C.

The maximum peak temperature (Ta) of heat of melting the toner is appropriately selected depending on the intended purpose without any limitation, but it is preferably 45° C. to 70° C., more preferably 53° C. to 65° C., and even more preferably 58° C. to 62° C. When Ta is 45° C. to 70° C., the minimum heat resistance storage stability required for the toner can be secured, and the toner having low temperature fixing ability more excellent than that of the conventional toner can be attained. When Ta is lower than 45° C., the desirable low temperature fixing ability of the toner can be attained, but the heat resistant storage stability is insufficient. When Ta is higher than 70° C., the heat resistant storage stability is improved, but the low temperature fixing ability reduces.

The ratio (Tb/Ta) of the softening temperature (Tb) of the toner to the maximum peak temperature (Ta) of heat of melting the toner is appropriately selected depending on the intended purpose without any limitation, but it is preferably 0.8 to 1.55, more preferably 0.85 to 1.25, even more preferably 0.9 to 1.2, and particularly preferably 0.9 to 1.19. The toner has a property that the resin sharply softens as the value of Tb reduces, which is excellent in terms of both low temperature fixing ability and heat resistant storage stability.

As for the viscoelastic properties of the toner, the storage elastic modulus G′(Ta+20) at the temperature of (Ta+20)° C. is preferably 1.0×10³ Pa·s to 5.0×10⁶ Pa·s in view of fixing strength and hot offset resistance, and more preferably 1.0×10⁴ Pa-s to 5.0×10⁵ Pa·s. Moreover, the loss elastic modulus G″(Ta+20) at the temperature of (Ta+20)° C. is preferably 1.0×10³ Pa·s to 5.0×10⁶ Pa·s in view of hot offset resistance, and more preferably 1.0×10⁴ Pa·s to 5.0×10⁵ Pa·s.

Further, the toner preferably satisfies: 0.05≦[G″(Ta+30)/G″(Ta+70)]≦50, where G″(Ta+30) (Pa·s) is the loss elastic modulus of the toner at the temperature of (Ta+30)° C., and G″(Ta+70) (Pa·s) is the loss elastic modulus at the temperature of (Ta+70)° C. By designing the toner to fall into the aforementioned range, the change in the loss elastic modulus of the toner against the temperature becomes mild, so that the resulting toner has excellent hot offset resistance with maintaining low temperature fixing ability. The value of [G″(Ta+30)/G″(Ta+70)] is preferably 0.05 to 50, more preferably 0.1 to 40, and even more preferably 0.5 to 30.

The viscoelastic properties of the toner can be appropriately controlled by adjusting a mixing ratio of the crystalline resin and non-crystalline resin constituting the binder resin, molecular weight of each resin, or formulation of the monomer mixture.

### [Production Method of Toner]

The toner of the present invention contains at least the binder resin, the colorant, and the organic-modified layered inorganic mineral, where the binder resin contains the crystalline resin in an amount of 50% by mass or greater, and the organic-modified layered inorganic mineral is the organic-modified layered inorganic mineral in which at least part of ions present between layers of a layered inorganic mineral are modified with organic ions, and a production method and materials of the toner can be selected from any of methods and materials known in the art without any limitation, as long as the resulting toner satisfies the aforementioned conditions. Examples of the production method thereof include a kneading-pulverization method, and a method in which toner particles are granulated in an aqueous medium, so-called a chemical method. In the chemical method, it is possible to easily granulate particles of a crystalline resin, and to easily locate the organic-modified layered inorganic mineral to the areas adjacent to the surfaces of the toner particles. Accordingly, the chemical method is preferable.

Examples of the chemical method where toner particles are granulated in an aqueous medium include: a suspension polymerization method, emulsification polymerization method, seed polymerization method, and dispersion polymerization method, all of which use a monomer as a starting material; a dissolution suspension method in which a resin or resin precursor is dissolved in an organic solvent, and the resulting solution is dispersed and/or emulsified in an aqueous medium; a phase-transfer emulsification method in which water is added to a solution containing a resin or resin precursor, and an appropriate emulsifying agent to proceed phase transfer; and an aggregation method in which resin particles formed in any of the aforementioned methods is dispersed in an aqueous medium, and aggregated by heating and fusing to granulate particles of the predetermined size. Among them, the toner obtained by the dissolution suspension method is preferable because of granulation ability of the crystalline resin (e.g., easiness in control of particle size distribution, and control of particle shape), or orientation of organic-modified layered inorganic mineral adjacent to surface layers of toner particles.

These production methods will be specifically explained hereinafter.

The kneading-pulverization method is a method for producing toner base particles, for example, by melting and kneading a toner composition containing at least a colorant, a binder resin and a layered inorganic mineral, pulverizing the resulting kneaded product, and classifying the pulverized particles.

In the melting and kneading, materials of the toner composition are mixed, and the resulting mixture is placed in a melt-kneader to perform melting and kneading. As the melt-kneader, for example, a monoaxial or biaxial continuous kneader, or a batch-type kneader with a roll mill can be used. Preferable examples thereof include a twin screw extruder KTT manufactured by KOBE STEEL, LTD., an extruder TEM manufactured by TOSHIBA MACHINE CO., LTD., a twin screw extruder manufactured by ASADA WORKS CO., LTD., a twin screw extruder PCM manufactured by Ikegai Corp., and a cokneader manufactured by Buss. The melt-kneading is preferably performed under the appropriate conditions so as not to cause scission of molecular chains of the binder resin. Specifically, the temperature of the melt-kneading is adjusted under taking the softening point of the binder resin as consideration. When the temperature of the melt-kneading is very high compared to the softening point, the scission occurs significantly. When the temperature thereof is very low compared to the softening point, the dispersing may not be progressed.

In the pulverizing, the kneaded product obtained by the kneading is pulverized. In the pulverizing, it is preferred that the kneaded product be coarsely pulverized, followed by finely pulverized. For the pulverizing, a method in which the kneaded product is pulverized by making the kneaded product to crush into an impact plate in the jet stream, a method in which particles of the kneaded product are made crushed each other in the jet stream to thereby pulverize the kneaded product, or a method in which the kneaded product is pulverized in a narrow gap between a mechanically rotating rotor and a stator is preferably used.

The classifying is classifying the pulverized product obtained by the pulverizing into particles having the predetermined particle diameters. The classifying can be performed by removing the fine particles component by means of a cyclone, a decanter, a centrifugal separator, or the like.

After the completion of the pulverizing and the classifying, the classified pulverized product is classified in an air stream by centrifugal force or the like to thereby produce toner base particles having the predetermined particle diameters.

The chemical method is appropriately selected depending on the intended purpose without any limitation, but the preferable method thereof is a method for granulating toner base particles by dispersing and/or emulsifying a toner composition containing at least the binder resin, the colorant, and the organic-modified layered inorganic mineral. As for the toner of the present invention, a toner obtained by granulating toner particles by dispersing and/or emulsifying particles containing at least the binder resin, the colorant, and the organic-modified layered inorganic mineral in an aqueous medium is preferable.

As for the chemical method, the preferable method is a method in which an oil phase, which has been prepared by dissolving and/or dispersing in an organic solvent a toner composition containing at least the binder resin and/or the binder resin precursor, the colorant, and the organic-modified layered inorganic mineral, is dispersed and/or emulsified in an aqueous medium to granulate base particles of the toner.

Since the crystalline resin excels in impact resistance, it is not suitable for use in a pulverization method in terms of energy efficiency, and in the toner using the crystalline resin, it is difficult to align the organic-modified layered inorganic mineral adjacent to the surfaces of the toner particles. On the other hand, particles can be easily granulated using the crystalline resin in the dissolution suspension method, or ester elongation method, and these methods are preferable, as the organic-modified layered inorganic mineral are uniformly aligned adjacent to surfaces of toner particles during the dispersing and/or emulsifying in the aqueous medium.

The method for producing the resin particles containing at least the binder resin is appropriately selected depending on the intended purpose without any restriction, and examples thereof include the following (a) to (h):

(a) In the case of a vinyl resin particles, a method for directly produce an aqueous dispersion liquid of resin particles by a polymerization reaction of a suspension polymerization method, emulsification polymerization method, seed polymerization method, or dispersion polymerization method, using a monomer as a starting material.
(b) In the case of a polyaddition or condensation resin such as a polyester resin, polyurethane resin, and epoxy resin, a method for producing an aqueous dispersion liquid of resin particles by dispersing a precursor (e.g. a monomer, and oligomer) or a solvent solution thereof in an aqueous medium in the presence of an appropriate dispersant, followed by curing the particles by heating or adding a curing agent.
(c) In the case of a polyaddition or condensation resin such as a polyester resin, polyurethane resin, and epoxy resin, a method in which after dissolving an appropriate emulsifying agent in a precursor (e.g., a monomer and oligomer) or a solvent solution thereof (preferably in form of a liquid, which may be one liquefied by heating), water is added thereto to perform phase transfer emulsification.
(d) A method in which a resin that has been prepared by a polymerization reaction (which may be any polymerization reaction selected from addition polymerization, ring-opening polymerization, polyaddition, addition condensation, and condensation polymerization) in advance is pulverized by means of a pulverizer of mechanical ration system or jet system, followed by classification to obtain resin particles, and the resulting resin particles are dispersed in water in the presence of an appropriate dispersant.
(e) A method in which a resin that has been prepared by a polymerization reaction (which may be any polymerization reaction selected from addition polymerization, ring-opening polymerization, polyaddition, addition condensation, and condensation polymerization) in advance is dissolved in a solvent to prepare a resin solution, the resin solution is sprayed in form of mist to obtain resin particles, and the resulting resin particles are dispersed in water in the presence of an appropriate dispersant.
(f) A method in which a resin that has been prepared by a polymerization reaction (which may be any polymerization reaction selected from addition polymerization, ring-opening polymerization, polyaddition, addition condensation, and condensation polymerization) in advance is dissolved in a solvent to prepare a resin solution, resin particles are precipitated by adding a solvent to the resin solution or cooling the resin solution into which a solvent has been dissolved by heating, followed by removing the solvent to obtain resin particles, and the resulting resin particles are dispersed in water in the presence of an appropriate dispersant.
(g) A method in which a resin that has been prepared by a polymerization reaction (which may be any polymerization reaction selected from addition polymerization, ring-opening polymerization, polyaddition, addition condensation, and condensation polymerization) in advance is dissolved in a solvent to prepare a resin solution, the resulting resin solution is dispersed in an aqueous medium in the presence of an appropriate dispersant, and the solvent is removed therefrom by heating or reducing the pressure.
(h) A method in which a resin that has been prepared by a polymerization reaction (which may be any polymerization reaction selected from addition polymerization, ring-opening polymerization, polyaddition, addition condensation, and condensation polymerization) in advance is dissolved in a solvent to prepare a resin solution, an appropriate emulsifying agent is dissolved in the resulting resin solution, and water is added thereto to perform phase transfer emulsification.

For emulsifying and/or dispersing in an aqueous medium, a surfactant or a polymer protective colloid can be optionally used.

### —Surfactant—

The surfactant is appropriately selected depending on the intended purpose without any limitation, and examples thereof include: anionic surfactants such as alkyl benzene sulfonic acid salts, α-olefin sulfonic acid salts and phosphoric acid esters; cationic surfactants, such as amine salts (e.g., alkyl amine salts, amino alcohol fatty acid derivatives, polyamine fatty acid derivatives and imidazoline), and quaternary ammonium salt (e.g., alkyltrimethylammonium salts, dialkyldimethylammonium salts, alkyl dimethyl benzyl ammonium salts, pyridinium salts, alkyl isoquinolinium salts and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine.

Also, a fluoroalkyl group-containing surfactant can exhibit its dispersing effects even in a small amount. Examples of the fluoroalkyl group-containing surfactant include a fluoroalkyl group-containing anionic surfactant, and a fluoroalkyl group-containing cationic surfactant.

Examples of the fluoroalkyl group-containing anionic surfactant include C2-C10 fluoroalkyl carboxylic acid or a metal salt thereof, disodium perfluorooctane sulfonyl glutamate, sodium 3-[ω-fluoroalkyl(C6-C11)oxy)-1-alkyl(C3-C4) sulfonate, sodium 3-[ω-fluoroalkanoyl(C6-C8)-N-ethylamino]-1-propanesulfonate, fluoroalkyl(C11-C20) carboxylic acid or a metal salt thereof, perfluoroalkylcarboxylic acid(C7-C13) or a metal salt thereof, perfluoroalkyl(C4-C12)sulfonate or a metal salt thereof, perfluorooctanesulfonic acid diethanol amide, N-propyl-N-(2-hydroxyethyl)perfluorooctanesulfone amide, perfluoroalkyl(C6-C10)sulfoneamidepropyltrimethylammonium salt, a salt of perfluoroalkyl(C6-C10)-N-ethylsulfonylglycin and monoperfluoroalkyl(C6-C16) ethylphosphate.

Examples of the fluoroalkyl group-containing cationic surfactant include a fluoroalkyl group-containing aliphatic primary or secondary amine acid, aliphatic quaternary ammonium salt such as a perfluoroalkyl(C6 to C10)sulfonic amide propyltrimethyl ammonium salt, benzalkonium salt, benzetonium chloride, pyridinium salt and imidazolinium salt.

### —Polymer Protective Colloid—

The polymer protective colloid is appropriately selected depending on the intended purpose without any limitation, and examples thereof include: acids such as acids such as acrylic acid, methacrylic acid, α-cyanoacrylic acid, α-cyanomethacrylic acid, itaconic acid, crotonic acid, fumaric acid, maleic acid and maleic anhydride; (meth)acryl monomer containing a hydroxyl group, such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acryl amide, and N-methylol methacryl amide; vinyl alcohol or ethers with vinyl alcohol, such as vinyl methyl ether, vinyl ethyl ether, and vinyl propyl ether; ester of vinyl alcohol and a compound containing a carboxyl group, such as vinyl acetate, vinyl propionate, and vinyl butyrate; acryl amide, methacryl amide, diacetone acryl amide or methylol compounds of the preceding amides; acid chlorides, such as acrylic acid chloride, and methacrylic acid chloride; a homopolymer or copolymer containing a nitrogen atom or its heterocycle, such as vinyl pyridine, vinyl pyrrolidone, vinyl imidazole, and ethylene imine; polyoxyethylenes, such as polyoxy ethylene, polyoxypropylene, polyoxy ethylene alkyl amine, polyoxypropylene alkyl amine, polyoxyethylene alkyl amide, polyoxypropylene alkyl amide, polyoxyethylene nonylphenyl ether, polyoxyethylene laurylphenyl ether, polyoxyethylene stearylphenyl ester, and polyoxyethylene nonylphenyl ester; and celluloses such as methyl cellulose, hydroxyethyl cellulose, and hydroxypropyl cellulose.

### —Organic Solvent—

As for the organic solvent used for dissolving or dispersing the toner composition containing the binder resin, binder resin precursor, colorant, and organic-modified layered inorganic mineral, a volatile organic solvent having a boiling point of lower than 100° C. is preferable because it can be easily removed in the later step.

Examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone, and methyl isobutyl ketone. These may be used alone, or in combination. Among them, the ester-based solvent such as methyl acetate, and ethyl acetate, the aromatic solvent such as toluene, and xylene, and the halogenated hydrocarbon such as methylene chloride, 1,2-dichloroethane, chloroform, and carbon tetrachloride are preferable.

The solid content of the oil phase, which is obtained by dissolving and/or dispersing the toner composition containing the binder resin or binder resin precursor, the colorant, and the organic-modified layered inorganic mineral is preferably 40% by mass to 80% by mass. The excessively high solid content thereof causes difficulties in dissolving or dispersing, and increases the viscosity of the oil phase which is difficult to handle. The excessively low solid content thereof leads to a low yield of the toner.

The toner composition excluding the resin, such as the colorant, and the organic-modified layered inorganic mineral, and master batches thereof may be separately dissolved and/or dispersed in an organic solvent, and then mixed with the resin solution and/or dispersion.

### —Aqueous Medium—

As for the aqueous medium, water may be used solely, or water may be used in combination with water-miscible solvent. Examples of the water-miscible solvent include alcohol (e.g., methanol, isopropanol, and ethylene glycol), dimethyl formamide, tetrahydrofuran, cellosolves (e.g., methyl cellosolve), and lower ketones (e.g., acetone, and methyl ethyl ketone).

An amount of the aqueous medium used to 100 parts by mass of the toner composition is appropriately selected depending on the intended purpose without any limitation, but it is typically 50 parts by mass to 2,000 parts by mass, preferably 100 parts by mass to 1,000 parts by mass. When the amount of the water-miscible solvent is smaller than 50 parts by mass, the toner composition cannot be desirably dispersed, which enables to provide toner particles having the predetermined particle diameters. When the amount thereof is greater than 2,000 parts by mass, it is not economical.

Inorganic dispersant and/or organic resin particles may be dispersed in the aqueous medium in advance, which is preferable for giving a sharp particle distribution to the resulting toner, and giving dispersion stability.

Examples of the inorganic dispersant include tricalcium phosphate, calcium carbonate, titanium oxide, colloidal silica and hydroxyapatite.

As for the resin for forming the organic resin particles, any resin can be used as long as it is a resin capable of forming an aqueous dispersant, and the resin for forming the organic resin particles may be a thermoplastic resin or thermoset resin. Examples of the resin for forming the organic resin particles include a vinyl resin, a polyurethane resin, an epoxy resin, a polyester resin, a polyamide resin, a polyimide resin, a silicon resin, a phenol resin, a melamine resin, a urea resin, an aniline resin, an iomer resin, and a polycarbonate resin. These may be used alone, or in combination. Among them, a vinyl resin, a polyurethane resin, an epoxy resin, a polyester resin, and a combination of any of the preceding resins are preferable because an aqueous dispersion liquid of fine spherical resin particles can be easily obtained.

The method for emulsifying and/or dispersing in the aqueous medium is not particularly limited, and to which a conventional equipment, such as a low-speed shearing disperser, a high-speed shearing disperser, a friction disperser, a high-pressure jetting disperser and ultrasonic wave disperser, can be employed. Among them, the high-speed shearing disperser is preferable in view of miniaturizing size of particles. In use of the high-speed shearing disperser, the rotating speed is appropriately selected without any limitation, but it is typically 1,000 rpm to 30,000 rpm, preferably 5,000 rpm to 20,000 rpm. The temperature for dispersing is typically 0° C. to 150° C. (in a pressurized state), preferably 20° C. to 80° C.

In the case where the toner composition contains the binder resin precursor, the compound containing an active hydrogen group, which is necessary for an elongation and/or crosslink reaction of the binder resin precursor, may be mixed in an oil phase before dispersing the toner composition in an aqueous medium, or mixed in the aqueous medium.

In order to remove the organic solvent from the obtained emulsified dispersion liquid, a conventional method known in the art can be used, and for example, a method, in which the temperature of the entire system is gradually increased under normal pressure or reduced pressure, to completely evaporate and remove the organic solvent in the droplets, can be employed.

In the case where the aggregation method is used in the aqueous medium, the resin particle dispersion liquid, colorant dispersion liquid, and the organic-modified layered inorganic mineral dispersion liquid obtained in the aforementioned manner, and optionally a dispersion liquid of a releasing agent or the like are mixed and aggregated together to thereby granulate particles. The resin particle dispersion liquid may be solely used, or two or more resin particle dispersion liquids may be added. Further, the resin particle dispersion liquid may be added at once, or added stepwise by few times. This can also be said to the other dispersion liquids.

In order to control the aggregation state, a method such as heating, adding a metal salt, and adjusting pH can be preferably used.

The metal salt is appropriately selected depending on the intended purpose without any limitation, and examples thereof include: a monovalent metal salt including salts of sodium and potassium; a bivalent metal salt including salts of calcium and magnesium; and a trivalent metal salt including a salt of aluminum.

Examples of an anion for constituting the aforementioned salt include chloride ion, bromide ion, iodide ion, carbonic ion, and sulfuric ion. Among them, magnesium chloride, aluminum chloride, a complex or multimer thereof are preferable.

Heating during or after the aggregating accelerates fusion between resin particles, which is preferable in terms of homogeneity of the toner. Further, the shapes of the toner particles, i.e., the shape of the toner, can be controlled by the heating. Generally, the shapes of the toner particles become closer to spherical shapes as heating continues.

For washing and drying of the base particles of the toner dispersed in the aqueous medium, conventional techniques can be used.

Specifically, after the solid-liquid separation is performed by a centrifugal separator, or a filter press, the resulting toner cake is again dispersed in ion-exchanged water having the normal temperature to about 40° C., optionally adjusting the pH thereof with acid or alkali, followed by again subjected to solid-liquid separation. This series of operations are repeated a few times to remove impurities or the surfactant, followed by drying by means of a flash dryer, circulation dryer, vacuum dryer, or vibration flash dryer, to thereby obtain toner particles. The fine particle component may be removed from the toner by centrifugal separation or the like during the aforementioned operations, or it may be optionally classified to have the desirable particle size distribution by means of a conventional classifying device after the drying.

The resulting dry toner particles may be mixed with other particles such as releasing agent fine particles, and charge controlling agent fine particles, and also a mechanical impact may be applied to the mixture for immobilization or fusion of other particles on the toner surface, to thereby prevent the other particles from dropping off from the surfaces of the toner particles.

Specific examples of the method include a method in which an impact is applied to a mixture using a high-speed rotating blade, and a method in which an impact is applied by putting mixed particles into a high-speed air flow and accelerating the air speed such that the particles collide against one another or that the particles are crashed into a proper collision plate.

Examples of apparatuses used in these methods include ANGMILL (product of Hosokawa Micron Corporation), an apparatus produced by modifying I-type mill (product of Nippon Pneumatic Mfg. Co., Ltd.) so that the pulverizing air pressure thereof is decreased, a hybridization system (product of Nara Machinery Co., Ltd.), a kryptron system (product of Kawasaki Heavy Industries, Ltd.) and an automatic mortar.

### (Developer)

The developer of the present invention contains the toner, and may further contain appropriately selected other components, such as carrier, if necessary.

The developer may be a one-component developer, or two-component developer, but is preferably a two-component developer for use in recent high-speed printers corresponded to the improved information processing speed, in view of a long service life.

In the case of the one-component developer using the toner, the diameters of the toner particles do not vary largely even when the toner is balanced, namely, the toner is supplied to the developer, and consumed by developing, the toner does not cause filming to a developing roller, nor fuse to a layer thickness regulating member such as a blade for thinning a thickness of a layer of the toner, and provides excellent and stable developing ability and image even when it is used (stirred)) in the developing unit over a long period of time.

In the case of the two-component developer using the toner, the diameters of the toner particles in the developer do not vary largely even when the toner is balanced, and the toner can provide excellent and stabile developing ability even when the toner is stirred in the developing unit over a long period of time.

### <Carrier>

The carrier is appropriately selected depending on the intended purpose without any limitation, but the carrier is preferably a carrier containing core particles, and a resin layer covering each core particle.

A material for the core particles is appropriately selected from those known in the art without any limitation, but it is preferably 50 emu/g to 90 emu/g manganese-strontium (Mn—Sr) material, or manganese-magnesium (Mn—Mg) material, and preferably a hard magnetic material such as iron powder (100 emu/g or higher), and magnetite (75 emu/g to 120 emu/g) is preferable for securing sufficient image density. Moreover, the material is preferably a soft magnetic material such as a copper-zinc (Cu—Zn) (30 emu/g to 80 emu/g) material because the toner particles born in the form of brush reduces an impact by contact to a latent electrostatic image bearing member, which is advantageous for providing high image quality. These may be used alone, or in combination.

As for particle diameters of the core particles, the average particle diameter (weight average particle diameter D50) of the core particles is preferably 10 μm to 200 μm, more preferably 40 μm to 100 μm. When the average particle diameter (weight average particle diameter (D50)) is smaller than 10 μm, the proportion of fine particles in the distribution of carrier particle diameters increases, increasing fine particles, causing carrier scattering because of low magnetization per carrier particle. When the average particle diameter thereof is greater than 200 μm, the specific surface area reduces, which may cause toner scattering, causing reproducibility especially in a solid image portion in a full color printing containing many solid image portions.

A material of the resin layer is appropriately selected from resins known in the art depending on the intended purpose without any limitation, and examples thereof include an amino resin, a polyvinyl resin, a polystyrene resin, a halogenated olefin resin, a polyester resin, a polycarbonate resin, a polyethylene resin, a polyvinyl fluoride resin, a polyvinylidene fluoride resin, a polytrifluoroethylene resin, a polyhexafluoropropylene resin, copolymer of vinylidene fluoride and acryl monomer, vinylidene fluoride-vinyl fluoride copolymer, fluoroterpolymer (e.g., terpolymer of tetrafluoroethylene, vinylidene fluoride, and non-fluoromonomer), and a silicone resin. These may be used alone, or in combination. Among them, a silicone resin is particularly preferable.

The silicone resin is appropriately selected from silicone resins commonly known in the art depending on the intended purpose without any limitation, and examples thereof include a straight silicone resin constituted of organosiloxane bonds; and a modified silicone resin, which is modified with an alkyd resin, a polyester resin, an epoxy resin, an acryl resin, or a urethane resin.

The silicone resin can be selected from commercial products. Examples of commercial products of the straight silicone resin include: KR271, KR255, and KR152 manufactured by Shin-Etsu Chemical Co., Ltd.; and SR2400, SR2406, and SR2410 manufactured by Dow Corning Toray Co., Ltd.

As for the modified silicone resin, commercial products thereof can be used. Examples of the commercial products thereof include: KR206 (alkyd-modified), KR5208 (acryl-modified), ES1001N (epoxy-modified), and KR305 (urethane-modified) manufactured by Shin-Etsu Chemical Co., Ltd.; and SR2115 (epoxy-modified), SR2110 (alkyd-modified) manufactured by Dow Corning Toray Co., Ltd.

Note that, the silicone resin can be used along, but the silicone resin can also be used together with a component capable of performing a crosslink reaction, a component for adjusting charging value, or the like.

The resin layer optionally contains electric conductive powder, and examples thereof include metal powder, carbon black, titanium oxide, tin oxide, and zinc oxide. The average particle diameter of the electric conductive powder is preferably 1 μm or smaller. When the average particle diameter thereof is greater than 1 μm, it may be difficult to control electric resistance.

The resin layer can be formed, for example, by dissolving the silicone oil or the like in a solvent to prepare a coating solution, uniformly applying the coating solution to surfaces of core particles by a conventional coating method, and drying the coated solution, followed by baking. Examples of the coating method include dip coating, spray coating, and brush coating.

The solvent is appropriately selected depending on the intended purpose without any limitation, and examples thereof include toluene, xylene, methyl ethyl ketone, methyl isobutyl ketone, cellosolve, and butyl acetate.

Baking may employ an external heating system or an internal heating system, without any limitation. Examples thereof include a method using a fix electric furnace, a flow electric furnace, a rotary electric furnace, or a burner furnace, and a method using microwaves.

An amount of the resin layer in the carrier is preferably 0.01% by mass to 5.0% by mass. When the amount thereof is smaller than 0.01% by mass, a uniform resin layer may not be formed on a surface of a core material. When the amount thereof is greater than 5.0% by mass, a thickness of the resin layer becomes excessively thick so that a plurality of carrier particles may form into one particle, and therefore uniform carrier particles cannot be obtained.

In the case where the developer is a two-component developer, an amount of the carrier in the two-component developer is appropriately selected depending on the intended purpose without any limitation, and it is, for example, preferably 90% by mass to 98% by mass, more preferably 93% by mass to 97% by mass.

A mixing ratio between the toner and the carrier in the two-component developer is typically 1 part by mass to 10.0 parts by mass of the toner relative to 100 parts by mass of the carrier.

### (Image Forming Apparatus)

The image forming apparatus of the present invention contains at least a latent electrostatic image bearing member, a charging unit, an exposing unit, a developing unit, a transferring unit, and a fixing unit, and may further contain appropriately selected other units, such as a cleaning unit, a diselectrification unit, a recycling unit, and a controlling unit, if necessary.

The developing unit is a unit configured to develop a latent electrostatic image with a toner to form a visible image, where the toner is the toner of the present invention.

Note that, the charging unit and the exposing unit may be collectively referred to as a latent electrostatic image forming unit. The developing unit contains a magnetic field generating unit fixed inside thereof, and contains a developer bearing member capable of bearing the toner of the present invention and rotating.

### <Latent Electrostatic Image Bearing Member>

The material, shape, structure, size, of the like of the latent electrostatic image bearing member is appropriately selected depending on the intended purpose without any limitation. Examples of the shape thereof include a drum shape, a sheet shape, and an endless belt shape. As for the structure thereof, the latent electrostatic image bearing member may have a single layer structure or a multilayer structure. The size thereof can be appropriately selected depending on the size and specification of the image forming apparatus. Examples of the material thereof include: an inorganic photoconductor such as amorphous silicon, selenium, CdS, and ZnO; and an organic photoconductor (OPC) such as polysilane, and phthalopolymethine.

### <Charging Unit>

The charging unit is a unit configured to charge a surface of the latent electrostatic image bearing member.

The charging unit is appropriately selected depending on the intended purpose without any limitation, provided that it is capable of applying voltage to and uniformly charging a surface of the latent electrostatic image bearing member. The charge unit is roughly classified into a (1) contact charging unit which charges by being in contact with latent electrostatic image bearing member, and a (2) non-contact charging unit which charges without being in contact with the latent electrostatic image bearing member.

Examples of the (1) contact charging unit include an electric conductive or semiconductive charging roller, a magnetic brush, a fur brush, a film, and a rubber blade. Among them, the charging roller enables to significantly reduce a generating amount of ozone compared to corona discharge, has excellent stability when the latent electrostatic image bearing member is used repeatedly, and is effective in prevention of image deterioration.

Examples of the (2) non-contact charging unit include: a non-contact charger or needle electrode device utilizing corona discharge, and a solid discharge element; and an electric conductive or semiconductive charging roller provided with only a slight space to the latent electrostatic image bearing member.

### <Exposing Unit>

The exposing unit is a unit configured to expose the charged surface of the latent electrostatic image bearing member to light to form a latent electrostatic image.

The exposing unit is appropriately selected depending on the intended purpose without any limitation, provided that it is capable of exposing the surface of the latent electrostatic image bearing member, which has been charged by the charging unit, to imagewise light corresponding to an image to be formed. Examples of the exposing unit include various exposure devices, such as a reproduction optical exposure device, a rod-lens array exposure device, a laser optical exposure device, a liquid crystal shutter optical device, and an LED optical exposure device. Moreover, the developing unit may employ a back light system in which imagewise light is applied from the back side of the latent electrostatic image bearing member for exposing.

### <Developing Unit>

The developing unit is a unit configured to develop the latent electrostatic image with a toner, where the toner is the toner of the present invention.

The developing unit is appropriately selected from those known in the art without any limitation, provided that it can develop using the toner. As for the developing unit, for example, a unit containing at least a developing unit housing the toner therein and capable of applying the toner to the latent electrostatic image in a contact or non-contact manner is preferable.

The developing unit may employ a dry developing system, or a wet developing system. The developing unit may be a developing unit for a single color, or a developing unit for multicolor. Preferable examples thereof include a developing device containing a stirrer for rubbing and stirring the toner to charge the toner, a magnetic field generating unit fixed inside the device, and a rotatable developer bearing member bearing a developer containing the toner on the surface thereof.

In the developing unit, for example, the toner and the carrier are mixed and stirred, by the friction of which the toner is charged. The charged toner is held on a surface of a rotatable magnet roller in the form of a brush to form a magnet brush. Since the magnet roller is located adjacent the latent electrostatic image bearing member, part of the toner constituting the magnet brush formed on the surface of the magnet roller is moved to the surface of the latent electrostatic image bearing member by electric suction force. As a result, the latent electrostatic image is developed with the toner to form a visible image on the surface of the latent electrostatic image bearing member.

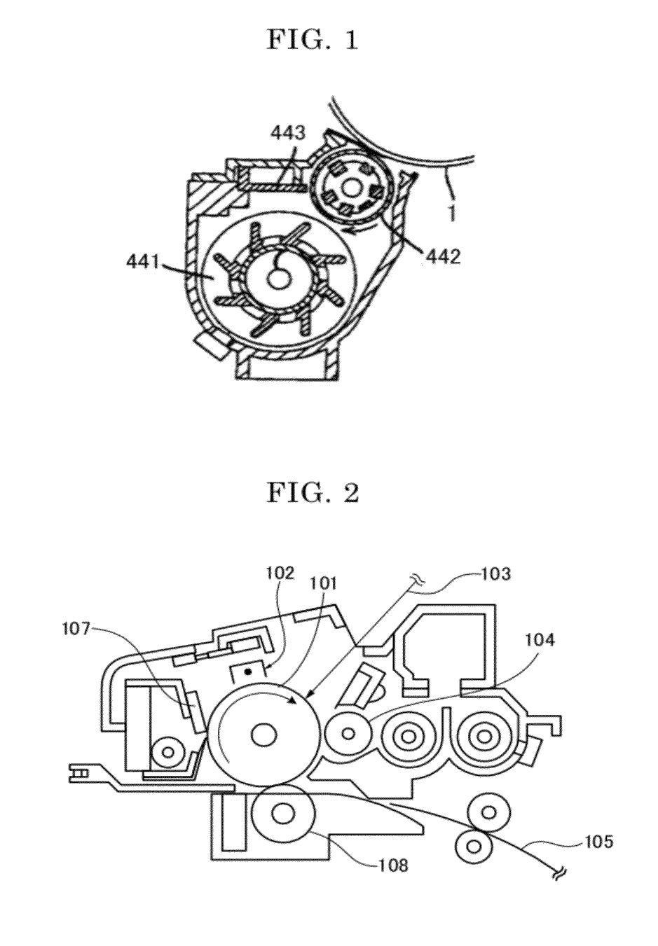

FIG. 1 is a schematic diagram illustrating one example of a two-component developing device using a two-component developer formed with a toner and a magnetic carrier. In the two-component developing device illustrated in FIG. 1, the two-component developer is stirred and conveyed by a screw 441, and then supplied to a developing sleeve 442 serving as a developer bearing member. The two-component developer supplied to the developing sleeve 442 is regulated by a doctor blade 443 serving as a layer thickness regulating member, and the amount of the developer to be supplied is controlled by a doctor gap, which is a space between the doctor blade 443 and the developer sleeve 442. When the doctor gap is too narrow, the amount of the developer is insufficient, causing insufficient in image density. When the doctor gap is too wide, conversely, an excessive amount of the developer is supplied to thereby cause a problem that the carrier deposition occurs on the photoconductor drum 1 serving as the latent electrostatic image bearing member. Accordingly, a magnet is provided inside the developing sleeve 442 as a magnetic field generating unit configured to form a magnetic field so that the developer forms brush around the circumferential surface of the magnetic sleeve. The developer forms a magnetic brush raised in the form of chains on the developer sleeve 442 along with the magnetic line of force in the direction of normal line emitted from the magnet.

The developer sleeve 442 and the photoconductor drum 1 are provided so as to be adjacent each other with a certain gap (i.e. developing gap), and a developing region is formed at the area where the both facing each other. The developing sleeve 442 is formed by forming a non-magnetic material (e.g. aluminum, brass, stainless steel, and an electric conductive resin) into a cylinder, and is driven to rotate by a rotation driving unit (not illustrated). The magnetic brush is transported to the developing region by the rotation of the developing sleeve 442. To the developing sleeve 442, developing voltage is applied from a power source for developing (not illustrated), and the toner on the magnetic brush is separated from the carrier by the developing electric field formed between the developing sleeve 442 and the photoconductor drum 1 serving as the latent electrostatic image bearing member, to develop the latent electrostatic image on the photoconductor drum 1. Note that, alternating current may be overlapped for the developing voltage.

The developing gap is preferably about 5 times to about 30 times the particle diameter of the developer. In the case where the particle diameter of the developer is 50 μm, the developing gap is preferably set to the range of 0.25 mm to 1.5 mm. When the developing gap is larger than the aforementioned range, desirable image density may not be attained.

The doctor gap is preferably the same to or slightly larger than the developing gap. The diameter and linear velocity of the photoconductor drum 1, and the diameter and linear velocity of the developing sleeve 442 are determined within restrictions such as the copying speed, or the size of the device. A ratio of the linear velocity of the drum to the linear velocity of the sleeve is preferably 1.1 or greater to attain sufficient image density. Note that, process conditions may be controlled by providing a sensor in a position downstream of the developing region, and detecting the deposition amount of the toner from the optical reflectance.

### <Transferring Unit>

The transferring unit is a unit configured to transfer the visible image onto a recording medium.

The transferring unit is roughly classified into a transferring unit which directly transfer the visible image on the latent electrostatic image bearing member to a recording medium, and a secondary transferring unit, which uses an intermediate transfer member, and after primary transferring the visible image to the intermediate transfer member, secondary transfer the visible image to a recording medium. Whichever it is, the transferring unit is appropriately selected from transferring members known in the art depending on the intended purpose without any limitation.

### <Fixing Unit>

The fixing unit is a unit configured to fix the transferred image on the recording medium.

The fixing unit is appropriately selected depending on the intended purpose without any limitation. As for the fixing unit, a fixing device containing a fixing member and a heater for heating the fixing member is preferably used. The fixing member is appropriately selected depending on the intended purpose without any limitation, provided that it can form a nip in contact with another fixing member. Examples thereof include a combination of an endless belt and a roller, and a combination of a roller and a roller. Considering the reduced warm-up time, and energy saving, use of a combination of an endless belt and a roller, or use of a heating method where the fixing member is heated from its surface by induction heating is preferable.

The fixing unit is roughly classified into a (1) embodiment (internal heating system) where a fixing unit containing at least any of a roller or a belt, which is heated from the surface that is not in contact with the toner, and the transferred image on the recording medium is heated and pressurized to fix, and a (2) embodiment (external heating system) where a fixing unit contains at least any of a roller or a belt, which is heated from the surface that is in contact with the toner, and the transferred image on the recording medium is heated and pressurized to fix. Note that, it is possible to employ both of them in combination.

Examples of the (1) fixing unit of the internal heating system include a fixing unit containing a fixing member, where the fixing member contains a heating unit inside thereof. Examples thereof include a heat source such as a heater, and a halogen lamp.

Examples of the (2) fixing unit of the external heating system preferably include an embodiment where at least part of a surface of at least one fixing member out is heated by a heating unit. The heating unit is appropriately selected depending on the intended purpose without any limitation, and examples thereof include an electromagnetic induction heating unit. The electromagnetic induction heating unit is appropriately selected depending on the intended purpose without any limitation, but it is preferably the one containing a unit for generating a magnetic field, and a unit for generating heat by electromagnetic induction. As for the electromagnetic induction heating unit, for example, the one containing a induction coil provided adjacent to the fixing member (e.g., a heating roller), a shielding layer to which the induction coil is provided, and an insulating layer provided to a surface of the shielding layer opposite to the surface thereof where the induction coil is provided is suitably included. In this embodiment, the heating roller is preferably the one formed of a magnetic material, or the one that is a heat pipe. The conduction coil is provided to over at least a half the cylinder of the heating roller at the side which is opposite to the side of the heating roller where the heating roller is in contact with the fixing member (e.g., a pressurizing roller, and an endless belt).

### (Process Cartridge)

The process cartridge for use in the present invention contains at least a latent electrostatic image bearing member, and a developing unit, and may further contain appropriately selected other units, such as a charging unit, an exposing unit, a transferring unit, a cleaning unit, and a diselectrification unit, if necessary.

The developing unit is a unit configured to develop a latent electrostatic image on the latent electrostatic image bearing member with a toner to form a visible image, where the toner is the toner of the present invention.

The developing unit contains at least a toner storage container housing the toner therein, and a toner bearing member configured to bear and convey the toner housed in the toner container, and may further contain a layer thickness regulating member for regulating a thickness of a toner layer born on the toner bearing member. The developing unit preferably contains at least a developer storage container housing the two-component developer, and a developer bearing member configured to bear and convey the two-component developer housed in the developer storage container. Specifically, the developing unit explained in the description of the image forming apparatus is suitably used.

As for the charging unit, exposing unit, transferring unit, cleaning unit, and diselectrification unit, those explained in the description of the image forming apparatus are appropriately selected and used.

The process cartridge can be detachably mounted in various electrophotographic image forming apparatuses, facsimiles, and printers, and is particularly preferably detachably mounted in the image forming apparatus of the present invention.

The process cartridge is, for example as illustrated in FIG. 2, equipped therein with a latent electrostatic image bearing member 101, and contains a charging unit 102, a developing unit 104, a transferring unit 108, and a cleaning unit 107, and may further contain other units, if necessary. In FIG. 2, 103 denotes exposure liquid from the exposing unit, and 105 denotes a recording medium.

The image forming process in the process cartridge illustrated in FIG. 2 is described next. While rotating the latent electrostatic image bearing member 101 in the direction indicated with the arrow, a latent electrostatic image corresponding an exposure image is formed by a surface of the latent electrostatic image bearing member 101 as a result of charging by the charging unit 102, and exposing to light 103 by the exposing unit (not illustrated). The latent electrostatic image is developed with a toner by the developing unit 104 to form a toner image, and the developed toner image is transferred onto a recording medium 105 by the transferring unit 108, followed by output as a print. Next, a surface of the latent electrostatic image bearing member after the transferring is cleaned by the cleaning unit 107, diselectrified by the diselectrification unit (not illustrated), and again returned to the aforementioned operation.

### EXAMPLES

The present invention will be more specifically explained through the following examples, but these examples shall not be construed as limiting the scope of the present invention.

### Production Example 1

### <Production of Crystalline Resin A1>

A reaction tank equipped with a condenser, a stirrer, and a nitrogen inlet tube was charged with 241 parts by mass of sebacic acid, 31 parts by mass of adipic acid, 164 parts by mass of 1,4-butanediol, and as a condensation catalyst, 0.75 parts by mass of titanium dihydroxybis(triethanolaminate), and the resulting mixture was allowed to react for 8 hours at 180° C. under nitrogen gas stream, with removing the generated water. The mixture was then gradually heated to 225° C., and was allowed to react for 4 hours under nitrogen gas stream, with removing the generated water as well as 1,4-butanediol. The resultant was further reacted under the reduced pressure of 5 mmHg to 20 mmHg until Mw of the resultant reached about 18,000, to thereby obtain Crystalline Resin A1 (crystalline polyester resin) having a melting point of 58° C.

Whether the obtained resin was a crystalline resin or a non-crystalline resin was confirmed by measuring a ratio (softening point (Tb)/the maximum peak temperature (Ta) of heat of melting) of the softening temperature (Tb) as measured by an elevated flow tester to the maximum peak temperature (melting point Ta) of heat of melting as measured by a differential scanning calorimeter (DSC), and determining the resin having the ratio of 0.80 to 1.55 as “a crystalline resin,” and the resin having the ratio of larger than 1.55 as “a non-crystalline resin.” The result is presented in Table 1.

### Production Example 2

### <Production of Crystalline Resin A2>

A reaction tank equipped with a condenser, a stirrer, and a nitrogen inlet tube was charged with 283 parts by mass of sebacic acid, 215 parts by mass of 1,6-hexanediol, and as a condensation catalyst, 1 part by mass of titanium dihydroxybis(triethanolaminate), and the resulting mixture was allowed to react for 8 hours at 180° C. under nitrogen gas stream, with removing the generated water. The mixture was then gradually heated to 220° C., and was allowed to react for 4 hours under nitrogen gas stream, with removing the generated water as well as 1,6-hexanediol. The resultant was further reacted under the reduced pressure of 5 mmHg to 20 mmHg until Mw of the resultant reached about 17,000, to thereby obtain Crystalline Resin A2 (crystalline polyester resin) having a melting point of 63° C.

### Production Example 3

### <Production of Crystalline Resin A3>

A reaction tank equipped with a condenser, a stirrer, and a nitrogen inlet tube was charged with 322 parts by mass of dodecanedioic acid, 215 parts by mass of 1,6-hexanediol, and as a condensation catalyst, 1 part by mass of titanium dihydroxybis(triethanolaminate), and the resulting mixture was allowed to react for 8 hours at 180° C. under nitrogen gas stream, with removing the generated water. The mixture was then gradually heated to 220° C., and was allowed to react for 4 hours under nitrogen gas stream, with removing the generated water as well as 1,6-hexanediol. The resultant was further reacted under the reduced pressure of 5 mmHg to 20 mmHg until Mw of the resultant reached about 16,000, to thereby obtain Crystalline Resin A3 (crystalline polyester resin) having a melting point of 66° C.

### Production Example 4

### <Production of Crystalline Resin A4>

A reaction tank equipped with a condenser, a stirrer, and a nitrogen inlet tube was charged with 530 parts by mass of E-caprolactone, 2 parts by mass of 1,4-butanediol, and as a catalyst, 2 parts by mass of dibutyl tin oxide, and the resulting mixture was allowed to react for 10 hours at 150° C. under nitrogen gas stream, to thereby obtain Crystalline Resin A4 (crystalline polyester resin) having Mw of about 10,000 and a melting point of 60° C.

### Production Example 5

### <Production of Crystalline Resin A5>

A reaction tank equipped with a condenser, a stirrer, and a nitrogen inlet tube was charged with 142 parts by mass of sebacic acid, 136 parts by mass of dimethyl terephthalate, 215 parts by mass of 1,6-hexanediol, and as a condensation catalyst, 1 part by mass of titanium dihydroxybis(triethanolaminate), and the resulting mixture was allowed to react for 8 hours at 180° C. under nitrogen gas stream, with removing the generated water. The mixture was then gradually heated to 220° C., and was allowed to react for 4 hours under nitrogen gas stream, with removing the generated water as well as 1,6-hexanediol. The resultant was further reacted under the reduced pressure of 5 mmHg to 20 mmHg until Mw of the resultant reached about 10,000, to thereby obtain Crystalline Resin A5 (crystalline polyester resin) having a melting point of 52° C.

### Production Example 6

### <Production of Crystalline Resin A6>

A reaction tank equipped with a condenser, a stirrer, and a nitrogen inlet tube was charged with 126 parts by mass of 1,4-butanediol, 215 parts by mass of 1,6-hexanediol, and 100 parts by mass of methyl ethyl ketone (MEK), followed by stirring. To the resultant, 341 parts by mass of hexamethylene diisocyanate (HDI) was added, and the resulting mixture was allowed to react for 8 hours at 80° C. under nitrogen gas stream. Subsequently, MEK was removed by evaporation under the reduced pressure, to thereby obtain Crystalline Resin A6 (crystalline polyurethane resin) having Mw of about 18,000, and a melting point of 59° C.

### Production Example 7

### <Production of Crystalline Resin A7>

A reaction tank equipped with a condenser, a stirrer, and a nitrogen inlet tube was charged with 241 parts by mass of sebacic acid, 31 parts by mass of adipic acid, 164 parts by mass of 1,4-butanediol, and as a condensation catalyst, 0.75 parts by mass of titanium dihydroxybis(triethanolaminate), and the resulting mixture was allowed to react for 8 hours at 180° C. under nitrogen gas stream, with removing the generated water. The mixture was then gradually heated to 225° C., and was allowed to react for 4 hours under nitrogen gas stream, with removing the generated water as well as 1,4-butanediol. The resultant was further reacted under the reduced pressure of 5 mmHg to 20 mmHg until Mw of the resultant reached about 6,000.

The resulting crystalline resin (218 parts by mass) was placed in a reaction tank equipped with a condenser, a stirrer, and a nitrogen inlet tube. To this, 250 parts by mass of ethyl acetate, and 8.6 parts by mass of hexamethylene diisocyanate (HDI) were added, and the resulting mixture was allowed to react for 5 hours at 80° C. under nitrogen gas stream. Subsequently, the ethyl acetate was removed by evaporation under the reduced pressure, to thereby obtain Crystalline Resin A7 (crystalline polyurethane resin) having Mw of about 22,000, and a melting point of 60° C.

### Production Example 8

### <Production of Crystalline Resin A8>

A reaction tank equipped with a condenser, a stirrer, and a nitrogen inlet tube was charged with 283 parts by mass of sebacic acid, 215 parts by mass of 1,6-hexanediol, and as a condensation catalyst, 1 part by mass of titanium dihydroxybis(triethanolaminate), and the resulting mixture was allowed to react for 8 hours at 180° C. under nitrogen gas stream, with removing the generated water. The mixture was then gradually heated to 220° C., and was allowed to react for 4 hours under nitrogen gas stream, with removing the generated water as well as 1,6-hexanediol. The resultant was further reacted under the reduced pressure of 5 mmHg to 20 mmHg until Mw of the resultant reached about 6,000.

The resulting crystalline resin (249 parts by mass) was placed in a reaction tank equipped with a condenser, a stirrer, and a nitrogen inlet tube. To this, 250 parts by mass of ethyl acetate, and 9 parts by mass of hexamethylene diisocyanate (HDI) were added, and the resulting mixture was allowed to react for 5 hours at 80° C. under nitrogen gas stream. Subsequently, the ethyl acetate was removed by evaporation under the reduced pressure, to thereby obtain Crystalline Resin A8 (crystalline polyurethane resin) having Mw of about 20,000, and a melting point of 65° C.

### Production Example 9

### <Production of Crystalline Resin A9>

A reaction tank equipped with a condenser, a stirrer, and a nitrogen inlet tube was charged with 322 parts by mass of dodecanedioic acid, 215 parts by mass of 1,6-hexanediol, and as a condensation catalyst, 1 part by mass of titanium dihydroxybis(triethanolaminate), and the resulting mixture was allowed to react for 8 hours at 180° C. under nitrogen gas stream, with removing the generated water. The mixture was then gradually heated to 220° C., and was allowed to react for 4 hours under nitrogen gas stream, with removing the generated water as well as 1,6-hexanediol. The resultant was further reacted under the reduced pressure of 5 mmHg to 20 mmHg until Mw of the resultant reached 6,000.

The resulting crystalline resin (269 parts by mass) was placed in a reaction tank equipped with a condenser, a stirrer, and a nitrogen inlet tube. To this, 280 parts by mass of ethyl acetate, and 10.4 parts by mass of tolylene diisocyanate (TDI) were added, and the resulting mixture was allowed to react for 5 hours at 80° C. under nitrogen gas stream. Subsequently, the ethyl acetate was removed by evaporation under the reduced pressure, to thereby obtain Crystalline Resin A9 (crystalline polyurethane resin) having Mw of about 18,000, and a melting point of 68° C.

### Production Example 10

### <Production of Crystalline Resin A10>

A 1 L autoclave was charged with 180 parts by mass of 1,2-propylene oxide, and 30 parts by mass of potassium hydroxide, and the resulting mixture was stirred for 48 hours at room temperature to proceed to polymerization. The obtained polymer was heated to 70° C. to melt the polymer, and to the melted polymer, 100 parts by mass of toluene and 100 parts by mass of water were added to perform partitioning. The operation of the partitioning was performed 3 times. The obtained toluene phase was neutralized with a 0.1 mol/L hydrochloric acid, and to this, 100 parts by mass of water was further added to perform partitioning. The operation of the partitioning was performed 3 times. The toluene was then removed from the resulting toluene phase by evaporation, to thereby obtain Crystalline Resin A10 (crystalline polyether resin) having Mw of about 12,000, melting point of 55° C., and isotacticity of 99%.

### Production Example 11

### <Production of Crystalline Resin A11>

A reaction tank equipped with a condenser, a stirrer, a dripping funnel and a nitrogen inlet tube was charged with 500 parts by mass of toluene. Separately to this, a glass beaker was charged with 350 parts by mass of toluene, 120 parts by mass of behenyl acrylate, 20 parts by mass of 2-ethylhexyl acrylate, 10 parts by mass of methacrylic acid, and 7.5 parts by mass of azobisisobutyronitrile (AIBN), and the resulting mixture was stirred and mixed at 20° C. to thereby prepare a monomer solution. The resulting monomer solution was poured into the dripping funnel.

After a vapor phase in the reaction tank was replaced with nitrogen gas, the monomer solution was added dropwise over the period of 2 hours at 80° C. in the sealed condition. After the completion of the dripping, the resultant was aged for 2 hours at 85° C., followed by removing the toluene therefrom for 3 hours at 130° C. under the reduced pressure, to thereby obtain Crystalline Resin A11 (crystalline vinyl resin) having Mw of about 87,000, and a melting point of 56° C.

### Production Example 12

### <Production of Crystalline Resin A12>

A reaction tank equipped with a condenser, a stirrer, and a nitrogen inlet tube was charged with 123 parts by mass of 1,4-butanediamine, 211 parts by mass of 1,6-hexanediamine, and 100 parts by mass of methyl ethyl ketone (MEK), and the resulting mixture was stirred. To this, 341 parts by mass of hexamethylene diisocyanate (HDI) was added, and the resulting mixture was allowed to react for 5 hours at 60° C. under nitrogen gas stream. Subsequently, MEK was removed from the reaction mixture by evaporation under the reduced pressure, to thereby obtain Crystalline Resin A12 (crystalline polyurea resin) having Mw of about 22,000, and a melting point of 63° C.

### Production Example 13

### <Production of Crystalline Resin Precursor B1>

A reaction tank equipped with a condenser, a stirrer, and a nitrogen inlet tube was charged with 28 parts by mass of hexamethylene diisocyanate (HDI), and 28 parts by mass of ethyl acetate. To the resulting mixture, a resin solution in which 249 parts by mass of Crystalline Resin A8 had been dissolved in 249 parts by mass of ethyl acetate was added, and the resulting mixture was allowed to react for 5 hours at 80° C. under nitrogen gas stream, to thereby a 50% by mass Crystalline Resin Precursor B1 having a terminal isocyanate group (modified polyester resin) ethyl acetate solution.

### Production Example 14

### <Production of Non-Crystalline Resin C1>

A reaction tank equipped with a condenser, a stirrer, and a nitrogen inlet tube was charged with 240 parts by mass of 1,2-propanediol, 226 parts by mass of terephthalic acid, and as a condensation catalyst 0.64 parts by mass of tetrabutoxy titanate, and the resulting mixture was allowed to react for 8 hours at 180° C. under nitrogen gas stream, with removing the generated methanol. Subsequently, the resultant was gradually heated to 230° C., and was allowed to react for 4 hours under nitrogen gas stream with removing the generated water and 1,2-propanediol, followed by reacted for 1 hour under the reduced pressure of 5 mmHg to 20 mmHg. The resulting reaction mixture was cooled to 180° C., and to this, 8 parts by mass of trimellitic anhydride, and 0.5 parts by mass of tetrabutoxy titanate were added, and the resulting mixture was allowed to react for 1 hour. The resultant was further reacted under the reduced pressure of 5 mmHg to 20 mmHg until Mw of the resultant reached about 7,000, to thereby obtain Non-Crystalline Resin C1 (non-crystalline polyester resin) having a melting point of 61° C.

### Production Example 15

### <Production of Non-Crystalline Resin C2>

A reaction tank equipped with a condenser, a stirrer, and a nitrogen inlet tube was charged with 215 parts by mass of bisphenol A propylene oxide 2 mol adduct, 132 parts by mass of bisphenol A ethylene oxide 2 mol adduct, 126 parts by mass of terephthalic acid, and as a condensation catalyst, 1.8 parts by mass of tetrabutoxy titanate, and the resulting mixture was allowed to react for 6 hours at 230° C. under nitrogen gas stream with removing the generated water. Subsequently, the reactant was allowed to react for 1 hour under the reduced pressure of 5 mmHg to 20 mmHg, followed by cooling to 180° C. To this, 8 parts by mass of trimellitic anhydride was added, and the resulting mixture was allowed to react under the reduced pressure of 5 mmHg to 20 mmHg until Mw of the resultant reached about 10,000, to thereby obtain Non-Crystalline Resin C2 (non-crystalline polyester resin) having a melting point of 60° C.

### Example 1

### —Production of Colorant Master Batch P1—

Crystalline Resin A1 (100 parts by mass), a cyan pigment (C.I. Pigment Blue 15:3) (100 parts by mass), and ion-exchanged water (30 parts by mass) were sufficiently mixed, and kneaded by means of an open-roll kneader (KNEADEX, manufactured by Nippon Coke & Engineering Co., Ltd.). As for the kneading temperature, the kneading was initiated at 90° C., followed by gradually cooling to 50° C. In the manner as described, Colorant Master Batch P1, in which a ratio (mass ratio) of the resin and the pigment was 1:1, was produced.

### —Production of Layered Inorganic Mineral Master Batch F1—

Crystalline Resin A1 (100 parts by mass), a montmorillonite compound modified with a quaternary ammonium salt including a benzyl group at least a part thereof (CLAYTONE APA, manufactured by Southern Clay Products Inc.) (100 parts by mass), and ion-exchanged water (50 parts by mass) were sufficiently mixed, and kneaded by means of an open-roll kneader (KNEADEX, manufactured by Nippon Coke & Engineering Co., Ltd.). As for the kneading temperature, the kneading was initiated at 90° C., followed by gradually cooling to 50° C. In the manner as described, Layered Inorganic Mineral Master Batch F1, in which a ratio (mass ratio) of the resin and the layered inorganic mineral was 1:1, was produced.

### —Production of Wax Dispersion Liquid—

A reaction vessel equipped with a condenser, a thermometer, and a stirrer was charged with 20 parts by mass of paraffin wax (HNP-9 (melting point: 75° C.), manufactured by NIPPON SEIRO CO., LTD.), and 80 parts by mass of ethyl acetate, and the resulting mixture was heated to 78° C. to sufficiently dissolve the wax in the ethyl acetate, followed by cooling to 30° C. over the period of 1 hour with stirring. The resultant was then subjected to wet pulverization by means of ULTRA VISCOMILL (of AIMEX CO., Ltd.) under the following conditions: a liquid feed rate of 1.0 Kg/hr, disc circumferential velocity of 10 m/s, 0.5 mm-zirconia beads packed to 80% by volume, and 6 passes, to thereby obtain Wax Dispersion.

### —Production of Toner 1—

A container equipped with a thermometer and a stirrer was charged with 37 parts by mass of Crystalline Resin A1, and 37 parts by mass of ethyl acetate, and the resulting mixture was heated to the temperature equal to or higher than the melting point of the resin to sufficiently dissolve Crystalline Resin A1. To this, 88 parts by mass of a 50% by mass Non-Crystalline Resin Cl ethyl acetate solution, 30 parts by mass of Wax Dispersion Liquid, 2 parts by mass of Layered Inorganic Mineral Master Batch F1, 12 parts by mass of Colorant Master Batch P1, and 47 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 1. Note that, the temperature of Oil Phase 1 was kept at 50° C. in the container, and Oil Phase 1 was used within 5 hours from the production so as not to crystallize the contents.

Next, a separate container equipped with a stirrer and a thermometer was charged with 90 parts by mass of ion-exchanged water, 3 parts by mass of a 5% by mass polyoxyethylene lauryl ether nonionic surfactant (NL450, manufactured by Dai-ichi Kogyo Seiyaku Co., Ltd.) aqueous solution, and 10 parts by mass of ethyl acetate, and the resulting mixture was mixed and stirred at 40° C. to thereby produce an aqueous phase solution. The resulting aqueous phase solution was added to 50 parts by mass of Oil Phase 1 the temperature of which had been kept at 50° C., and the resulting mixture was mixed for 1 minute by means of TK Homomixer (of Tokushu Kika Kogyo Co., Ltd.) at 40° C. to 50° C. and at 13,000 rpm, to thereby obtain Emulsified Slurry 1.

A container equipped with a stirrer and a thermometer was charged with Emulsified Slurry 1, and the solvent was removed from Emulsified Slurry 1 over the period of 6 hours at 60° C., to thereby obtain Slurry 1.

The obtained toner base particles in Slurry 1 (100 parts by mass) were subjected to filtration under the reduced pressure, followed by subjected to the following washing procedure.

(1): ion-exchanged water (100 parts) was added to the filtration cake, followed by mixing with TK Homomixer (at 6,000 rpm for 5 minutes) and then filtration;

(2): a 10% by mass aqueous sodium hydroxide solution (100 parts by mass) was added to the filtration cake obtained in (1), followed by subjected to mixing with TK Homomixer (at 6,000 rpm for 10 minutes) and then filtration under reduced pressure;

(3): a 10% by mass hydrochloric acid (100 parts by mass) was added to the filtration cake obtained in (2), followed by subjected to mixing with TK Homomixer (at 6,000 rpm for 5 minutes) and then filtration; and

(4): ion-exchanged water (300 parts) was added to the filtration cake obtained in (3), followed by mixing with TK Homomixer (at 6,000 rpm for 5 minutes) and then filtration.

This operation was performed twice, to thereby obtain Filtration Cake 1.

Filtration Cake 1 was dried by means of an air-circulating drier for 48 hours at 45° C., followed by passed through a sieve with a mesh size of 75 μm, to thereby produce Toner Base Particles 1.

Next, Toner Base Particles 1 (100 parts by mass) were mixed with hydrophobic silica (HDK-2000, manufactured by Wacker Chemie AG) (1.0 part by mass) by means of HENSCHEL MIXER, to thereby obtain Toner 1 having the volume average particle diameter of 5.8 μm.

Toner 1 was evaluated in the manner described below. The results are presented in Tables 3 and 4. Further, the organic-modified layered inorganic mineral used, and the amount thereof in Example 1, as well as the below-described Examples 2 to 25 and Comparative Examples 1 to 6, are presented in Table 2.

Further, it was confirmed that the organic-modified layered inorganic mineral was all present in the areas adjacent to surfaces of toner particles, according to the method for evaluating the state of the organic-modified layered inorganic mineral in the toner, which would be described below.

### —Production of Carrier—

Carrier used in a two-component developer of the invention was produced in the following manner.

As for a core material, 5,000 parts by mass of Mn ferrite particles (the weight average particle diameter: 35 μm) were used. As for a coating material, a coating liquid, which had been prepared by stirring 450 parts by mass of toluene, 450 parts by mass of a silicone resin SR2400 (of Dow Corning Toray Co., Ltd., nonvolatile content: 50% by mass), 10 parts by mass of aminosilane SH6020 (of Dow Corning Toray Co., Ltd.), and 10 parts by mass of carbon black for 10 minutes, was used. As for a coating device, a device equipped with a rotatable The coating device was charged with the core material and the coating liquid to thereby coat the core material with the coating liquid. The coating device was a device equipped with a rotatable bottom plate disk, and a stirring blade, which performed coating by forming swirling air flow in a flow bed of the core material and the coating liquid. The resulting coated product was baked in an electric furnace for 2 hours at 250° C., to thereby obtain Carrier A.

### —Production of Two-Component Developer—

The obtained toner (7 parts by mass) was uniformly mixed with Carrier A (100 parts by mass) by means of TURBULA mixer (manufactured by Willy A. Bachofen AG) for 3 minutes at 48 rpm to thereby charge the toner, where the TURBULA mixer was a mixer where a container was driven in rolling motions to perform stirring. In the present invention, a stainless steel container having an internal volume of 500 mL was charged with 200 g of Carrier A and 14 g of the toner to perform mixing.

The thus obtained two-component developer was loaded in a developing unit of an intermediate transfer system tandem image forming apparatus (Image Forming Apparatus A) employing a contact charging system, two-component developing system, secondary transferring system, blade cleaning system, and external heating roller fixing system to perform image formation. In the image formation, performance of the toner and developer was evaluated.

Image Forming Apparatus A used in the performance evaluation is specifically explained hereinafter.

### —Image Forming Apparatus A—

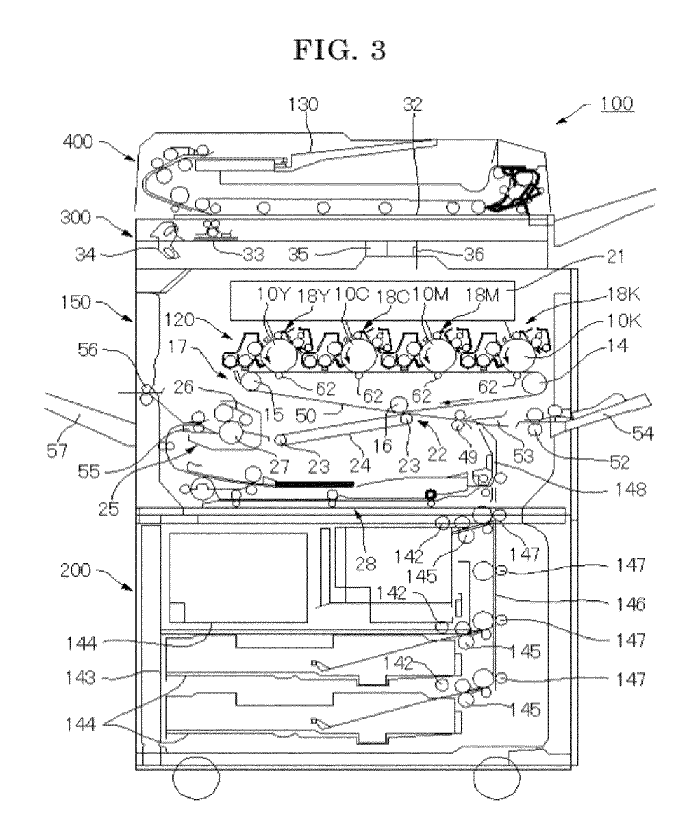

Image Forming Apparatus A 100 illustrated in FIG. 3 is a tandem color image forming apparatus. Image Forming Apparatus A 100 is equipped with a photocopying device main body 150, feeding table 200, scanner 300, and automatic document feeder (ADF) 400.

To photocopying device main body 150, an intermediate transfer member 50 in the form of an endless belt is provided, and is mounted in the center of the main body 150. The intermediate transfer member 50 is rotatably supported by supporting rollers 14, 15 and 16 in the clockwise direction in FIG. 3. In the surrounding area of the supporting roller 15, an intermediate transfer member cleaning unit 17 configured to remove the residual toner on the intermediate transfer member 50 is provided. To the intermediate transfer member 50 supported by the supporting rollers 14 and 15, a tandem developing unit 120, in which four image forming units 18Y, 18C, 18M, 18K, respectively for yellow, cyan, magenta, and black, are aligned parallel to face the intermediate transfer member 50 along the conveying direction of the intermediate transfer member 50. An exposing unit 21 is provided adjacent to the tandem developing unit 120. A secondary transfer unit 22 is provided to the side of the intermediate transfer member 50, which is opposite to the side thereof where the tandem developing unit 120 is provided. In the secondary transfer member 22, a secondary transfer belt 24 in the form of an endless belt is supported by a pair of rollers 23, and is designed so that a recording medium conveyed on the secondary transfer belt 24 can be in contact with the intermediate transfer member 50. A fixing unit 25 is provided adjacent to the secondary transfer unit 22.

Note that, in Image Forming Apparatus A 100, a reversing device 28 is provided adjacent to the secondary transfer unit 22 and the fixing unit 25, where the reversing device 28 is configured to reverse a recording medium to perform image formation on both sides of the recording medium.

Next, formation of a full color image by means of the tandem developing unit 120 is explained.

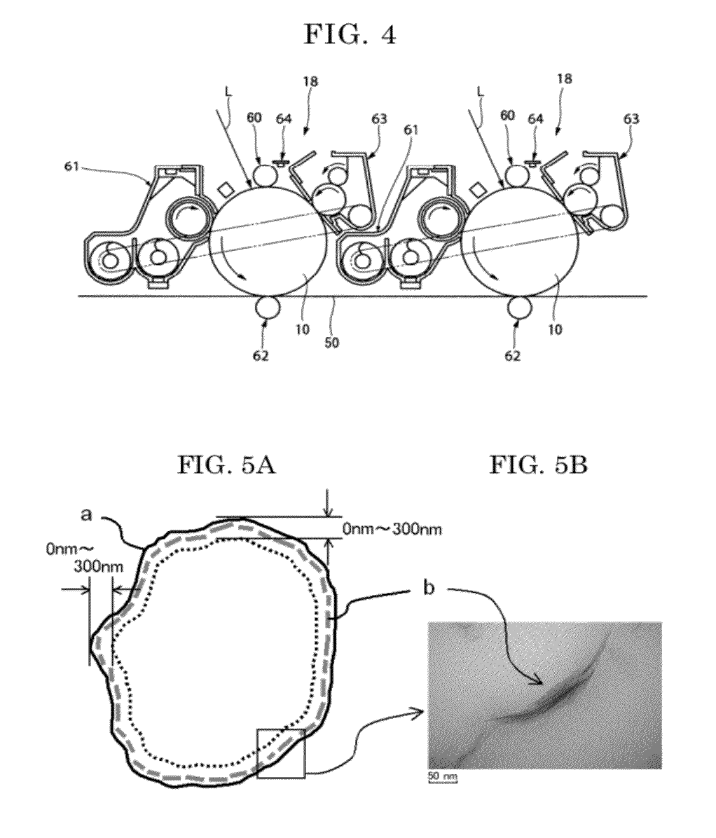

Specifically, a document is, first, set on a document table 130 of the automatic document feeder (ADF) 400, or set on a contact glass 32 of a scanner 300 after opening the automatic document feeder 400, followed by closing the automatic document feeder 400. As a start switch (not illustrated) is pressed, in the case where the document is set in the automatic document feeder 400, the document is transported onto the contact glass 32, and then the scanner 300 is driven to scan a first scanning carriage 33 and a second scanning carriage 34. In the case where the document is set on the contact glass 32, the scanner 300 is driven immediately after the start switch is pressed. During this operation, as well as applying light from a light source of the first scanning carriage 33, the reflected light from the surface of the document is reflected by a mirror of the second scanning carriage 34. The reflected light is then passed through a imaging lens 35, and received by a reading sensor 36 to be read as a color document (color image), which constitutes image information of black, yellow, magenta and cyan. Each image information of black, yellow, magenta, or cyan is transmitted to a respective image forming unit 18 (black image forming unit 18K, yellow image forming unit 18Y, magenta image forming unit 18M, or cyan image forming unit 18C) of the tandem developing unit 120, and each toner image of black, yellow, magenta, or cyan is formed by the respective image forming unit. Specifically, each image forming unit 18 (black image forming unit 18K, yellow image forming unit 18Y, magenta image forming unit 18M, or cyan image forming unit 18C) in the tandem developing unit 120 is, as illustrated in FIG. 4, equipped with: a latent electrostatic image bearing member 10 (latent electrostatic image bearing member for black 10K, latent electrostatic image bearing member for yellow 10Y, latent electrostatic image bearing member for magenta 10M, or latent electrostatic image bearing member for cyan 10C); a charging unit 60 configured to uniformly charge the latent electrostatic image bearing member; an exposing unit configured to apply imagewise light (L in FIG. 4) to the respective latent electrostatic image bearing member corresponding to the respective color image information to form a latent electrostatic image corresponding to each color image on the latent electrostatic image bearing member; a developing unit 61 configured to develop the latent electrostatic image with each color toner (black toner, yellow toner, magenta toner, or cyan toner) to form a respective toner image; a transfer charger 62 for transferring the toner image to an intermediate transfer member 50; a cleaning unit 63; and a diselectrification unit 64, and each image forming unit 18 can form a respective monocolor image (black image, yellow image, magenta image, and cyan image) corresponding to the respective color image information. The black image, yellow image, magenta image and cyan image formed in the aforementioned manner are respectively transferred to the intermediate transfer member 50 rotatably supported by the supporting rollers 14, 15, and 16. Specifically, the black image formed on the latent electrostatic image bearing member for black 10K, the yellow image formed on the latent electrostatic image bearing member for yellow 10Y, the magenta image formed on the latent electrostatic image bearing member for magenta 10M, and the cyan image formed on the latent electrostatic image bearing member 10C are successively transferred (primary transferred) onto the intermediate transfer member 50. Then, the black image, yellow image, magenta image, and cyan image are superimposed on the intermediate transfer member 50 to thereby form a composite color image (color transfer image).

Meanwhile, in the feeding table 200, recording media is sent out from one of feeding cassettes 144 multiply equipped in a paper bank 143, by selectively rotating one of the feeding rollers 142, and the recording media is separated one by one with a separation roller 145 to send into a feeding path 146. The separated recording medium is then transported by the transporting roller 147 to guide into the feeding path 148 inside the photocopying device main body 150, and is bumped against the registration roller 49 to stop. Alternatively, the recording media on a manual-feeding tray 54 is ejected by rotating a feeding roller 142, separated one by one with a separation roller 52 to guide into a manual feeding path 53, and then stopped against the registration roller 49 in the similar manner. Note that, the registration roller 49 is generally earthed at the time of the use, but it may be biased for removing paper dust of the recording medium. The registration roller 49 is then rotated synchronously with the movement of the composite color image (color transfer image) formed on the intermediate transfer member 50, the recording medium is sent in between the intermediate transfer member 50 and a secondary transfer member 22, and the composite color image (color transfer image) is then transferred (secondary transferred) onto the recording medium by the secondary transfer unit 22, to thereby transfer and form the color image onto the recording medium. Note that, the residual toner on the intermediate transfer member 50 after the transferring of image is cleaned by an intermediate transfer member cleaning unit 17.

The recording medium on which the color image has been transferred and formed is transported by the secondary transfer member 22 to send to a fixing unit 25, and the composite color image (color transfer image) is fixed to the recording medium by heat and pressure applied by the fixing unit 25. Thereafter, the recording medium was changed its traveling direction by a switch craw 55, and ejected onto an output tray 57 by an ejecting roller 56. Alternatively, the recording medium is changed its traveling direction by the switch craw 55, reversed by the reversing device 28 to form an image on the back surface of the recording medium in the same manner as mentioned above, and then ejected onto the output tray 57 by the ejecting roller 56. Note that, in FIG. 3, the reference signs 26 and 27 respectively denote a fixing belt and a pressure roller.

A damage of an image by transporting due to recrystallization just after thermal fixing, prevention of which is one of the problems to be solved by the present invention, occurs in Image Forming Apparatus A 100 when a recording medium passes through a discharging roller 56 or transporting roller provided in the reversing device 28.

### <Evaluation>

The evaluation methods for the binder resin for use, toner, and developer will be specifically explained hereinafter.

### <<Melting Point Ta and Softening Point Tb of Binder Resin and Toner, and Ratio Ta/Tb of Melting Point to Softening Point>>

The melting points (the maximum peak temperature of heat of melting, Ta) of the binder resin and toner were measured by a differential scanning calorimeter (DSC) (TA-60WS and DSC-60, manufactured by Shimadzu Corporation). A sample provided for the measurement of the maximum peak of heat of melting was subjected to the pretreatment. As for the pretreatment, the sample was melted at 130° C., followed by cooling from 130° C. to 70° C. at the cooling rate of 1.0° C./min. The sample was then cooled from 70° C. to 10° C. at the cooling rate of 0.5° C./min. The sample was subjected to the measurement of endothermic and exothermic changes in DSC by heating at the heating rate of 20° C., to thereby plot “absorption or evolution heat capacity” verses “temperature” in a graph. The endothermic peak temperature in the range of 20° C. to 100° C. appeared in the graph was determined as “Ta*.” Note that, in the case where there were few endothermic peaks, the temperature of the peak having the largest endothermic value was determined as Ta*. Thereafter, the sample was stored for 6 hours at the temperature of (Ta*−10)° C., followed by stored for 6 hours at the temperature of (Ta*−15)° C. Next, the sample was cooled to 0° C. at the cooling rate of 10° C./min., heated at the heating rate of 20° C./min. to measure the endothermic and exothermic changes by means of DSC, creating a graph in the same manner as the above. In the graph, the temperature corresponding to the maximum peak of the absorption or evolution heat capacity was determined as the maximum peak temperature of heat of melting.

The softening points (Tb) of the binder resins and the toners were measured by means of an elevated flow tester (e.g., CFT-500D, manufactured by Shimadzu Corporation). As a sample, 1 g of the binder resin or toner was used. The sample was heated at the heating rate of 6° C./min., and at the same time, load of 1.96 Mpa was applied by a plunger to extrude the sample from a nozzle having a diameter of 1 mm and length of 1 mm, during which an amount of the plunger of the flow tester pushed down relative to the temperature was plotted. The temperature at which half of the sample was flown out was determined as a softening point of the sample.

From the results above obtained in the aforementioned manner, a ratio (softening point/maximum peak temperature of heat of melting: Ta/Tb) of the softening point of the binder resin or toner to the melting point of the binder resin or toner was obtained. The results of the binder resins and the toners are presented Tables 1 and 3, respectively.

### <<Viscoelastic Properties of Toner>>

The dynamic viscoelastic values (storage elastic modulus G′, loss elastic modulus G″) of the toner, specifically, storage elastic modulus G′(Ta+20) and loss elastic modulus G″(Ta+20) at the temperature of (the maximum peak temperature of heat of melting)+20° C., loss elastic modulus G″(Ta+30) at the temperature of (the maximum peak temperature of heat of melting)+30° C., loss elastic modulus G″(Ta+70) at the temperature of (the maximum peak temperature of heat of melting)+70° C., and a ratio (G″(30/70)) of G″(Ta+30) to G″(Ta+70), were measured by means of a dynamic viscoelasticity measuring device (ARES, of TA INSTRUMENTS JAPAN INC.), with frequency of 1 Hz. A sample was formed into a pellet having a diameter of 8 mm, and a thickness of 1 mm to 2 mm, and the pellet sample was fixed to a parallel plate having a diameter of 8 mm, followed by stabilizing at 40° C. Then, the sample was heated to 200° C. at the heating rate of 2.0° C./min. with frequency of 1 Hz (6.28 rad/s), and strain of 0.1% (in a strain control mode) to thereby measure dynamic viscoelastic values of the sample. The results are presented in Table 3.

### <<Low Temperature Fixing Ability (Minimum Fixing Temperature)>>

Using Image Forming Apparatus A, a solid image (the image size: 3 cm×8 cm) having a toner deposition amount of 0.85 mg/cm²±0.1 mg/cm² (after transferring) on transfer paper (Copy Print Paper <70>, of Ricoh Business Expert, Ltd.) was formed, and the transferred image was fixed with varying the temperature of the fixing belt. The surface of the obtained fixed image was drawn with a ruby needle (point diameter: 260 μm to 320 μm, point angle: 60 degrees) by means of a drawing tester AD-401 (manufactured by Ueshima Seisakusho Co., Ltd.) with a load of 50 g. The drawn surface was rubbed 5 times with fibers (HaniCot #440, available from Sakata Inx Eng. Co., Ltd.). The temperature of the fixing belt at which hardly any image was scraped in the resulting image was determined as the minimum fixing temperature. Moreover, the solid image was formed in the position of the transfer paper, which was 3.0 cm from the edge of the paper from which the sheet was fed. Note that, the speed of the sheet passing the nip in the fixing device was 280 mm/s. The lower the minimum fixing temperature is, more excellent the low temperature fixing ability of the toner is. The results are presented in Table 4.

### <<Hot Offset Resistance (Fixable Temperature Range)>>

Using Image Forming Apparatus A, a solid image (the image size: 3 cm×8 cm) having a toner deposition amount of 0.85 mg/cm²±0.1 mg/cm² (after transferring) on transfer paper (Type 6200, manufactured by Ricoh Company Limited) was formed, and the transferred image was fixed with varying the temperature of the fixing belt. Then, occurrences of hot offset was visually evaluated, and the temperature range between the upper temperature at which the hot offset did not occur, and the minimum fixing temperature was determined as the fixable temperature range. Moreover, the solid image was formed in the position of the transfer paper, which was 3.0 cm from the edge of the paper from which the sheet was fed. Note that, the speed of the sheet passing the nip in the fixing device was 280 mm/s. The toner has more excellent hot offset resistance as the fixable temperature range widens, and about 50° C. is the average fixable temperature range of a conventional full color toner. The results are presented in Table 4.

### <<Contamination of Carrier>>

The contamination of the carrier is properties for indicating the contamination of carrier with the toner. The higher the mechanical strength of the toner is, less likely contamination of the carrier occurs.

Image Forming Apparatus A was used to perform a running test for outputting 30,000 sheets of the print on which an image chart having an imaging area of 50% was printed in a monochrom mode. After the test, the developer was taken out from Image Forming Apparatus A, and an appropriate amount of the developer was placed in a cage which had been covered with a mesh having an opening size of 32 μm. Then, the toner and carrier were separated from each other by air blow. Next, 1.0 g of the obtained carrier was placed in a 50 mL glass bottle, 10 mL of chloroform was added to the glass bottle, followed by shaking the bottle 50 times by hand. Then, it was left to stand for 10 minutes. Thereafter, the supernatant, that was the chloroform solution, was placed in a glass cell, and the transmittance of the chloroform solution was measured by means of a tribidimeter. The results are presented in Table 4.

### [Evaluation Criteria]

I: transmittance of 95% or higher

II: transmittance of 90% or higher, but lower than 95%

III: transmittance of 80% or higher, but lower than 90%

IV: transmittance of 70% or higher, but lower than 80%

V: transmittance of lower than 70%

### <Image Damage by Transportation>>

Using Image Forming Apparatus A, a solid image having a toner deposition amount of 0.85 mg/cm²±0.1 mg/cm² (after transferring) was formed on the entire area of transfer paper (Type 6200, manufactured by Ricoh Company Limited), and the image was fixed with the fixing belt the temperature of which had been set at the temperature that was the minimum fixing temperature of the toner+10° C. A degree of damages on the surface of the obtained fixed image due to a discharging roller (discharging roller 56, FIG. 3) was evaluated comparing to the evaluation samples. Note that, the speed of the sheet passing the nip in the fixing device was 280 mm/s, and the A4-size sheet was fed from the wide side. The results are presented in Table 4.

The evaluation samples included those of a point 0 to a point 5.0 from the one having many damages to the one having fewer damages at interval of 0.5 points. The higher the point is, more damage included. Note that, the point 5.0 is the level at which the scratch (damage) by transportation is hardly observed in the image under naked eyes, the point 3.0 is the level at which the scratch is very slightly observed under naked eyes, the point 3.0 or higher is an acceptable level, and the point 2.5 or lower is unacceptable level. Moreover, the point 1.0 is the level at which the scratch can be clearly observed under naked eyes, part of the image is scraped, and the base, that is transfer paper, can be observed.

### <<Heat Resistance Storage Stability>>

A 50 mL glass container was filled with the toner, and the container was left to stand in a thermostat of 50° C. for 24 hours, followed by cooling to 24° C. The resulting toner was subjected to a penetration degree test (JIS K2235-1991) to thereby measure a penetration degree (mm), and the result was evaluated in terms of the heat resistance storage stability based on the following criteria. The greater the penetration degree is, more excellent the heat resistance storage stability of the toner is. The toner having the penetration degree of lower than 10 mm more likely causes a problem on practice. The results are presented in Table 4.

### [Evaluation Criteria]

I: penetration degree of 25 mm or greater
II: penetration degree of 20 mm or greater, but less than 25 mm
III: penetration degree of 15 mm or greater, but less than 20 mm
IV: penetration degree of 10 mm or greater, but less than 15 mm
V: penetration degree of less than 10 mm

### <<Presence and State of Organic-Modified Layered Inorganic Mineral>>

The toner was embedded in a commercially available epoxy resin, and the resulting epoxy resin was sliced into an ultra-thin cut piece by a diamond knife using a microtome (Ultracut-E, Reichert, Inc.). The thickness of the cut piece was adjusted to approximately 100 nm using the interference color of the epoxy resin. The cut piece was then placed on a copper grid mesh, and was subjected to vapor dyeing using a commercially available 5% by mass ruthenium tetraoxide aqueous solution. The cross-sectional image of the toner particle on the cut piece of the sample was observed under a transmission electron microscope (JEM-2100F, manufactured by JEOL Ltd.) and recorded. The cross-sections of about 20 toner particles were observed to observe the surface areas of the toner particles (the outline area of the cross-section of the toner particle, including the center of the toner particle) formed of Resin Particle A, and the crystalline polyester resin, to thereby evaluate the presence and state of the organic-modified layered inorganic mineral.

### Example 2

### —Production of Toner 2—

A container equipped with a thermometer and a stirrer was charged with 81 parts by mass of Crystalline Resin A1, and 81 parts by mass of ethyl acetate, and the resulting mixture was heated to the temperature equal to or higher than the melting point of the resin to sufficiently dissolve Crystalline Resin A1. To this, 30 parts by mass of Wax Dispersion Liquid, 2 parts by mass of Layered Inorganic Mineral Master Batch F1, 12 parts by mass of Colorant Master Batch P1, and 47 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 2.

Toner 2 was produced in the same manner as in Example 1, provided that Oil Phase 1 was replaced with Oil Phase 2, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 3

### —Production of Toner 3—

Toner 3 was produced in the same manner as in Example 1, provided that Crystalline Resin A1 was replaced with Crystalline Resin A2, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 4

### —Production of Toner 4—

Toner 4 was produced in the same manner as in Example 1, provided that Crystalline Resin A1 was replaced with Crystalline Resin A3, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 5

### —Production of Toner 5—

Toner 5 was produced in the same manner as in Example 1, provided that Crystalline Resin A1 was replaced with Crystalline Resin A4, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 6

### —Production of Toner 6—

Toner 6 was produced in the same manner as in Example 1, provided that Crystalline Resin A1 was replaced with Crystalline Resin A5, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 7

### —Production of Toner 7—

A container equipped with a thermometer and a stirrer was charged with 37 parts by mass of Crystalline Resin A1, and 37 parts by mass of ethyl acetate, and the resulting mixture was heated to the temperature equal to or higher than the melting point of the resin to sufficiently dissolve Crystalline Resin A1. To this, 88 parts by mass of a 50% by mass Non-Crystalline Resin C2 ethyl acetate solution, 30 parts by mass of Wax Dispersion Liquid, 2 parts by mass of Layered Inorganic Mineral Master Batch F1, 12 parts by mass of Colorant Master Batch P1, and 47 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 7.

Toner 7 was produced in the same manner as in Example 1, provided that Oil Phase 1 was replaced with Oil Phase 7, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 8

### —Production of Toner 8—

Toner 8 was produced in the same manner as in Example 1, provided that Crystalline Resin A1 was replaced with Crystalline Resin A6, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 9

### —Production of Toner 9—

Toner 9 was produced in the same manner as in Example 1, provided that Crystalline Resin A1 was replaced with Crystalline Resin A7, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 10

### —Production of Colorant Master Batch P8—

Colorant Master Batch P8 was produced in the same manner as in the production of Colorant Master Batch P1, provided that Crystalline Resin A1 was replaced with Crystalline Resin A8.

### —Production of Layered Inorganic Mineral Master Batch F8—

Layered Inorganic Mineral Master Batch F8 was produced in the same manner as in the production of Layered Inorganic Mineral Master Batch F1, provided that Crystalline Resin A1 was replaced with Crystalline Resin A8.

### —Production of Toner 10—

A container equipped with a thermometer and a stirrer was charged with 37 parts by mass of Crystalline Resin A8, and 37 parts by mass of ethyl acetate, and the resulting mixture was heated to the temperature equal to or higher than the melting point of the resin to sufficiently dissolve Crystalline Resin A8. To this, 88 parts by mass of a 50% by mass Non-Crystalline Resin Cl ethyl acetate solution, 30 parts by mass of Wax Dispersion Liquid, 2 parts by mass of Layered Inorganic Mineral Master Batch F8, 12 parts by mass of Colorant Master Batch P8, and 47 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 10.

Toner 10 was produced in the same manner as in Example 1, provided that Oil Phase 1 was replaced with Oil Phase 10, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 11

### —Production of Toner 11—

Toner 11 was produced in the same manner as in Example 1, provided that Crystalline Resin A1 was replaced with Crystalline Resin A9, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 12

### —Production of Toner 12—

A container equipped with a thermometer and a stirrer was charged with 50 parts by mass of Crystalline Resin A8, and 50 parts by mass of ethyl acetate, and the resulting mixture was heated to the temperature equal to or higher than the melting point of the resin to sufficiently dissolve Crystalline Resin A8. To this, 62 parts by mass of a 50% by mass Non-Crystalline Resin Cl ethyl acetate solution, 30 parts by mass of Wax Dispersion Liquid, 2 parts by mass of Layered Inorganic Mineral Master Batch F8, 12 parts by mass of Colorant Master Batch P8, and 47 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 12.

Toner 12 was produced in the same manner as in Example 1, provided that Oil Phase 1 was replaced with Oil Phase 12, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 13

### —Production of Toner 13—

A container equipped with a thermometer and a stirrer was charged with 63 parts by mass of Crystalline Resin A8, and 63 parts by mass of ethyl acetate, and the resulting mixture was heated to the temperature equal to or higher than the melting point of the resin to sufficiently dissolve Crystalline Resin A8. To this, 36 parts by mass of a 50% by mass Non-Crystalline Resin Cl ethyl acetate solution, 30 parts by mass of Wax Dispersion Liquid, 2 parts by mass of Layered Inorganic Mineral Master Batch F8, 12 parts by mass of Colorant Master Batch P8, and 47 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 13.

Toner 13 was produced in the same manner as in Example 1, provided that Oil Phase 1 was replaced with Oil Phase 13, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 14

### —Production of Toner 14—

A container equipped with a thermometer and a stirrer was charged with 81 parts by mass of Crystalline Resin A8, and 81 parts by mass of ethyl acetate, and the resulting mixture was heated to the temperature equal to or higher than the melting point of the resin to sufficiently dissolve Crystalline Resin A8. To this, 30 parts by mass of Wax Dispersion Liquid, 2 parts by mass of Layered Inorganic Mineral Master Batch F8, 12 parts by mass of Colorant Master Batch P8, and 47 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 14.

Toner 14 was produced in the same manner as in Example 1, provided that Oil Phase 1 was replaced with Oil Phase 14, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 15

### —Production of Toner 15—

A container equipped with a thermometer and a stirrer was charged with 37 parts by mass of Crystalline Resin A8, and 37 parts by mass of ethyl acetate, and the resulting mixture was heated to the temperature equal to or higher than the melting point of the resin to sufficiently dissolve Crystalline Resin A8. To this, 30 parts by mass of Wax Dispersion Liquid, 2 parts by mass of Layered Inorganic Mineral Master Batch F8, 12 parts by mass of Colorant Master Batch P8, and 47 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents. To the resultant, 88 parts by mass of a 50% by mass Crystalline Resin Precursor B1 ethyl acetate solution was further added, and the resulting mixture was stirred by means of TK Homomixer at 50° C. and at 10,000 rpm to uniformly dissolve and disperse, to thereby obtain Oil Phase 15. Note that, the temperature of Oil Phase 15 was kept at 50° C. in the container, and Oil Phase 15 was used within 5 hours from the production so as not to crystallize the contents.

Next, a separate container equipped with a stirrer and a thermometer was charged with 90 parts by mass of ion-exchanged water, 3 parts by mass of a 25% by mass organic resin particles (copolymer of styrene, methacrylic acid, butyl acrylate, and sodium sulfate of methacrylic acid ethylene oxide adduct) dispersion liquid (manufactured by Sanyo Chemical Industries Ltd.) for stabilizing a dispersion state, 1 part by mass of sodium carboxymethyl cellulose, 16 parts by mass of a 48.5% aqueous solution of sodium dodecyldiphenyl ether disulfonate (ELEMINOL MON-7, manufactured by Sanyo Chemical Industries Ltd.), and 5 parts by mass of ethyl acetate, and the resulting mixture was mixed and stirred at 40° C. to thereby prepare an aqueous phase solution. To this, 80 parts by mass of Oil Phase 15 the temperature of which had been kept at 50° C., and 7.5 parts by mass of isophorone diamine were added, the resulting mixture was mixed for 1 minute by means of TK Homomixer (of Tokushu Kika Kogyo Co., Ltd.) at 40° C. to 50° C. and at 11,000 rpm, to thereby obtain Emulsified Slurry 15.

A container equipped with a stirrer and a thermometer was charged with Emulsified Slurry 15, and the solvent was removed from Emulsified Slurry 15 over the period of 6 hours at 60° C., followed by allowing the unreacted crystalline resin precursor to react (age) for 10 hours at 45° C., to thereby obtain Slurry 15.

Toner 15 was produced in the same manner as in Example 1, provided that Slurry 1 was replaced with Slurry 15, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 16

### —Production of Toner 16—

Toner 16 was produced in the same manner as in Example 1, provided that Crystalline Resin A1 was replaced with Crystalline Resin A10, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 17

### —Production of Toner 17—

Toner 17 was produced in the same manner as in Example 1, provided that Crystalline Resin A1 was replaced with Crystalline Resin A11, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 18

### —Production of Toner 18—

Crystalline Resin A1 (37 parts by mass), Non-Crystalline Resin C1 (44 parts by mass), paraffin wax (HNP-9 (melting point: 75° C.), manufactured by NIPPON SEIRO CO., LTD.) (6 parts by mass), Layered Inorganic Mineral Master Batch F1 (2 parts by mass), and Colorant Master Batch P1 (12 parts by mass) were pre-mixed by means of HENSCHEL MIXER (FM10B, manufactured by Nippon Cole & Engineering Co., Ltd.), followed by being melted and kneaded by means of two-axial kneader (PCM-30, manufactured by Ikegai Corp) at the temperature of 80° C. to 120° C. The obtained kneaded product was cooled to room temperature, followed by pulverized by a hammer mill into the size of 200 μm to 300 μm. Subsequently, the resultant was finely pulverized by means of Supersonic Jet Mill Labo Jet (manufactured by Nippon Pneumatic Mfg. Co., Ltd.) with appropriately adjusting the pulverizing air pressure to give the weight average particle diameter of 6.2 μm±0.3 μm, followed by subjected to classification by means of an air classifier (MDS-I, manufactured by Nippon Pneumatic Mfg. Co., Ltd.) with appropriately adjusting the opening degree of the louver so that the weight average particle diameter was to be 7.0 μm±0.2 μm, and the amount of the fine powder having the diameter of 4 μm or smaller was to be 10% by number or less, to thereby obtain Toner Base Particles 18.

Toner 18 was produced in the same manner as in Example 1, provided that Toner Base Particles 1 were replaced with Toner Base Particles 18, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was located in an entire inner portions of toner particles, as well as the area adjacent to surfaces of the toner particles.

### Example 19

### —Production of Toner 19—

To an aqueous phase in which 100 parts by mass of water, 5 parts by mass of a 48.5% aqueous solution of sodium dodecyldiphenyl ether disulfonate (ELEMINOL MON-7, manufactured by Sanyo Chemical Industries Ltd.), and 2 parts by mass of a 2% by mass of sodium hydroxide aqueous solution were mixed, 100 parts by mass of Oil Phase 1 was added, and the resulting mixture was emulsified by means of a homogenizer (ULTRA-TURRAX T50, of IKA), followed by subjected to emulsification by means of Manton-Gaulin high-pressure homogenizer (of Gaulin (SPX Corporation)), to thereby obtain Emulsified Slurry 19.

Subsequently, a container equipped with a stirrer and a thermometer was charged with Emulsified Slurry 19, and the solvent was removed from Emulsified Slurry 19 over the period of 4 hours at 60° C., to thereby obtain slurry. The particles contained in the obtained slurry were subjected to the measurement of the volume average particle diameter by means of a particle size distribution measuring device (LA-920, manufactured by Horiba Ltd.), and the result was 0.2 μm.

A container equipped with a stirrer and a thermometer was charged with 1,000 parts by mass of water, 5 parts by mass of a 48.3% by mass sodium dodecyl diphenyl ether sulfonate, 800 parts by mass of the aforementioned slurry, and the resulting mixture was adjusted with a 2% by mass sodium hydrorixde aqueous solution to give a pH of 10. To the resultant, a solution in which 40 parts by mass of magnesium chloride hexahydrate had been dissolved in 40 parts by mass of ion-exchanged water was added little by little with stirring, and heated up to 80° C. The temperature of the resultant was kept at 80° C. until the aggregated particles therein grew into the size of 5.8 μm, to thereby Slurry 19.

Toner 19 was produced in the same manner as in Example 1, provided that Slurry 1 was replaced with Slurry 19, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was located in entire inner portions of toner particles, as well as the areas adjacent to surfaces of the toner particles.

### Example 20

### —Production of Layered Inorganic Mineral Master Batch F12—

Crystalline Resin A8 (100 parts by mass), a synthetic smectite compound (LUCENTITE SPN, manufactured by Kobo Products, Inc.) (100 parts by mass), and ion-exchanged water (50 parts by mass) were sufficiently mixed, and kneaded by means of an open roll kneader (KNEADEX, manufactured by Nippon Coke & Engineering Co., Ltd.). As for the kneading temperature, the kneading was initiated at 90° C., followed by gradually cooling to 50° C. In the manner as described, Layered Inorganic Mineral Master Batch F12, in which a ratio (mass ratio) of the resin and the layered inorganic mineral was 1:1, was produced.

### —Production of Toner 20—

A container equipped with a thermometer and a stirrer was charged with 37 parts by mass of Crystalline Resin A8, and 37 parts by mass of ethyl acetate, and the resulting mixture was heated to the temperature equal to or higher than the melting point of the resin to sufficiently dissolve Crystalline Resin A8. To this, 30 parts by mass of Wax Dispersion Liquid, 2 parts by mass of Layered Inorganic Mineral Master Batch F12, 12 parts by mass of Colorant Master Batch P8, and 47 parts by mass of ethyl acetate were added, and the resulting mixture was stirred by means of TK Homomixer (of Tokushu Kika Kogyo Co., Ltd.) at 50° C. and at 10,000 rpm. A 50% by mass of Crystalline Resin Precursor B1 ethyl acetate solution (88 parts by mass) was further added thereto, and the resulting mixture was stirred by means of TK Homomixer at 50° C. and at 10,000 rpm to uniformly dissolve and disperse the contents, to thereby obtain Oil Phase 20.

Toner 20 was produced in the same manner as in Example 15, provided that Oil Phase 15 was replaced with Oil Phase 20, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 21

### —Production of Layered Inorganic Mineral Master Batch F13—

Crystalline Resin A8 (100 parts by mass), a montmorillonite compound which had been at least partially modified with an ammonium salt containing polyoxyethylene group (CLAYTONE HY, manufactured by Southern Clay Products Inc.) (100 parts by mass), and ion-exchanged water (50 parts by mass) were sufficiently mixed, and kneaded by means of an open roll kneader (KNEADEX, manufactured by Nippon Coke & Engineering Co., Ltd.). As for the kneading temperature, the kneading was initiated at 90° C., followed by gradually cooling to 50° C. In the manner as described, Layered Inorganic Mineral Master Batch F13, in which a ratio (mass ratio) of the resin and the layered inorganic mineral was 1:1, was produced.

### —Production of Toner 21—

A container equipped with a thermometer and a stirrer was charged with 37 parts by mass of Crystalline Resin A8, and 37 parts by mass of ethyl acetate, and the resulting mixture was heated to the temperature equal to or higher than the melting point of the resin to sufficiently dissolve Crystalline Resin A8. To this, 30 parts by mass of Wax Dispersion Liquid, 2 parts by mass of Layered Inorganic Mineral Master Batch F13, 12 parts by mass of Colorant Master Batch P8, and 47 parts by mass of ethyl acetate were added, and the resulting mixture was stirred by means of TK Homomixer (of Tokushu Kika Kogyo Co., Ltd.) at 50° C. and at 10,000 rpm. To the resultant, 88 parts by mass of a 50% by mass Crystalline Resin Precursor B1 ethyl acetate was further added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 21.

Toner 21 was produced in the same manner as in Example 15, provided that Oil Phase 15 was replaced with Oil Phase 21, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 22

### —Production of Toner 22—

A container equipped with a thermometer and a stirrer was charged with 38 parts by mass of Crystalline Resin A8, and 38 parts by mass of ethyl acetate, and the resulting mixture was heated to the temperature equal to or higher than the melting point of the resin to sufficiently dissolve Crystalline Resin A8. To this, 30 parts by mass of Wax Dispersion Liquid, 2 parts by mass of Layered Inorganic Mineral Master Batch F8, 12 parts by mass of Colorant Master Batch P8, and 46 parts by mass of ethyl acetate were added, and the resulting mixture was stirred by means of TK Homomixer (of Tokushu Kika Kogyo Co., Ltd.) at 50° C. and at 10,000 rpm. To the resultant, 88 parts by mass of a 50% by mass Crystalline Resin Precursor B1 ethyl acetate was further added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 22.

Toner 22 was produced in the same manner as in Example 15, provided that Oil Phase 15 was replaced with Oil Phase 22, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 23

### —Production of Toner 23—

A container equipped with a thermometer and a stirrer was charged with 35 parts by mass of Crystalline Resin A8, and 35 parts by mass of ethyl acetate, and the resulting mixture was heated to the temperature equal to or higher than the melting point of the resin to sufficiently dissolve Crystalline Resin A8. To this, 30 parts by mass of Wax Dispersion Liquid, 6 parts by mass of Layered Inorganic Mineral Master Batch F8, 12 parts by mass of Colorant Master Batch P8, and 49 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents. To the resultant, 88 parts by mass of a 50% by mass of Crystalline Resin Precursor B1 ethyl acetate was added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase 23.

Toner 23 was produced in the same manner as in Example 15, provided that Oil Phase 15 was replaced with Oil Phase 23, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 24

### —Production of Toner 24—

Toner 24 was produced in the same manner as in Example 1, provided that Crystalline Resin A1 was replaced with Crystalline Resin A12, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Example 25

The evaluation of performance of the toner and developer was performed in the same manner as in Example 1, provided that Image Forming Apparatus was replaced with Image Forming Apparatus B in which Image Forming Apparatus A had been modified so that the latent electrostatic image bearing member, the charging device, the developing unit, and the cleaning device constituted an integrated unit together as a process cartridge, and the process cartridge was detachably mounted. The results are presented in Tables 3 and 4.

### Comparative Example 1

—Production of Toner a—

A container equipped with a thermometer and a stirrer was charged with 38 parts by mass of Crystalline Resin A1, and 38 parts by mass of ethyl acetate, and the resulting mixture was heated to the temperature equal to or higher than the melting point of the resin to sufficiently dissolve Crystalline Resin A1. To this, 88 parts by mass of a 50% by mass Non-Crystalline Resin Cl ethyl acetate solution, 30 parts by mass of Wax Dispersion Liquid, 12 parts by mass of Colorant Master Batch P1, and 46 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase a.

Toner a was produced in the same manner as in Example 1, provided that Oil Phase 1 was replaced with Oil Phase a, and the resulting toner and developer were evaluated in terms of their performance. The results are presented in Tables 3 and 4.

### Comparative Example 2

—Production of Toner b—

A container equipped with a thermometer and a stirrer was charged with 82 parts by mass of Crystalline Resin A1, and 82 parts by mass of ethyl acetate, and the resulting mixture was heated to the temperature equal to or higher than the melting point of the resin to sufficiently dissolve Crystalline Resin A1. To this, 30 parts by mass of Wax Dispersion Liquid, 12 parts by mass of Colorant Master Batch P1, and 46 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase b.

Toner b was produced in the same manner as in Example 1, provided that Oil Phase 1 was replaced with Oil Phase b, and the resulting toner and developer were evaluated in terms of their performance. The results are presented in Tables 3 and 4.

### Comparative Example 3

—Production of Toner c—

A container equipped with a thermometer and a stirrer was charged with 33 parts by mass of Crystalline Resin A1, and 33 parts by mass of ethyl acetate, and the resulting mixture was heated to the temperature equal to or higher than the melting point of the resin to sufficiently dissolve Crystalline Resin A1. To this, 96 parts by mass of a 50% by mass Non-Crystalline Resin Cl ethyl acetate solution, 30 parts by mass of Wax Dispersion Liquid, 2 parts by mass of Layered Inorganic Mineral Master Batch F1, 12 parts by mass of Colorant Master Batch P1, and 47 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase c.

Toner c was produced in the same manner as in Example 1, provided that Oil Phase 1 was replaced with Oil Phase c, and the resulting toner and developer were evaluated in terms of their performance. The results are presented in Tables 3 and 4. Further, the state of the organic-modified layered inorganic mineral in the toner was confirmed in the same manner as in Example 1, and as a result, it was found that the organic-modified layered inorganic mineral contained in the toner was all present in the areas adjacent to surfaces of toner particles.

### Comparative Example 4

—Production of Toner d—

A container equipped with a thermometer and a stirrer was charged with 38 parts by mass of Crystalline Resin A8, and 38 parts by mass of ethyl acetate, and the resulting mixture was heated to the temperature equal to or higher than the melting point of the resin to sufficiently dissolve Crystalline Resin A8. To this, 30 parts by mass of Wax Dispersion Liquid, 12 parts by mass of Colorant Master Batch P8, and 46 parts by mass of ethyl acetate were added, and the resulting mixture was stirred by means of TK Homomixer (of Tokushu Kika Kogyo Co., Ltd.) at 50° C. and at 10,000 rpm to uniformly dissolve and disperse the contents. To the resultant, 88 parts by mass of a 50% by mass Crystalline Resin Precursor B1 ethyl acetate was further added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase d.

Toner d was produced in the same manner as in Example 15, provided that Oil Phase 15 was replaced with Oil Phase d, and the resulting toner and developer were evaluated in terms of their performance. The results are presented in Tables 3 and 4.

### Comparative Example 5

### —Production of Layered Inorganic Mineral Master Batch F14—

Crystalline Resin A8 (100 parts by mass), an unmodified montmorillonite compound (Kinipia, manufactured by Kunimine Industries Co., Ltd.) which was an unmodified layered inorganic mineral (100 parts by mass), and ion-exchanged water (50 parts by mass) were sufficiently mixed, and kneaded by means of an open roll kneader (KNEADEX, manufactured by Nippon Coke & Engineering Co., Ltd.). As for the kneading temperature, the kneading was initiated at 90° C., followed by gradually cooling to 50° C. In the manner as described, Layered Inorganic Mineral Master Batch F14, in which a ratio (mass ratio) of the resin and the layered inorganic mineral was 1:1, was produced.

—Production of Toner e—

A container equipped with a thermometer and a stirrer was charged with 37 parts by mass of Crystalline Resin A8, and 37 parts by mass of ethyl acetate, and the resulting mixture was heated to the temperature equal to or higher than the melting point of the resin to sufficiently dissolve Crystalline Resin A8. To this, 30 parts by mass of Wax Dispersion Liquid, 2 parts by mass of Layered Inorganic Mineral Master Batch F14, 12 parts by mass of Colorant Master Batch P8, and 47 parts by mass of ethyl acetate were added, and the resulting mixture was stirred by means of TK Homomixer (of Tokushu Kika Kogyo Co., Ltd.) at 50° C. and at 10,000 rpm. To the resultant, 88 parts by mass of a 50% by mass Crystalline Resin Precursor B1 ethyl acetate was further added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase e.

Toner e was produced in the same manner as in Example 15, provided that Oil Phase 15 was replaced with Oil Phase e, and the resulting toner and developer were evaluated in terms of their performance. The results are presented in Tables 3 and 4. Further, the state of the unmodified layered inorganic mineral in the toner was confirmed in the same manner as in Example 1, and as a result, it was found that the unmodified layered inorganic mineral contained in the toner was all present in the areas adjacent to surfaces of toner particles.

### Comparative Example 6

### —Production of Inorganic Mineral Master Batch F15—

Crystalline Resin A8 (100 parts by mass), hydrophobic silica particles (R972, manufactured by Nippon Aerosil Co., Ltd.) (100 parts by mass), and ion-exchanged water (50 parts by mass) were sufficiently mixed, and kneaded by means of an open roll kneader (KNEADEX, manufactured by Nippon Coke & Engineering Co., Ltd.). As for the kneading temperature, the kneading was initiated at 90° C., followed by gradually cooling to 50° C. In the manner as described, Inorganic Mineral Master Batch F15, in which a ratio (mass ratio) of the resin and the inorganic mineral was 1:1, was produced.

—Production of Toner f—

A container equipped with a thermometer and a stirrer was charged with 37 parts by mass of Crystalline Resin A8, and 37 parts by mass of ethyl acetate, and the resulting mixture was heated to the temperature equal to or higher than the melting point of the resin to sufficiently dissolve Crystalline Resin A8. To this, 30 parts by mass of Wax Dispersion Liquid, 2 parts by mass of Layered Inorganic Mineral Master Batch F15, 12 parts by mass of Colorant Master Batch P8, and 47 parts by mass of ethyl acetate were added, and the resulting mixture was stirred by means of TK Homomixer (of Tokushu Kika Kogyo Co., Ltd.) at 50° C. and at 10,000 rpm. To the resultant, 88 parts by mass of a 50% by mass Crystalline Resin Precursor B1 ethyl acetate was further added, and the resulting mixture was stirred by means of TK Homomixer (of Tokushu Kika Kogyo Co., Ltd.) at 50° C. and at 10,000 rpm to uniformly dissolve and disperse the contents, to thereby obtain Oil Phase f.

Toner f was produced in the same manner as in Example 15, provided that Oil Phase 15 was replaced with Oil Phase f, and the resulting toner and developer were evaluated in terms of their performance. The results are presented in Tables 3 and 4.

TABLE 1

| | | | | | | Tb/Ta | |
|---|---|---|---|---|---|---|---|
| Binder resin | | Resin for use | Tg (° C.) | Ta (° C.) | Tb (° C.) | (° C.) | Mw |
| Crystalline | A1 | Polyester resin | — | 58 | 56 | 0.96 | 18,000 |
| resin | A2 | Polyester resin | — | 63 | 63 | 1.00 | 17,000 |
| | A3 | Polyester resin | — | 66 | 79 | 1.20 | 16,000 |
| | A4 | Polyester resin | — | 60 | 69 | 1.15 | 10,000 |
| | A5 | Polyester resin | — | 52 | 58 | 1.12 | 10,000 |
| | A6 | Polyurethane resin | — | 59 | 69 | 1.18 | 18,000 |
| | A7 | Polyurethane resin | — | 60 | 61 | 1.02 | 22,000 |
| | A8 | Polyurethane resin | — | 65 | 75 | 1.15 | 20,000 |
| | A9 | Polyurethane resin | — | 68 | 81 | 1.19 | 18,000 |
| | A10 | Polyether resin | — | 55 | 53 | 0.96 | 12,000 |
| | A11 | Polyvinyl resin | — | 56 | 65 | 1.16 | 87,000 |
| | A12 | Polyurea resin | — | 63 | 65 | 1.03 | 22,000 |
| Binder resin | B1 | Modified polyester | — | 65 | 76 | 1.17 | 20,000 |
| precursor | | resin | | | | | |
| Non- | C1 | Polyester resin | 55 | 61 | 137 | 2.25 | 7,000 |
| crystalline | C2 | Polyester resin | 53 | 60 | 144 | 2.40 | 10,000 |
| resin | | | | | | | |

TABLE 2

| | | | Organic- | | Binder resin | | | | | |
|---|---|---|---|---|---|---|---|---|---|---|
| | | | modified layered | | Crystalline | | Crystalline | | Non-Crystalline | |
| | | | inorganic mineral | | Resin A | | Resin B | | Resin C | |
| | | Production | | Amount | | Amount | | Amount | | Amount |
| | Toner | method | Type | (mass %) | Type | (mass %) | Type | (mass %) | Type | (mass %) |
| Ex. 1 | Toner 1 | Dissolution | CLAYTONE | 1.0 | A1 | 50 | | | C1 | 50 |
| | | suspension | APA | | | | | | | |
| Ex. 2 | Toner 2 | Dissolution | CLAYTONE | 1.0 | A1 | 100 | | | | |
| | | suspension | APA | | | | | | | |
| Ex. 3 | Toner 3 | Dissolution | CLAYTONE | 1.0 | A2 | 50 | | | C1 | 50 |
| | | suspension | APA | | | | | | | |
| Ex. 4 | Toner 4 | Dissolution | CLAYTONE | 1.0 | A3 | 50 | | | C1 | 50 |
| | | suspension | APA | | | | | | | |
| Ex. 5 | Toner 5 | Dissolution | CLAYTONE | 1.0 | A4 | 50 | | | C1 | 50 |
| | | suspension | APA | | | | | | | |
| Ex. 6 | Toner 6 | Dissolution | CLAYTONE | 1.0 | A5 | 50 | | | C1 | 50 |
| | | suspension | APA | | | | | | | |
| Ex. 7 | Toner 7 | Dissolution | CLAYTONE | 1.0 | A1 | 50 | | | C2 | 50 |
| | | suspension | APA | | | | | | | |
| Ex. 8 | Toner 8 | Dissolution | CLAYTONE | 1.0 | A6 | 50 | | | C1 | 50 |
| | | suspension | APA | | | | | | | |
| Ex. 9 | Toner 9 | Dissolution | CLAYTONE | 1.0 | A7 | 50 | | | C1 | 50 |
| | | suspension | APA | | | | | | | |
| Ex. 10 | Toner 10 | Dissolution | CLAYTONE | 1.0 | A8 | 50 | | | C1 | 50 |
| | | suspension | APA | | | | | | | |
| Ex. 11 | Toner 11 | Dissolution | CLAYTONE | 1.0 | A9 | 50 | | | C1 | 50 |
| | | suspension | APA | | | | | | | |
| Ex. 12 | Toner 12 | Dissolution | CLAYTONE | 1.0 | A8 | 65 | | | C1 | 35 |
| | | suspension | APA | | | | | | | |
| Ex. 13 | Toner 13 | Dissolution | CLAYTONE | 1.0 | A8 | 80 | | | C1 | 20 |
| | | suspension | APA | | | | | | | |
| Ex. 14 | Toner 14 | Dissolution | CLAYTONE | 1.0 | A8 | 100 | | | | |
| | | suspension | APA | | | | | | | |
| Ex. 15 | Toner 15 | Dissolution | CLAYTONE | 1.0 | A8 | 50 | B1 | 50 | | |
| | | suspension | APA | | | | | | | |
| Ex. 16 | Toner 16 | Dissolution | CLAYTONE | 1.0 | A10 | 50 | | | C1 | 50 |
| | | suspension | APA | | | | | | | |
| Ex. 17 | Toner 17 | Dissolution | CLAYTONE | 1.0 | A11 | 50 | | | C1 | 50 |
| | | suspension | APA | | | | | | | |
| Ex. 18 | Toner 18 | Kneading | CLAYTONE | 1.0 | A1 | 50 | | | C1 | 50 |
| | | pulverizing | APA | | | | | | | |
| Ex. 19 | Toner 19 | Aggregating | CLAYTONE | 1.0 | A1 | 50 | | | C1 | 50 |
| | | | APA | | | | | | | |
| Ex. 20 | Toner 20 | Dissolution | LUCENTITE | 1.0 | A8 | 50 | B1 | 50 | | |
| | | suspension | SPN | | | | | | | |
| Ex. 21 | Toner 21 | Dissolution | CLAYTONE | 1.0 | A8 | 50 | B1 | 50 | | |
| | | suspension | HY | | | | | | | |
| Ex. 22 | Toner 22 | Dissolution | CLAYTONE | 0.1 | A8 | 50 | B1 | 50 | | |
| | | suspension | APA | | | | | | | |
| Ex. 23 | Toner 23 | Dissolution | CLAYTONE | 3.0 | A8 | 50 | B1 | 50 | | |
| | | suspension | APA | | | | | | | |
| Ex. 24 | Toner 24 | Dissolution | CLAYTONE | 1.0 | A12 | 50 | | | C1 | 50 |
| | | suspension | APA | | | | | | | |
| Ex. 25 | Toner 1 | Dissolution | CLAYTONE | 1.0 | A1 | 50 | | | C1 | 50 |
| | | suspension | APA | | | | | | | |
| Comp. | Toner a | Kneading | — | — | A1 | 50 | | | C1 | 50 |
| Ex. 1 | | pulverizing | | | | | | | | |
| Comp. | Toner b | Kneading | — | — | A1 | 100 | | | | |
| Ex. 2 | | pulverizing | | | | | | | | |
| Comp. | Toner c | Kneading | CLAYTONE | 1.0 | A1 | 45 | | | C1 | 55 |
| Ex. 3 | | pulverizing | APA | | | | | | | |
| Comp. | Toner d | Kneading | — | — | A8 | 50 | B1 | 50 | | |
| Ex. 4 | | pulverizing | | | | | | | | |
| Comp. | Toner e | Kneading | Kinipia | 1.0 | A8 | 50 | B1 | 50 | | |
| Ex. 5 | | pulverizing | (unmodified | | | | | | | |
| | | | montmorillonite) | | | | | | | |
| Comp. | Toner f | Kneading | R972 | 1.0 | A8 | 50 | B1 | 50 | | |
| Ex. 6 | | pulverizing | | | | | | | | |

In Table 2, the amounts (mass %) of Crystalline Resin A, Crystalline Resin B, Non-Crystalline Resin C each represent an amount (% by mass) relative to the amount of the binder resin.

TABLE 3

| | | | | | Viscoelastic properties | | | | |
|---|---|---|---|---|---|---|---|---|---|
| | | Ta | Tb | Tb/Ta | G′ (Ta + 20) | G″ (Ta + 20) | G″ (Ta + 30) | G″ (Ta + 70) | G″ (30/70) |
| | Toner | (° C.) | (° C.) | (° C.) | (Pa) | (Pa) | (Pa) | (Pa) | (Pa) |
| Ex. 1 | Toner 1 | 59 | 63 | 1.07 | 4.4 × 10³ | 2.1 × 10³ | 1.2 × 10³ | 2.4 × 10¹ | 49.4 |
| Ex. 2 | Toner 2 | 58 | 60 | 1.03 | 4.0 × 10³ | 1.3 × 10³ | 8.7 × 10² | 3.4 × 10¹ | 25.6 |
| Ex. 3 | Toner 3 | 63 | 70 | 1.11 | 4.7 × 10³ | 2.3 × 10³ | 9.8 × 10² | 4.6 × 10¹ | 21.3 |
| Ex. 4 | Toner 4 | 67 | 87 | 1.30 | 6.0 × 10⁵ | 7.6 × 10⁴ | 1.4 × 10⁴ | 8.8 × 10² | 15.9 |
| Ex. 5 | Toner 5 | 60 | 75 | 1.25 | 2.7 × 10³ | 8.3 × 10² | 8.1 × 10² | 5.6 × 10¹ | 14.5 |
| Ex. 6 | Toner 6 | 53 | 67 | 1.26 | 2.0 × 10⁵ | 3.1 × 10⁴ | 7.2 × 10³ | 2.6 × 10² | 27.7 |
| Ex. 7 | Toner 7 | 58 | 61 | 1.05 | 4.6 × 10³ | 1.9 × 10³ | 1.2 × 10³ | 5.8 × 10¹ | 20.7 |
| Ex. 8 | Toner 8 | 59 | 76 | 1.29 | 4.8 × 10⁵ | 3.3 × 10⁴ | 2.9 × 10⁴ | 8.5 × 10³ | 3.4 |
| Ex. 9 | Toner 9 | 60 | 65 | 1.08 | 1.7 × 10⁵ | 1.2 × 10⁴ | 9.5 × 10³ | 3.8 × 10³ | 2.5 |
| Ex. 10 | Toner 10 | 66 | 84 | 1.27 | 5.6 × 10⁵ | 5.3 × 10⁴ | 4.2 × 10⁴ | 1.7 × 10⁴ | 2.5 |
| Ex. 11 | Toner 11 | 70 | 91 | 1.30 | 6.1 × 10⁵ | 7.8 × 10⁴ | 7.2 × 10⁴ | 3.2 × 10⁴ | 2.3 |
| Ex. 12 | Toner 12 | 65 | 79 | 1.22 | 9.2 × 10⁵ | 8.7 × 10⁴ | 8.4 × 10⁴ | 3.6 × 10⁴ | 2.3 |
| Ex. 13 | Toner 13 | 65 | 77 | 1.18 | 2.5 × 10⁶ | 2.4 × 10⁵ | 1.6 × 10⁵ | 7.5 × 10⁴ | 2.1 |
| Ex. 14 | Toner 14 | 65 | 75 | 1.15 | 4.8 × 10⁶ | 4.1 × 10⁵ | 4.0 × 10⁵ | 1.9 × 10⁵ | 2.1 |
| Ex. 15 | Toner 15 | 66 | 83 | 1.26 | 2.6 × 10⁶ | 2.1 × 10⁵ | 2.0 × 10⁵ | 1.9 × 10⁵ | 1.0 |
| Ex. 16 | Toner 16 | 57 | 68 | 1.19 | 1.7 × 10³ | 9.8 × 10² | 7.3 × 10² | 1.2 × 10¹ | 60.8 |
| Ex. 17 | Toner 17 | 58 | 66 | 1.14 | 3.1 × 10⁴ | 3.3 × 10⁴ | 9.3 × 10³ | 5.2 × 10³ | 1.8 |
| Ex. 18 | Toner 18 | 58 | 60 | 1.03 | 1.1 × 10³ | 7.6 × 10² | 6.9 × 10² | 1.2 × 10¹ | 57.5 |
| Ex. 19 | Toner 19 | 59 | 63 | 1.07 | 4.2 × 10³ | 2.3 × 10³ | 1.2 × 10³ | 2.4 × 10¹ | 50.0 |
| Ex. 20 | Toner 20 | 66 | 80 | 1.21 | 2.2 × 10⁶ | 1.7 × 10⁵ | 1.6 × 10⁵ | 1.5 × 10⁵ | 1.0 |
| Ex. 21 | Toner 21 | 66 | 81 | 1.23 | 2.4 × 10⁶ | 2.0 × 10⁵ | 1.9 × 10⁵ | 1.9 × 10⁵ | 1.0 |
| Ex. 22 | Toner 22 | 66 | 83 | 1.26 | 2.6 × 10⁶ | 2.0 × 10⁵ | 1.9 × 10⁵ | 1.9 × 10⁵ | 1.0 |
| Ex. 23 | Toner 23 | 66 | 83 | 1.26 | 2.6 × 10⁶ | 2.1 × 10⁵ | 2.1 × 10⁵ | 2.0 × 10⁵ | 1.0 |
| Ex. 24 | Toner 24 | 62 | 68 | 1.10 | 2.0 × 10⁵ | 1.8 × 10⁴ | 1.5 × 10⁴ | 1.0 × 10⁴ | 1.5 |
| Ex. 25 | Toner 1 | 59 | 63 | 1.07 | 4.4 × 10³ | 2.1 × 10³ | 1.2 × 10³ | 2.4 × 10¹ | 49.4 |
| Comp. | Toner a | 59 | 62 | 1.05 | 4.5 × 10³ | 2.1 × 10³ | 1.0 × 10³ | 2.5 × 10¹ | 40.0 |
| Ex. 1 | | | | | | | | | |
| Comp. | Toner b | 58 | 60 | 1.03 | 4.0 × 10³ | 1.5 × 10³ | 8.6 × 10² | 3.4 × 10¹ | 25.3 |
| Ex. 2 | | | | | | | | | |
| Comp. | Toner c | 59 | 64 | 1.08 | 8.7 × 10² | 6.5 × 10² | 5.2 × 10² | — | — |
| Ex. 3 | | | | | | | | | |
| Comp. | Toner d | 66 | 81 | 1.23 | 2.4 × 10⁶ | 2.0 × 10⁵ | 2.0 × 10⁵ | 1.9 × 10⁵ | 1.1 |
| Ex. 4 | | | | | | | | | |
| Comp. | Toner e | 66 | 83 | 1.26 | 2.4 × 10⁶ | 2.1 × 10⁵ | 2.0 × 10⁵ | 1.9 × 10⁵ | 1.0 |
| Ex. 5 | | | | | | | | | |
| Comp. | Toner f | 68 | 95 | 1.40 | 5.7 × 10⁶ | 5.1 × 10⁵ | 5.1 × 10⁵ | 4.9 × 10⁵ | 1.0 |
| Ex. 6 | | | | | | | | | |

TABLE 4

| | | | Minimum | | | | Heat |
|---|---|---|---|---|---|---|---|
| | | Image | fixing | Fixable | | Image damage | resistant |
| | | forming | temperature | temperature | Contamination | by | storage |
| | Toner | apparatus | (° C.) | range (° C.) | of carrier | transportation | stability |
| Ex. 1 | Toner 1 | A | 110 | 40 | II | 4.0 | III |
| Ex. 2 | Toner 2 | A | 105 | 65 | III | 3.5 | II |
| Ex. 3 | Toner 3 | A | 115 | 60 | II | 4.0 | II |
| Ex. 4 | Toner 4 | A | 120 | 65 | II | 4.0 | I |
| Ex. 5 | Toner 5 | A | 125 | 65 | II | 3.5 | II |
| Ex. 6 | Toner 6 | A | 140 | 65 | II | 4.0 | III |
| Ex. 7 | Toner 7 | A | 115 | 40 | II | 4.0 | III |
| Ex. 8 | Toner 8 | A | 135 | 85 | II | 4.5 | II |
| Ex. 9 | Toner 9 | A | 110 | 75 | II | 4.0 | III |
| Ex. 10 | Toner 10 | A | 120 | 75 | II | 4.0 | II |
| Ex. 11 | Toner 11 | A | 125 | 75 | II | 4.0 | I |
| Ex. 12 | Toner 12 | A | 120 | 75 | II | 4.0 | II |
| Ex. 13 | Toner 13 | A | 110 | 90 | II | 4.0 | I |
| Ex. 14 | Toner 14 | A | 105 | 100 | II | 4.0 | I |
| Ex. 15 | Toner 15 | A | 105 | 125 or more | I | 4.5 | I |
| Ex. 16 | Toner 16 | A | 120 | 40 | III | 3.5 | III |
| Ex. 17 | Toner 17 | A | 135 | 55 | III | 4.0 | II |
| Ex. 18 | Toner 18 | A | 110 | 40 | III | 3.0 | III |
| Ex. 19 | Toner 19 | A | 135 | 55 | H | 3.5 | II |
| Ex. 20 | Toner 20 | A | 105 | 120 | II | 4.0 | I |
| Ex. 21 | Toner 21 | A | 105 | 120 | II | 4.5 | I |
| Ex. 22 | Toner 22 | A | 105 | 125 or more | III | 4.0 | I |
| Ex. 23 | Toner 23 | A | 110 | 120 or more | I | 5.0 | I |
| Ex. 24 | Toner 24 | A | 115 | 85 | II | 4.0 | II |
| Ex. 25 | Toner 1 | B | 110 | 40 | II | 4.0 | — |
| Comp. | Toner a | A | 110 | 40 | IV | 1.5 | III |
| Ex. 1 | | | | | | | |
| Comp. | Toner b | A | 105 | 65 | V | 1.0 | II |
| Ex. 2 | | | | | | | |
| Comp. | Toner c | A | 115 | 25 | III | 2.5 | IV |
| Ex. 3 | | | | | | | |
| Comp. | Toner d | A | 105 | 125 or more | III | 1.5 | I |
| Ex. 4 | | | | | | | |
| Comp. | Toner e | A | 120 | 110 or more | III | 2.5 | I |
| Ex. 5 | | | | | | | |
| Comp. | Toner f | A | 150 | 80 or more | II | 1.5 | I |
| Ex. 6 | | | | | | | |

The embodiments of the present invention are as follows:

<1> A toner for electrophotography, containing:

a binder resin;

a colorant; and

an organic-modified layered inorganic mineral,

wherein the binder resin contains a crystalline resin in an amount of 50% by mass or greater, and

wherein the organic-modified layered inorganic mineral is an organic-modified layered inorganic mineral in which at least part of ions present between layers of a layered inorganic mineral are modified with organic ions.

<2> The toner according to <1>, wherein the toner is obtained by the method, which contains:

dispersing or emulsifying, in an aqueous medium, a toner composition containing at least the binder resin, the colorant, and the organic-modified layered inorganic mineral, to thereby granulate toner particles.

<3> The toner according to <1> or <2>, wherein the crystalline resin contains a first crystalline resin, and a second crystalline resin which has a weight average molecular weight larger than that of the first crystalline resin.
<4> The toner according to <3>, wherein the second crystalline resin is a reaction product of an elongation or crosslink reaction of a modified crystalline resin having a terminal isocyanate group.
<5> The toner according to <4>, wherein the modified crystalline resin having a terminal isocyanate group is the first crystalline resin to a terminal of which an isocyanate group has been introduced.
<6> The toner according to any one of <1> to <5>, wherein the crystalline resin is at least one selected from the group consisting of a polyester resin, a polyurethane resin, a polyurea resin, a polyamide resin, and a polyether resin.
<7> The toner according to any one of <1> to <6>, wherein the crystalline resin contains a urethane backbone, a urea backbone, or both a urethane backbone, and a urea backbone.
<8> The toner according to any one of <1> to <7>, wherein the toner is in the shape of particles, and the organic-modified layered inorganic mineral is present in a region of each toner particle, which is 0 nm to 300 nm in depth from an outer surface of the toner particle.

<9> The toner according to any one of <1> to <8>, wherein the organic-modified layered inorganic mineral is an organic-modified layered inorganic mineral in which at least part of ions present between layers of a smectite clay mineral are modified with organic cations.

<10> A developer, containing:

the toner as defined in any one of <1> to <9>.

<11> An image forming apparatus, containing:

a latent electrostatic image bearing member;

a charging unit configured to charge a surface of the latent electrostatic image bearing member;

an exposing unit configured to expose the charged surface of the latent electrostatic image bearing member to light to form a latent electrostatic image;

a developing unit configured to develop the latent electrostatic image with a toner to form a visible image;

a transferring unit configured to transfer the visible image to a recording medium; and

a fixing unit configured to fix the transferred visible image onto the recording medium,

wherein the toner is the toner defined in any one of <1> to <9>.

What is claimed is:

1. A toner for electrophotography, comprising:
a binder resin;
a colorant; and
an organic-modified layered inorganic mineral,
wherein the binder resin contains a crystalline resin in an amount of 50% by mass or greater, and
wherein the organic-modified layered inorganic mineral is an organic-modified layered inorganic mineral in which at least part of ions present between layers of a layered inorganic mineral are modified with organic ions.

2. The toner according to claim 1, wherein the toner is obtained by the method, which contains:
dispersing or emulsifying, in an aqueous medium, a toner composition containing at least the binder resin, the colorant, and the organic-modified layered inorganic mineral, to thereby granulate toner particles.

3. The toner according to claim 1, wherein the crystalline resin contains a first crystalline resin, and a second crystalline resin which has a weight average molecular weight larger than that of the first crystalline resin.

4. The toner according to claim 3, wherein the second crystalline resin is a reaction product of an elongation or crosslink reaction of a modified crystalline resin having a terminal isocyanate group.

5. The toner according to claim 4, wherein the modified crystalline resin having a terminal isocyanate group is the first crystalline resin to a terminal of which an isocyanate group has been introduced.

6. The toner according to claim 1, wherein the crystalline resin is at least one selected from the group consisting of a polyester resin, a polyurethane resin, a polyurea resin, a polyamide resin, and a polyether resin.

7. The toner according to claim 1, wherein the crystalline resin contains a urethane backbone, a urea backbone, or both a urethane backbone, and a urea backbone.

8. The toner according to claim 1, wherein the toner is in the shape of particles, and the organic-modified layered inorganic mineral is present in a region of each toner particle, which is 0 nm to 300 nm in depth from an outer surface of the toner particle.

9. The toner according to claim 1, wherein the organic-modified layered inorganic mineral is an organic-modified layered inorganic mineral in which at least part of ions present between layers of a smectite clay mineral are modified with organic cations.

10. A developer, comprising:
a toner for electrophotography, which contains:
a binder resin;
a colorant; and
an organic-modified layered inorganic mineral,
wherein the binder resin contains a crystalline resin in an amount of 50% by mass or greater, and
wherein the organic-modified layered inorganic mineral is an organic-modified layered inorganic mineral in which at least part of ions present between layers of a layered inorganic mineral are modified with organic ions.

11. An image forming apparatus, comprising:
a latent electrostatic image bearing member;
a charging unit configured to charge a surface of the latent electrostatic image bearing member;
an exposing unit configured to expose the charged surface of the latent electrostatic image bearing member to light to form a latent electrostatic image;
a developing unit configured to develop the latent electrostatic image with a toner to form a visible image;
a transferring unit configured to transfer the visible image to a recording medium; and
a fixing unit configured to fix the transferred visible image onto the recording medium,
wherein the toner contains:
a binder resin;
a colorant; and
an organic-modified layered inorganic mineral,
wherein the binder resin contains a crystalline resin in an amount of 50% by mass or greater, and
wherein the organic-modified layered inorganic mineral is an organic-modified layered inorganic mineral in which at least part of ions present between layers of a layered inorganic mineral are modified with organic ions.
